(19) United States
(12) Patent Application Publication
(10) Pub. No.: US 2006/0217831 A1
(43) Pub. Date: Sep. 28, 2006

(54) Graphical user interface for winder

(76) Inventors: Tad Butterworth, Ashland, WI (US); Timm Retzloff, Washburn, WI (US); John Zanto, Washburn, WI (US)

Correspondence Address: MICHAEL BEST & FRIEDRICH, LLP, 100 E WISCONSIN AVENUE, MILWAUKEE, WI, 53202, US

(21) Appl. No.: 11/086,807

(22) Filed: Mar. 22, 2005

(51) Int. Cl. G06F 19/00

(52) U.S. Cl. 700/126; 242/534.2; 700/83; 700/122

(57) ABSTRACT

A graphical user interface for use with a paper winder system. The graphical user interface can include a main control screen including at least one of a web handling section, a log/core handling section, and a menu section. The graphical user interface can include a change parameters screen including at least one parameter field that allows a user to adjust at least one parameter according to which the paper winder system operates. The graphical user interface can include at least one of a help menu screen, a change message screen, a control panels screen, and a create product codes screen.

### BACKGROUND OF THE INVENTION

Paper winder systems can be designed to manufacture a wide variety of embossed or unembossed materials, including toilet paper or paper towels. Initially, the paper can be held by a self-chucking, core-ejecting unwind stand. A hydraulic roll handler generally loads a paper roll onto the self-chucking, core-ejecting unwind stands. The paper roll can then be unwound by the unwind stands.

Web tension on each unwind stand can be monitored by a dancer unit coupled to each unwind stand. The unwind stand can also include a web break detection system. In the event of a web break, the web break detection system can shut down the unwind stand and/or the paper winder system.

Paper from one roll can be spliced with another roll. A web splicer can be positioned between a front unwind stand and a rear unwind stand. Conventionally, before two or more paper webs can be spliced together using the web splicer, the unwind stands that are currently running are stopped. Once the paper web is spliced, the unwind stands can be restarted.

From the unwind stands, a paper web can travel to an embosser. The embosser can emboss a pattern on the paper web. The embosser can include one or more steel engraved embossing rolls that emboss a pattern on the paper web.

After passing through the embosser, the paper web can travel to a rewinder. As the paper web enters the rewinder, the paper web can pass through a bowed roll assembly. The bowed roll assembly can smooth out wrinkles in the paper web. The paper web can then pass through one or more pull rolls. The pull rolls can draw the paper web from the embosser to the rewinder. The pull rods can assist in controlling the tension of the paper web.

The paper web can pass through a perforation roll assembly after passing through the pull rolls. The perforation roll can perforate the paper web to generate individual sheets of paper (e.g., toilet paper squares or paper towel sheets). The perforated paper web can then pass through an ironing roll assembly that removes wrinkles in the paper web.

After passing through the perforation roll assembly and the ironing roll assembly, the paper web can pass through an assembly that can insert a core around which the paper web can be wound.

Next, the paper web can pass through an upper winding roll assembly. The upper winding roll assembly can maintain a constant tension on the paper web while the paper web is glued to a core. A lower winding roll assembly can support the core and can rotate at a constant rate in order to wind the paper web onto the core evenly.

A rider roll assembly can maintain even pressure on the core while the paper web is being spun onto the core by the upper winding roll assembly and the lower winding roll assembly. As a log of paper is built, the rider roll assembly can move away from the log until the log is complete. Then the rider roll assembly can pivot back in order to allow the log to roll into a tail sealer. The tail sealer can apply a line of adhesive, such as glue, onto the tail of the paper log. The line of adhesive can form a tab or seal on the paper log that can be broken by the customer in order to unwind the paper from around the core.

From the tail sealer, the paper log can be transferred by an infeed table into a bander. The bander can place a wrap on the paper log to prevent the paper log from unwinding. From the bander, the paper log can travel to an accumulator. The accumulator can stage many paper logs before sending the paper logs to a log transfer. From the accumulator, logs can enter a log saw. The log saw can cut the paper logs in order to generate individual rolls of papers. The rolls of paper can then be transferred out of the paper winder system by a conveyor.

### SUMMARY OF THE INVENTION

Some embodiments of the invention provide a graphical user interface for use with a paper winder system. Some embodiments of the graphical user interface can include a main control screen including at least one of a web handling section, a log/core handling section, and a menu section. Some embodiments of the graphical user interface can include a change parameters screen including at least one parameter field that allows a user to adjust at least one parameter according to which the paper winder system operates. Further, some embodiments of the graphical user interface can include at least one of a help menu screen, a change message screen, a control panels screen, and a create product codes screen.

### BRIEF DESCRIPTION OF THE DRAWINGS

FIG. 1 illustrates a paper winder control system including a graphical user interface according to one embodiment of the invention.

FIG. 2 is a side view of unwind stand components for use with the graphical user interface according to one embodiment of the invention.

FIG. 3 is a side view of an embosser for use with the graphical user interface according to one embodiment of the invention.

FIG. 4 is a side view of a rewinder for use with the graphical user interface according to one embodiment of the invention.

FIG. 5 is a side view of a core hopper and core incline conveyor for use with the graphical user interface according to one embodiment of the invention.

FIG. 6 is a side view of a tail sealer for use with the graphical user interface according to one embodiment of the invention.

FIG. 7 is a side view of an accumulator for use with the graphical user interface according to one embodiment of the invention.

FIG. 8 is a side view of an orbital log saw for use with the graphical user interface according to one embodiment of the invention.

FIG. 9 is a main control screen of the graphical user interface according to one embodiment of the invention.

FIG. 10 is a control panels screen of the graphical user interface according to one embodiment of the invention.

FIG. 11 is an unwind stand control screen of the graphical user interface according to one embodiment of the invention.

FIG. 12 is an accumulator control screen of the graphical user interface according to one embodiment of the invention.

FIG. 13 is a perforation control screen of the graphical user interface according to one embodiment of the invention.

FIG. 14 is a machine run tension screen of the graphical user interface according to one embodiment of the invention.

FIG. 15 is a machine stop tension screen of the graphical user interface according to one embodiment of the invention.

FIG. 16 is a machine thread tension screen of the graphical user interface according to one embodiment of the invention.

FIG. 17 is a lubrication procedures screen of the graphical user interface according to one embodiment of the invention.

FIG. 18 is a create product codes screen of the graphical user interface according to one embodiment of the invention.

FIG. 19 is another create product codes screen of the graphical user interface according to one embodiment of the invention.

FIG. 20 is a still another create product codes screen of the graphical user interface according to one embodiment of the invention.

FIG. 21 is a monitor servos screen of the graphical user interface according to one embodiment of the invention.

FIG. 22 is a diagnostic confirmation screen of the graphical user interface according to one embodiment of the invention.

FIG. 23 is a login screen of the graphical user interface according to one embodiment of the invention.

FIG. 24 is a login confirmation screen of the graphical user interface according to one embodiment of the invention.

FIG. 25 is a servo diagnostic main screen of the graphical user interface according to one embodiment of the invention.

FIG. 26 is an axis setup screen of the graphical user interface according to one embodiment of the invention.

FIG. 27 is a rider roll setup screen of the graphical user interface according to one embodiment of the invention.

FIG. 28 is a separator bar setup screen of the graphical user interface according to one embodiment of the invention.

FIG. 29 is a core inserter setup screen of the graphical user interface according to one embodiment of the invention.

FIG. 30 is an axis homing, axis jog, and axis cycle screen of the graphical user interface according to one embodiment of the invention.

FIG. 31 is an axis cycle confirmation screen of the graphical user interface according to one embodiment of the invention.

FIG. 32 is a cycle monitor screen of the graphical user interface according to one embodiment of the invention.

FIG. 33 is a change message screen of the graphical user interface according to one embodiment of the invention.

FIG. 34 is a help menu screen of the graphical user interface according to one embodiment of the invention.

FIG. 35 is an overview of the winder screen of the graphical user interface according to one embodiment of the invention.

FIG. 36 is an operator's manual screen of the graphical user interface according to one embodiment of the invention.

FIG. 37 is a starting the machine screen of the graphical user interface according to one embodiment of the invention.

FIG. 38 is a product troubleshooting guide screen of the graphical user interface according to one embodiment of the invention.

FIG. 39 is another product troubleshooting guide screen of the graphical user interface according to one embodiment of the invention.

FIGS. 40-55 are troubleshooting help screens of the graphical user interface according to one embodiment of the invention.

FIG. 56 is a change parameters screen for a main winder of the graphical user interface according to one embodiment of the invention.

FIG. 57 is another change parameters screen for expert adjust parameters of the graphical user interface according to one embodiment of the invention.

FIG. 58 is still another change parameters screen for adjusting tail seal parameters of the graphical user interface according to one embodiment of the invention.

FIGS. 59-104 are function definition screens of the graphical user interface according to one embodiment of the invention.

FIG. 105 is a front unwind stand main screen of the graphical user interface according to one embodiment of the invention.

FIG. 106 is a front unwind stand jog screen of the graphical user interface according to one embodiment of the invention.

FIG. 107 is a front unwind stand roll change screen of the graphical user interface according to one embodiment of the invention.

FIG. 108 is an unwind stand splice control screen of the graphical user interface according to one embodiment of the invention.

FIG. 109 is a rear unwind stand main screen of the graphical user interface according to one embodiment of the invention.

FIG. 110 is a rear unwind stand jog screen of the graphical user interface according to one embodiment of the invention.

FIG. 111 is a rear unwind stand roll change screen of the graphical user interface according to one embodiment of the invention.

FIG. 112 is a log saw main screen of the graphical user interface according to one embodiment of the invention.

FIG. 113 is a log saw servo monitor screen of the graphical user interface according to one embodiment of the invention.

FIG. 114 is a log saw cycle confirmation screen of the graphical user interface according to one embodiment of the invention.

FIG. 115 is a login screen of the graphical user interface according to one embodiment of the invention.

FIG. 116 is a log saw login confirmation screen of the graphical user interface according to one embodiment of the invention.

FIG. 117 is a log saw diagnostic main screen of the graphical user interface according to one embodiment of the invention.

FIG. 118 is a log saw axis homing screen of the graphical user interface according to one embodiment of the invention.

FIG. 119 is a log saw axis cycle screen of the graphical user interface according to one embodiment of the invention.

FIG. 120 is a log saw axis cycle confirmation screen of the graphical user interface according to one embodiment of the invention.

FIG. 121 is a log saw cycle monitor screen of the graphical user interface according to one embodiment of the invention.

FIG. 122 is a log saw change message screen of the graphical user interface according to one embodiment of the invention.

FIG. 123 is a log saw axis jog screen of the graphical user interface according to one embodiment of the invention.

FIG. 124 is a log saw axis setup screen of the graphical user interface according to one embodiment of the invention.

FIG. 125 is a log saw product codes screen of the graphical user interface according to one embodiment of the invention.

FIG. 126 is another log saw product codes screen of the graphical user interface according to one embodiment of the invention.

FIG. 127 is an accumulator control screen of the graphical user interface according to one embodiment of the invention.

FIG. 128 is a log saw product setup screen of the graphical user interface according to one embodiment of the invention.

FIG. 129 is a log saw setup screen of the graphical user interface according to one embodiment of the invention.

FIG. 130 is a parameter definition screen for log dump parameters of the graphical user interface according to one embodiment of the invention.

FIG. 131 is a grinder setup screen of the graphical user interface according to one embodiment of the invention.

FIG. 132 is a reject setup screen of the graphical user interface according to one embodiment of the invention.

FIG. 133 is another parameter definition screen for a last clip of log position at clamp parameter and a reject open and close position parameter of the graphical user interface according to one embodiment of the invention.

FIG. 134 is a warning screen for the last clip of log position at clamp parameter of the graphical user interface according to one embodiment of the invention.

FIG. 135 is a lubrication setup screen of the graphical user interface according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

Also, it should be noted that a plurality of different structural components may be utilized to implement the invention. Furthermore, and as described in subsequent paragraphs, the specific configurations illustrated in the drawings are intended to exemplify embodiments of the invention and that other alternative configurations are possible.

In addition, it should be understood that embodiments of the invention include both hardware and electronic components or modules (e.g., integrated circuits and/or programmable logic controllers) that, for purposes of discussion, may be illustrated and described as if the majority of the components were implemented solely in hardware. However, one of ordinary skill in the art, based on a reading of this detailed description, would recognize that, in at least one embodiment, the electronic based aspects of the invention may be implemented in software. As such, it should be noted that a plurality of hardware and software based devices, as well as a plurality of different structural components may be utilized to implement the invention. Furthermore, and as described in subsequent paragraphs, the specific configurations illustrated in the drawings are intended to exemplify embodiments of the invention and that other alternative configurations are possible.

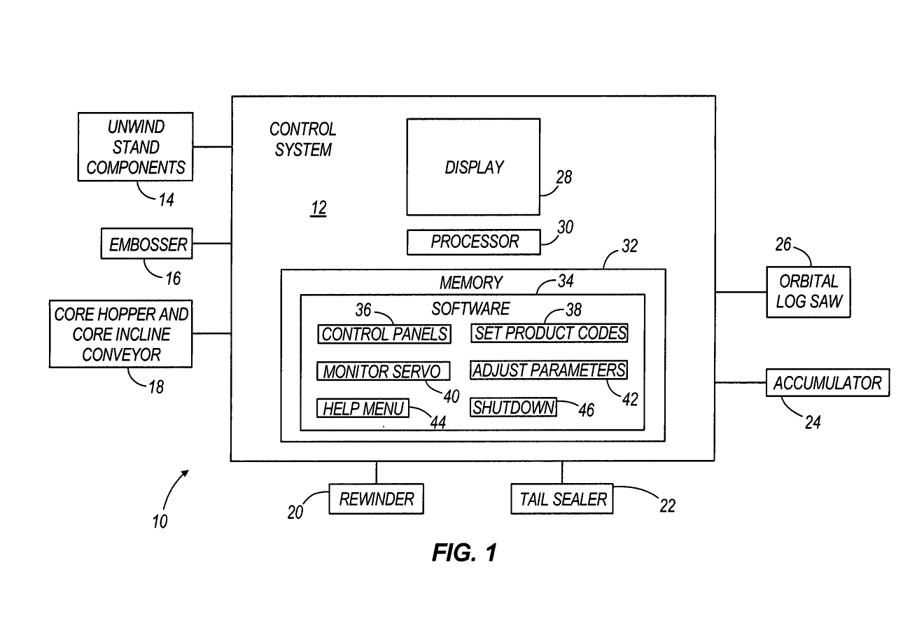

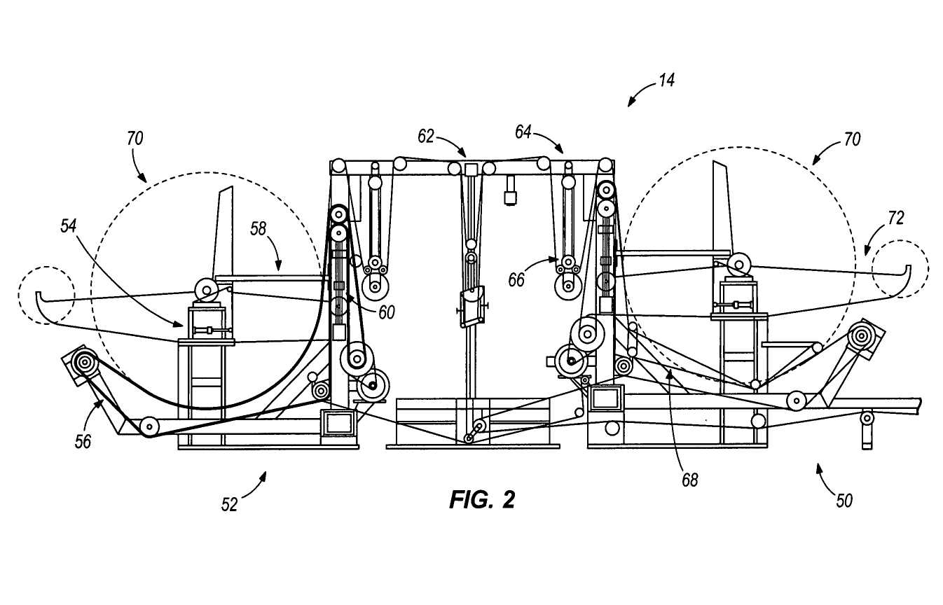

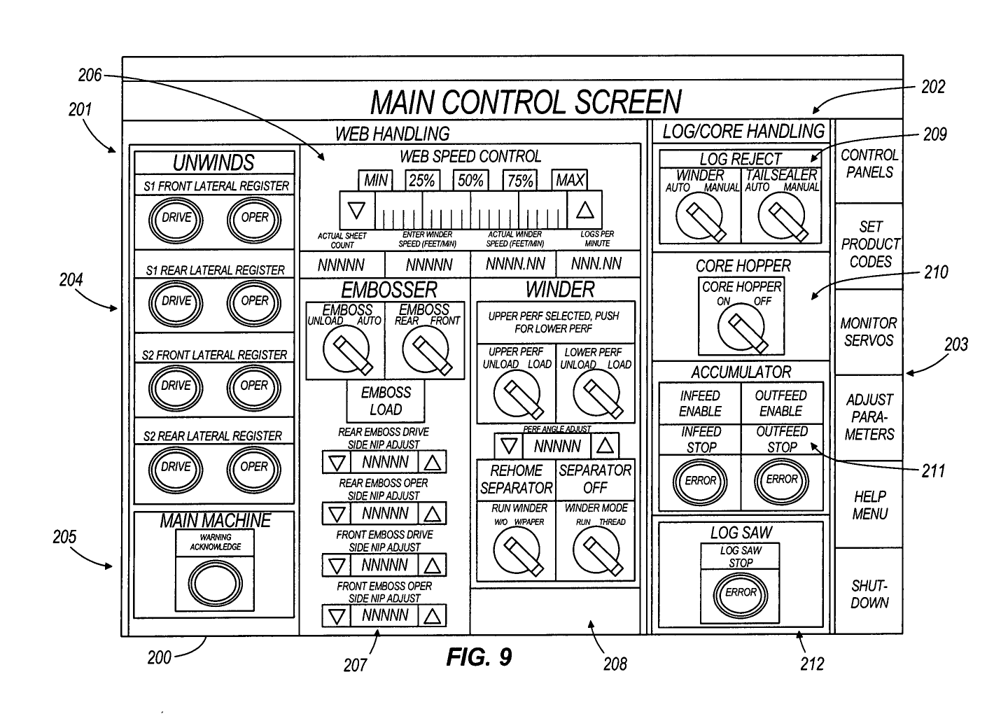

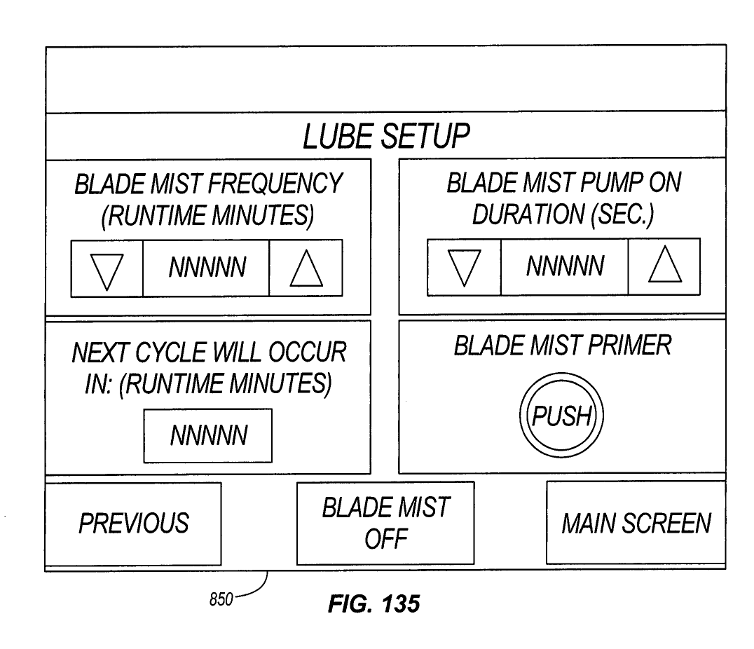

FIG. 1 illustrates a paper winder system 10 that can include a control system 12 that can be connected to one or more of the following components of the paper winder system 10: unwind stand components 14, an embosser 16, a core hopper and core incline conveyor 18, a rewinder 20, a tail sealer 22, an accumulator 24, and an orbital log saw 26. The control system 12 can include a display 28, a processor 30, and memory 32. The control system 12 can be housed in an operator console, such as one located on a main operator console on an operator side of the paper winder system 10 near the rewinder 20. The display 28 can include a touch screen display, such as the Allen-Bradley VersaView™ 1500 CE touch screen system sold by Rockwell Automation. The memory 32 can store software 34. The software 34 can include a control panels module 36, a set product codes module 38, a monitor servo engine module 40, an adjust parameters module 42, a help menu module 44, and a shutdown module 46. The processor 30 can execute the software 34 in order to provide a graphical user interface (described and illustrated below with respect to FIGS. 9-135) that can be used to control the paper winder system 10. The display 28 can display the graphical user interface to an operator of the paper winder system 10. FIGS. 2-8 are described below in order to provide a context for the machines and parameters controlled using the control system 12. The various mechanical configurations and parameters shown and described with respect to FIGS. 2-8 may not all be controlled by the control system 12 or the software 34 that provides the graphical user interface. For example, some embodiments of the graphical user interface may control only one machine, while other embodiments control each machine shown in FIGS. 2-8. The graphical user interface provided according to embodiments of the invention is in no way limited by the mechanical configurations shown in FIGS. 2-8. The mechanical configurations shown and described with respect to FIGS. 2-8 are provided only as a context for one embodiment of the graphical user interface.

Some embodiments of the invention can be used to control other types of paper converting machines, such as paper napkin and hand towel machines. Modern, fully-automatic paper napkin and hand towel machines are very complex and include highly-automated converting lines. The complexity of such converting lines includes the complete process of napkin and towel manufacture, from unwinding the large paper rolls (from the paper machine), embossing the paper, printing the paper, cutting, folding, separating into discrete stacks, multiplexing stacks, and interfacing to packaging machines. There are many machine and process variables that must be correct for these automated machines to provide quality product. It is very common for the users of these machines to require the machine manufacturer's highly-trained technicians to reset the machine and process variables at substantial expense. Some embodiments of the invention provide the ability for the users and operators of these complex machines to be more efficient in the parameter and machine adjustment relationships as to produce quality products. The following is a brief partial listing of napkin and towel machine adjustments and parameters: web tension control through all process of the machine; calendar skew and roll pressure adjustments; printing registration; cutting to length; roll to roll gap settings; folding machine vacuum valve timing absolute and side to side; gripping roller timing; gripper opening position; gripper closing position; count finger reference set point; count finger engagement time; count finger build rates; and packer system timing. There are often relationships between multiple parameters that can create a very complex matrix of possible settings that produce quality products. Some embodiments of the invention can significantly improve the overall operating efficiency of napkin and towel manufacturing machines.

FIG. 2 is a side view of the unwind stand components 14 that can be controlled with the control system 12. The unwind stand components 14 can be used to support and unwind one or more parent rolls. The unwind stand components 14 can provide self-chucking functionality and/or core-ejecting functionality in order to automatically load and unload parent rolls. The unwind stand components 14 can include a core adaptor designed to fit over a chuck loading shaft. The core adaptor can allow a chuck loading shaft to fit into a parent roll core of a larger diameter than the chuck loading shaft.

The unwind stand components 14 can be used to maintain an even and consistent tension on a paper web throughout the unwind process. The unwind stand components 14 can be positioned in front of the embosser 16 such that paper passes through the unwind stand components 14 before passing through the embosser 16.

As shown in FIG. 2, the unwind stand components 14 can include a front unwind stand 50 and a rear unwind stand 52. The unwind stand components 14 can also include a core-eject air cylinder and assembly 54, a surface drive belt 56, a splice detector 58, a drive belt tensioner arm and air cylinder 60, a web splicer 62, a dancer unit assembly 64, a dancer idler roll 66, a web thread belt 68, a parent roll 70, and a core catcher 72.

The unwind stand components 14 can support and unwind one or more parent rolls 70. The unwind stand components 14 can include a web threader that includes a system of belts and pulleys, such as the web thread belt 62, which can be used to assist with threading a paper web from a parent roll 70 into the unwind stand components 14 and onward to the embosser 16. The web threader can be located on an operator side of the unwind stand components 14.

Once the paper web is threaded, the unwind speed of the parent roll 70 can be controlled by the dancer unit assembly 64. The dancer unit assembly 64 can be adjusted in order to help eliminate wrinkles in the web and in order to help prevent the paper from wandering. The dancer assembly 64 can include the dancer idler roll 66, a dancer cam, and a dancer position proximity sensor. The dancer position sensor can include a proximity sensor positioned near the dancer cam. When there is a change in web tension, the dancer cam can rotate. The dancer position proximity sensor can read the distance to the dancer cam. This distance can be translated to voltage fluctuations through the cam/sensor relationship.

A drive motor can drive the unwind stand components 14. The driver motor can include a vector follower motor. The vector follower motor can adjust the unwind speed of the surface drive belt 56. The vector follower motor can obtain the distance translation from the dancer position sensor and can adjust the unwind speed of the parent roll 70. The dancer position sensor and the vector follower motor can control the speed of the paper being fed into the embossing unit in order to maintain proper web tension. The dancer position proximity sensor and the vector follower motor can be used to adjust (e.g., periodically or continuously) an unwind speed of the parent roll 70.

The dancer cam can rotate as the dancer idler roll 66 moves. As the paper web travels under the dancer unit assembly 64, the dancer idler roll 66 can move up and down an idler track. In some embodiments, the dancer idler roll 66 includes wheels, such as Dua-L-Vee wheels, that allow the dancer idler roll 66 to move along the idler track. The amount of travel of the dancer idler roll 66 can be influenced by the unwind speed of the unwind stand components 14 in relationship with the speed of a folder. For example, if the unwind stand components 14 are running slower than the folder, the dancer idler roll 66 travels upward along the idler track. If the unwind stand components 14 are running faster than the folder, the dancer idler roll 66 travels downward along the idler track.

The movement of the dancer idler roll 66 along the idler track can rotate the dancer cam. The distance between the dancer cam and the dancer position sensor is sensed and provided to the vector follower motor in order to adjust an unwind speed of the parent roll 70. After the vector follower motor adjusts the unwind speed, the dancer idler roll 66 can return to a starting position, such as the middle of the idler track. In some embodiments, the parent roll 70 can unwind at a rate that maintains the dancer idler roll 66 in the middle of a range of travel along the idler track in order to maintain a proper unwind speed. Once the web tension is correct, an adjustment process can be activated when a next variation in the web tension is detected by the dancer position sensor.

The dancer unit assembly 64 can include dancer idler roll loading cylinders. The dancer idler roll loading cylinders can be used to load the dancer idler roll 66 into a running position. The dancer idler roll loading cylinders can also act as dancer unit assembly 64 counterweights. Air pressure provided to the dancer idler roll loading cylinders can be adjusted in order to increase or decrease the web tension. Changing the tension can help eliminate wrinkles or prevent wandering of one or more plies of the paper web. A dancer pressure regulator can supply air pressure to the dancer idler roll loading cylinders.

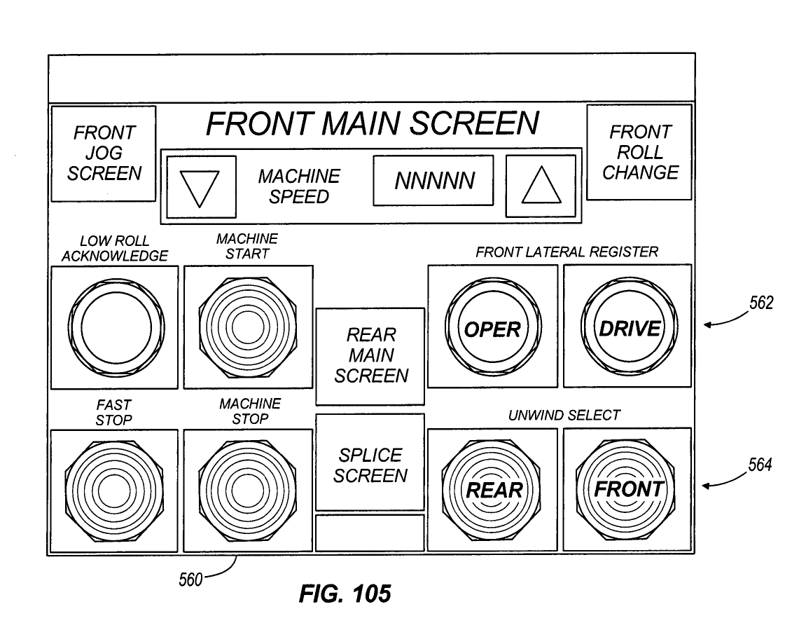

The drive belt tensioner arm and air cylinder 60 can be mounted in the center of the unwind stand components 14 in order to engage and disengage the surface drive belt 56 with the parent roll 70. The air cylinder can be controlled by a Belt Arm Disengage selector and a Belt Arm Engage selector on using one or more unwind stand control screens as shown and described with respect to FIGS. 105-111. For example, when the Belt Arm Engage selector is selected, the air cylinder can extend to engage the drive belt 56. When the Belt Arm Disengage selector is selected, the air cylinder can retract in order to allow the weight of the drive belt 56 to lower the drive belt 56, such that the drive belt 56 disengages from the parent roll 70.

As the paper is unwound, a lateral register mechanism can center the paper web from the unwind stand components 14 to the embosser 16. Lateral Register selectors, located on the unwind control screen shown and described with respect to FIGS. 105-111, can control the lateral register mechanism.

After the parent roll 70 has been unwound, the core-eject air cylinder and assembly 54 can eject spent cores from the unwind stand components 14. The core-eject air cylinder and assembly 54 can retract to pivot a core-eject arm slightly upwards. Pivoting the core-eject arm slightly upwards can allow a core to roll down into the core catcher 72 located at the rear of the unwind stand components 14. The core catcher 72 can include two arms that catch expired parent roll cores. From this position, the empty cores can be accessible for disposal. Hydraulic loading cylinders can move the core chucks in and out of the roll.

Located on the top of the unwind stand components 14, a web break sensor can monitor the paper web as it passes under it. When paper is no longer detected (i.e., a web break fault is detected), the unwind stand components 14 can automatically shut down.

The web splicer 62 can be located between the front unwind stand 50 and the rear unwind stand 52. The web splicer 62 can allow an operator to prepare an idle web and have it ready to be spliced when the current parent roll 70 expires (when running a one web product). When a low parent roll 70 is detected, a low roll detection system can display a message on the display 28. An operator can then visually monitor the roll and can begin web splice procedures before a parent roll 70 expires.

The splice detector 58 can be used to monitor the position of a splice between two parent rolls 70. The splice detector 58 can include a sensor that is manually positioned at a point before a splice. When the sensor no longer detects an unwinding parent roll 70, a “Splice Detected” message can be sent to the display 28. In some embodiments, an operator can stop the paper winder system 10 in order to jog a splice through the system when an operator receives the “Splice Detected” message.

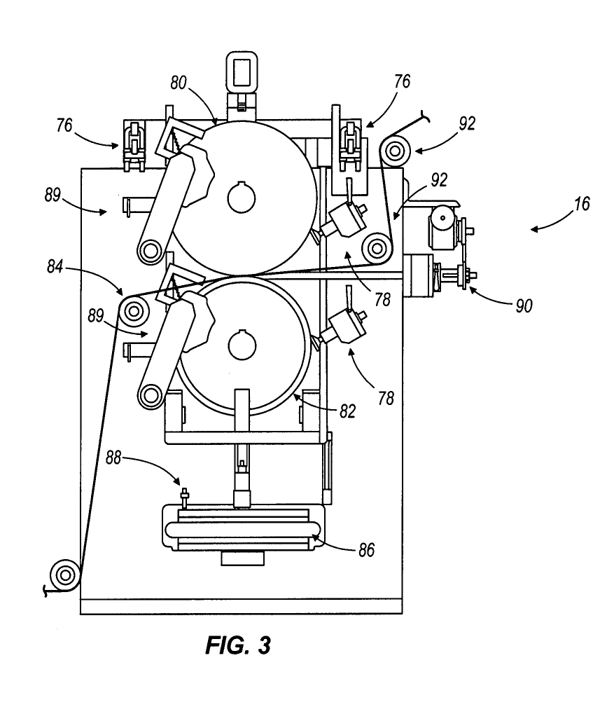

FIG. 3 is a side view of the embosser 16 which can be controlled using the control system 12. The embosser 16 can include one or more embossing rolls. The embossing rolls can be used to place an engraved pattern on one or both sides of the paper web. The embossing rolls can be set into interchangeable frames called cassettes. The cassettes can be replaced with other cassettes in order to change the pattern embossed on the paper web. A latch clamp 76 and a toggle foot 78 can be used to secure embossing cassettes into an embosser frame.

The embossing rolls can have an upper engraved steel roll 80 and a lower flat rubber roll 82. The flat rubber roll 82 can be placed in a cassette first before the upper steel roll 80. The lower rubber roll 82 can be friction driven. For example, the lower rubber roll 82 can be pressured against the upper steel roll 80, such that as the upper steel roll 80 turns so does the lower rubber roll 82.

A bowed roll 84 can be mounted before the embossing rolls on a cassette. The bowed roll 84 can be used to spread the paper web before it enters the embossing rolls. Spreading the paper web can help smooth out wrinkles in the web.

To load the embossing rolls into a running position, two air diaphragms 86 (one at each side of the cassette) can move the lower rubber roll 82 against the upper steel roll 80. A mechanical stop can prevent the embossing roll gears from coming out of mesh when the air is taken off the diaphragms 86.

The embossing rolls can use a wrap-up detection and embossing rolls load/unload detection assembly 88 in order to detect when the rolls are engaged or disengaged. The detection assembly can include one or more proximity switches located on a drive side and an operator side of the embosser 16 above the air loading diaphragms 86. The embossing rolls can also use the proximity switches to detect wrap-ups. When a wrap-up occurs, the proximity switches can shut down the embosser 16.

The amount of nip between the embossing rolls can be controlled by a nip adjustment mechanism 90. The nip adjustment mechanism 90 can be coupled to threaded rods by a chain and a sprocket. The threaded rods can be coupled to double-sided wedge blocks that slide between two single-sided wedges. The sliding movement of the double-sided wedge can increase or decrease the distance (i.e., the nip) depending on the direction of movement of the double-sided wedge. The distance between the embossing rolls can determine the depth of emboss, as well as package bulk. As the paper web passes out of the embosser 16, idler rolls 92 can guide and direct the paper web to the rewinder 20.

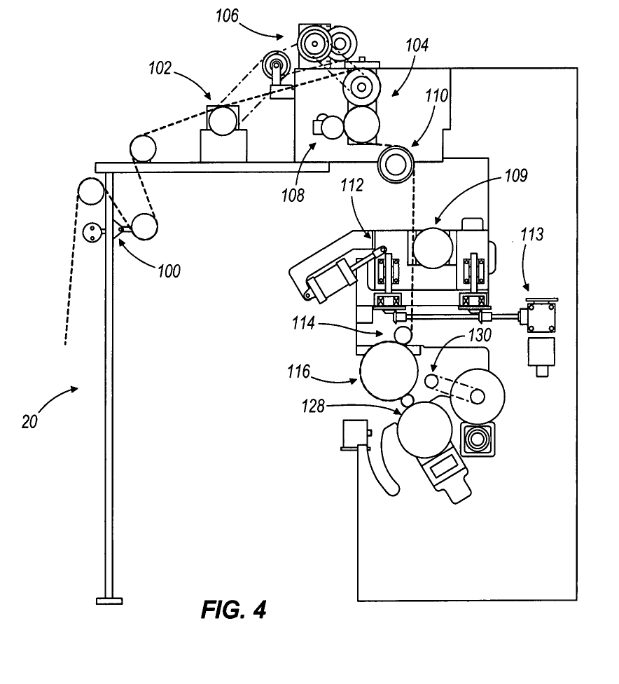

FIG. 4 is a side view of a rewinder 20 that can be controlled using the control system 12. As the paper web enters the rewinder 20, the paper web passes over a dancer unit assembly 100. The dancer unit assembly 100 can monitor the tension of the paper web. The dancer unit assembly 100 can include a dancer position sensor, a dancer cam, and a dancer idler roll. The dancer position sensor can include a proximity sensor positioned near the dancer cam. The dancer cam can be positioned on the end of a dancer pivot shaft. Changes in the paper web tension can move the dancer idler roll away from a reference or original position. The movement of the dancer idler roll can be translated to voltage fluctuations through a cam/sensor relationship. The speed of a drive motor can be adjusted (e.g., periodically or continuously) according to the voltage fluctuations. In some embodiments, the parent roll 70 can unwind at a rate that keeps the dancer idler roll in a reference or original position. The dancer unit assembly 100 can be adjusted to help eliminate wrinkles and to help prevent the paper web from wandering.

A bowed roll 102, located before one or more pull rolls 104, can remove wrinkles from the paper web. A ply bonder wheel loading unit 108 can interact with the pull rolls 104. The ply bonder wheel loading unit 108 can use a compact air cylinder that engages a ply bonder wheel against a ply bonder roll in order to bond two or more paper webs together to form a single sheet. The pull rolls 104 can include a set of variable speed driven rolls located at the upper web entry section of the rewinder 20. A differential gearbox 106 can drive the pull rolls 104 so that the speed can be electrically controlled by an operator. A top pull roll can have a rough surface in order to better grip the paper.

Located between the pull rolls 104 and a perforation (“perf”) roll 109, a tension roll 110 can monitor the tension of the paper web before it moves between the perforation roll and a perforation bar 112. Load cells in the tension roll can monitor the tension in the paper web as it passes over the tension roll 110. If the tension in the paper web does not match a predetermined value, the tension roll 10 can adjust the speed of the pull rolls 104.

The perforation roll 109 can interact with the perforation bar 112 in order to perforate the paper to a series of predetermined lengths. The perforation roll 109 can carry one or more anvil blades that wipe across the perforation blades in order to place the perforation roll 109 onto the paper web. The perforation roll may contain eight anvil blades. The rewinder 20 can include a perforation angle adjustment assembly 113. The perforation angle adjustment assembly 113 can be used to adjust an angle of the perforation roll 109 and/or the perforation bar 112.

A taper cone driven ironing roll 114, located after the perforation roll 109 and the perforation bar 112, can iron the paper web to the surface of an upper winding roll 116, so that the upper winding roll 116 can get a positive hold on the paper web. The ironing roll 114 can move away from the upper winding roll 116 when a paper wad becomes located between the upper winding roll 116 and a lower winding roll 128. The ability to axially move the ironing roll 114 with respect to the upper winding roll 116 can prevent a winding log from being damaged or distorted.

A variable speed drives for the ironing roll 114 and the perforation roll 109 can be located on a drive side of the rewinder 20. The drives can include two opposing tapered cones, a drive belt driving both cones, and a belt shifter controlled by a linear actuator. A larger diameter cone can run in an opposite direction of a smaller diameter end of the opposing cone. The belt shifter can move the drive belt across the faces of the tapered cones in order to change the speed of the ironing roll 114 and/or the perforation roll 109.

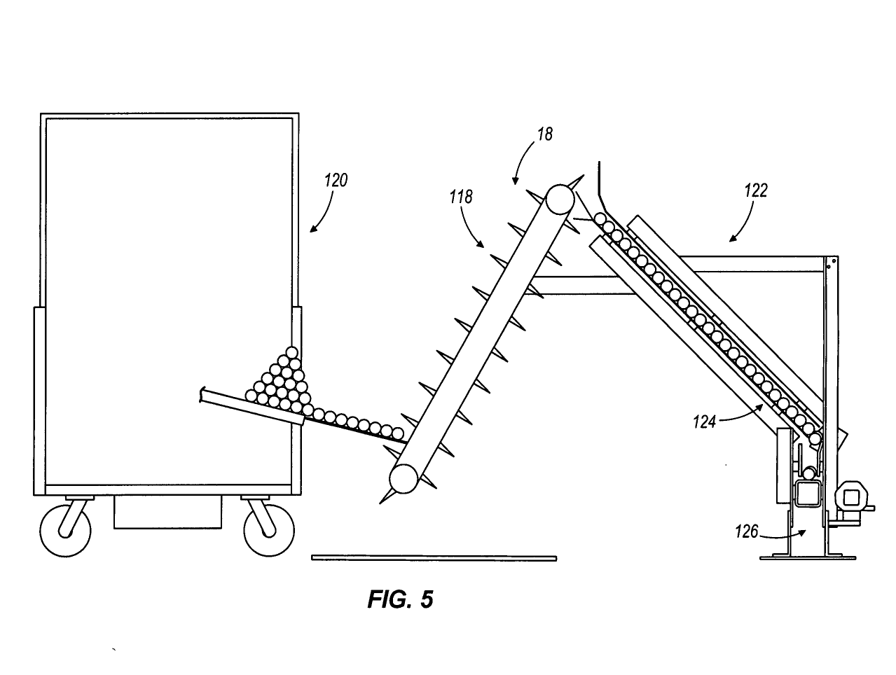

FIG. 5 is a side view of a core hopper and core incline conveyor 18 that can be controlled using the control system 12. An inclined core conveyor 118 can be located on an operator side of the rewinder 20. The inclined core conveyor 118 can transfer empty cores from a holding bin 120 to a core insertion assembly 122 inside the rewinder 20 (as shown in FIG. 5). The core insertion assembly 122 can include an inclined core hopper 124 and a core conveyor. The inclined core hopper 124 can stage and transfer empty cores into the core conveyor 126. The core conveyor 126 can then transfer empty cores into the rewinder 20.

Once the rewinder 20 receives an empty core, a gluing system can transfer a thin stretch of glue onto the empty core while the empty core is being staged before being transferred to a winding position between the upper winding roll 116 and the lower winding roll 128 (as shown in FIG. 4). A separator finger on a pivot can move the core into a position between the winding rolls. After inserting an empty core, the separator finger can then pivot to accept another empty core.

The upper winding roll 116 can be driven with a main motor. The main motor can set a base speed of the rewinder 20. Additional speed settings of the rewinder 20 can be set based on the speed of the embosser 16.

The lower winding roll 128 can control the rotation speed of the cores. In some embodiments, the lower winding roll is driven by the main motor and a servo motor through a differential gearbox. When an empty core is first inserted between the winding rolls 116 and 128, the lower winding roll 128 can operate at a slower speed than the upper winding roll 116. Then, as a paper log is built, the speed of the lower winding roll 128 can increase until the speed of the lower winding roll 128 substantially equals the speed of the upper winding roll 116. After the paper log is completed, the lower winding roll 128 can slow down and a finished paper log can be discharged. The separator finger on a pivot can then insert another empty core.

As shown in FIG. 4, a rider roll 130 can be located adjacent to the upper winding roll 116 and the lower winding roll 128. The rider roll 130 can be mounted on a pivoting mechanism that allows the rider roll 130 to lightly squeeze paper being wound on a core. As a paper log builds around a core, the rider roll 130 can pivot and move away from the paper log in order to allow the paper log to increase in size. When a paper log is completed, the rider roll 130 can pivot open, which can allow the completed paper log to drop on a reject gate of the rewinder 20.

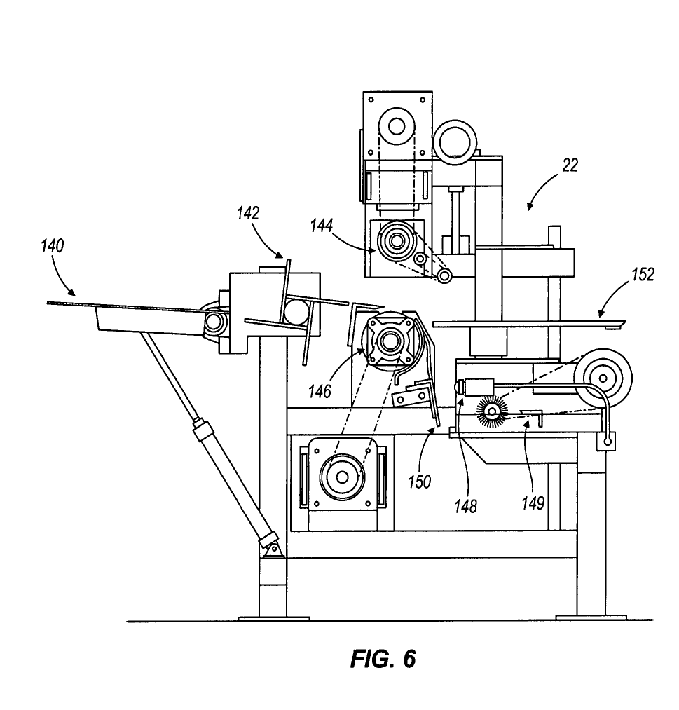

FIG. 6 is a side view of a tail sealer 22 that can be controlled using the control system 12. The tail sealer 22 can include an infeed table 140. The infeed table 140 can include a cylinder-actuated bridge stretching from the rewinder 20 to the tail sealer 22. The bridge can be up when the tail sealer 22 is running. The infeed table 140 can transfer a paper log from the rewinder 20 to the tail sealer 22. The infeed table 140 can also reject paper logs before paper logs enter the tail sealer 22. The infeed table 140 can provide access for an operator to make adjustments to the tail sealer 22 and/or rewinder 20.

Located after the infeed table 140, a log rotary index 142 can accept paper logs from the infeed table 140, can rotate paper logs, and can roll paper logs onto an overhead conveyor assembly 144 and a winding roll assembly 146. The log rotary index 142 can include one or more paddles, such that the log rotary index 142 is ready to stage another paper log as needed.

The overhead conveyor assembly 144 can interact with the winding roll assembly 146 in order to rotate a paper log while glue is applied to a tail end of the paper log. The height of the overhead conveyor assembly 144 can be adjusted to match the different diameters of a finished paper log.

The surface of the winding roll assembly 146 can be coated so that it can grip the paper on the log when the log rotates. The winding roll assembly 146 can interact with the overhead conveyor assembly 144 so that a tail end of a paper log can have glue applied to its surface by one or more glue guns 148. Located across from the glue guns 148, tail guides can support the tail end of the paper log as it passes by the glue guns 148. The glue guns 148 can apply glue to a tail end of the paper log as the tail end of the paper log passes in front of the glue guns 148. A glue pan 149 can be located beneath the glue guns 148 and can catch any excess glue. A glue drum can supply the tail sealer 22 with glue.

The tail sealer 22 can also include a discharge table 152 that can accept paper logs after they exit the overhead conveyor assembly 144 and the winding roll assembly 146. The overhead conveyor assembly can also drop an unacceptable paper log.

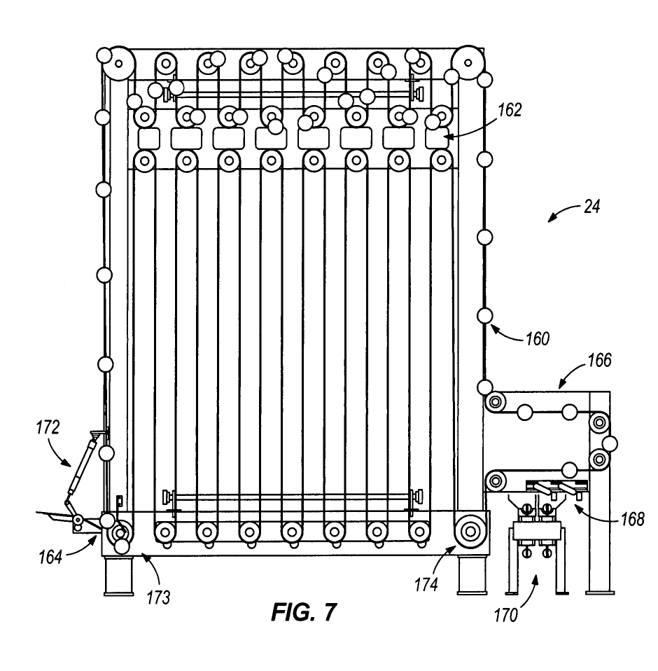

FIG. 7 is a side view of an accumulator 24 that can be controlled using the control system 12. The accumulator 24 can include buckets 160 mounted on a continuous chain. The buckets can be supported by a series of sprockets in a framework. The rewinder 20 can output more paper logs than the log saw 26 can cut such that the accumulator stores paper logs waiting to be cut. The accumulator 24 can also be used to store paper logs while the log saw 26 is not running. When the entire or a portion of the paper winder system 10 is down for roll changes or service, the log saw 26 can continue to operate by cutting paper logs stored in the accumulator 24.

The accumulator 24 can be driven by a dual drive. The dual drive can include two shaft-mounted gear motors, one on an input side (i.e., the tail sealer 22 side) and one on the output side (i.e., the log saw 26 side). The accumulator 24 can have two air cylinders that can be used to maintain torque on the motor/gearbox arrangements and the shafts. If the air cylinder on the tail sealer 22 side is forced to extend (i.e., retract on the log saw 26 side) due to a jam, the shaft may not receive the drive torque needed to power the accumulator 24.

The dual shaft-mounted gear motors can operate together or independently. When the input drive of the accumulator 24 is running, paper logs can be picked up from the tail sealer 22 and placed in the accumulator 24. In some embodiments, if the log saw 26 is not running, the paper logs are not discharged from the accumulator 24 to the log saw 26, and the accumulator 24 can start to fill with paper logs. The accumulator 24 can include a floating carriage 162 that can move down as paper logs enter the accumulator 24. The floating carriage 162 can allow, for example, approximately 100 to 300 paper logs to be stored within the accumulator 24. However, when an output drive of the accumulator 24 is running, paper logs can be discharged from the accumulator 24 to the log saw 24. As the accumulator 24 begins to empty, the floating carriage 162 can rise as paper logs are discharged. If both drives are running together, paper logs can pass through the accumulator 24 with limited storage time.

The accumulator 24 can have a resident log value. The resident log value can indicate a minimum storage capacity for paper logs, such as approximately 100 logs, that the accumulator 24 can hold. The resident log value may be equal to, for example, the least number of available buckets 160. The accumulator 24 can also have a flexible log value, which indicates an additional log storage capacity beyond the minimum storage capacity indicated by the resident log value. In some embodiments, the accumulator 24 can have a flexible log value of approximately 300 paper logs. Therefore, in some embodiments, the accumulator 24 can stage approximately 300 paper logs.

Paper logs can enter the accumulator 24 through an infeed area 164 of the accumulator 24. A log receiver 172 located at the infeed area 164 can stage the paper logs before they are transported through the accumulator 24. The buckets 160 can move through the log receiver 172 and pick up waiting paper logs. For example, the accumulator 24 can include approximately 368 buckets 160. The buckets 160 can be shaped to accommodate a paper log (e.g., 4 inch minimum to 6 inch maximum paper log diameter) and hold it until the paper log travels through the accumulator 24.

Once a paper log is picked up by a bucket 160, the paper log is transported through the accumulator 24. In some embodiments, the glue applied by the tail sealer 22 can dry during the paper log's travel through the accumulator 24 to prepare for the log saw 26.

After the paper log is transported through the main portion of the accumulator 24, the paper log can enter an accumulator outfeed area 166. The accumulator 24 can then discharge a paper log into a staging area 168. Paper logs can then be indexed forward by a saw conveyor 170 from the staging area 168 into the log saw 26. In some embodiments, the accumulator 24 includes multiple log saw conveyors 170. In order for the multiple log saw conveyors 170 to index the paper logs to the log saw 26, each log saw conveyor 170 must contain a paper log. If any log saw conveyor 170 does not have a paper log, all the log saw conveyors 170 may wait until a bucket 160 places a paper log into each empty log saw conveyor 170.

The accumulator 24 can include an infeed-bucket-in-position sensor 173 and an outfeed-bucket-in-position sensor 174. The infeed-bucket-in-position sensor 173 can include a proximity switch at the infeed area 164 of the accumulator 24 that can count revolutions of a cam that is driven by a drive sprocket. A signal can be sent to load a paper log into the log receiver 172 at the entry of the accumulator 24. The count ratio can be, for example, one quarter turn of the sprocket to one index position of the buckets 160 in the accumulator 24. A proximity switch at the outfeed area 166 included in the outfeed-bucket-in-position sensor 174 can signal when to discharge a paper log into the outfeed area 166.

As the paper logs are transported to the log staging area 168, a sensor can detect whether or not the log staging area 168 of the log saw conveyor 170 includes a paper log. If a log is not positioned in the log saw conveyor 170, an electromagnet can remain un-energized, which allows a cam arm to pivot and a bucket 160 to pass over the conveyor 170 without tilting (e.g., approximately 90 degree) to load the paper log into the staging area 168. If a paper log is detected in the log saw conveyor 170, the electromagnet can keep the cam arm from pivoting, which can cause a bucket 160 to tilt (e.g., approximately 90 degrees) in order to unload a paper log into the log staging area 168.

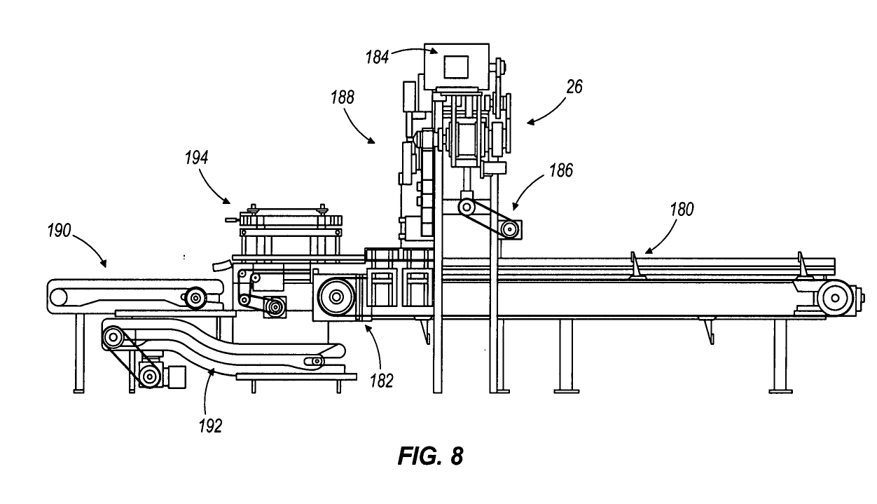

FIG. 8 is a side view of the orbital log saw 26 that can be controlled using the control system 12. A paper log can enter the log saw 26 from a paddle indexing conveyor 180. The paddle indexing conveyor 180 can be driven with a conveyor motor 182 in order to index transferred logs into the log saw 26. The paddle indexing conveyor 180 can include one or more paddles, a roller chain, one or more buckets, and one or more table top log guides. The paddles can be mounted on two pairs of roller chains. The paddles can be driven with a servo motor and a gearbox. The paddles can be guided by chain guides mounted on the underside of the paddles.

Upon entering the log saw 26, a log clamp assembly can grip the paper log. The log clamp assembly can include springs to actuate one or more log clamps in order to provide support for the paper log as the log saw 26 cuts the paper log. If equal pressure is not exerted against the paper log as a blade of the log saw 24 cuts it, uneven cuts or crushing of the paper log may occur.

A saw blade of the log saw 26 can be driven by an electric motor, such as a Reliance electric motor from Rockwell Automation. The starting and stopping, as well as the speed of the saw blade rotation, can be governed by a drive unit 184. The drive unit 184 can include an electric motor, a clutch brake, a pivot shaft, and a moveable bracket used for belt tensioning.

The orbit of the log saw 26 can be driven by a servo motor, such as an Indramat servo motor. The orbital speed of the log saw 26 can vary and can be adjusted. A disc brake can be used to stop the orbital movement of the log saw 26. The height of the log saw 26 can also be adjusted by an orbit head height adjust assembly 186.

A blade sharpening assembly 188 can be mounted on a small table located on the top side of the saw blade. Two honing wheels can be attached to the table, one above the saw blade and one below the saw blade. An air cylinder can be used to push the wheels against the blade edge in order to sharpen the edge of the saw blade. As the blade wears, the diameter of the blade can decrease. To counteract this, an air actuated motor can advance the table top forward toward the blade.

Once the saw blade cuts a roll (i.e., a toilet paper roll or a paper towel roll), off of a paper log, a roll removal conveyor system 190, located on the discharge side of the log saw 26, can carry the cut rolls out of the log saw 26. The roll removal conveyor system 190 can carry rolls out of the paper winder system 10 in order to package the rolls with additional equipment. The log saw 26 can also include a trim removal conveyor system 192 located on a discharge side of the log saw 26 below the roll removal conveyor system 190, which can carry waste out of the paper winder system 10.

The log saw 26 can also include a log guide assembly 194. The log guide assembly 194 can index forward a remaining portion of a paper log so that the paper log can be cut again.

FIG. 9 illustrates a main control screen 200 of the graphical user interface according to one embodiment of the invention. The main control screen 200 can display one or more fault messages. The main control screen 200 can display prompts for obtaining paper winder system 10 operating parameters. The main control screen 200 can include one or more selectors, such as buttons, levers, switches, touch-buttons, touch-levers, touch-switches, and/or touch-sensitive areas of the screen, in order to obtain paper winder system 10 operating parameters. In some embodiments, the main control screen 200 can include a web handling section 201, a log-core handling section 202, and a menu section 203.

In one embodiment, the web handling section 201 can include an unwind stand components control section 204, a main machine control section 205, a web speed control section 206, an embosser control section 207, and a rewinder control section 208. In order to modify operation of the unwind stand components 14, the unwind stand components control section 204 can include Lateral Register selectors that can be used to adjust the lateral position of one or more parent rolls 70. In some embodiments, the unwind stand components control section 204 can include four sets of Drive and Operator Lateral Register selectors. Selecting the Operator Lateral Register selector can move the parent roll 70 toward the operator side of the paper winder system 10. Selecting the Drive Lateral Register selector can move the parent roll 70 toward the drive side of the paper winder system 10.

As shown in FIG. 9, the main machine control section 205 can include an Acknowledge selector. Selecting the Acknowledge selector can acknowledge automatic warnings initiated by the paper winder system 10. In some embodiments, when a low parent roll is sensed, the paper winder system 10 can initiate a warning signal, such as a horn or light. Selecting the Acknowledge selector can turn off the warning horn and can allow the paper winder system 10 to continue to operate. In some embodiments, if the Acknowledge selector is not selected within a predetermined time period after the warning signal is initiated, such as approximately 120 seconds, the paper winder system 10 can shut down. The Acknowledge selector can also be used to indicate or acknowledge when the inclined core hopper 124 is low.

The web speed control section 206 can include a Minimum Speed selector, a Maximum Speed selector, a 25% Speed selector, a 50% Speed selector, and a 75% Speed selector. An operator can select one of these selectors to quickly change the running speed of the paper winder system 10 to a preset speed. An operator can also select an Increase Speed selector and a Decrease Speed selector in order to incrementally adjust the running speed of the paper winder system 10.

In some embodiments, the web speed control section 206 includes a bar graph speed indicator. The bar graph speed indicator can display a percentage of a maximum running speed at which the paper web is currently moving through the paper winder system 10. An operator can modify the running speed of the paper web by modifying the percentage displayed on the bar graph speed indicator. For example, an operator can input a numeric percentage value that specifies a desired percentage of a maximum running speed for the paper web using an Adjust Percentage selector.

The web speed control section 206 can include an adjust speed selector for entering a specific running speed for the paper web. In some embodiments, an operator can enter a desired running speed in units of feet per minute. The web speed control section 206 can include a current running speed in various measurement units. For example, the web speed control section 206 can display a Log Sheet Count, a Feet-per-Minute speed, and a Logs-per-Minute speed.

As shown in FIG. 9, the embosser control section 207 can include an Emboss Unload/Automatic selector. Selecting the Emboss Unload/Automatic selector can control the amount of air provided to the air diaphragms 86 that engage the embossing rolls 80 and 82 (as shown in FIG. 3). Selecting the unload mode using the Emboss Unload/Automatic selector can cause air to be released from the air diaphragms 86 in order to form a gap between the embossing rolls 80 and 82. The gap can allow an operator to thread paper through the rolls or to remove wrap-ups. Selecting the automatic mode using the Emboss Unload/Automatic selector can cause fluid to flow into the air diaphragms 86 in order to load the embossing rolls 80 and 82 into a running position (e.g., in contact with the paper web).

The embosser control section 207 can include an Emboss Rear/Front selector. The Emboss Rear/Front selector can set the paper winder system 10 to run either a front (or upper) embossing deck or rear (or lower) embossing deck. The front embossing deck can imprint a different pattern on the paper web than the rear embossing deck. In some paper winder systems, only one embossing deck can be run at a given time.

The embosser control section 207 can include an Emboss Load selector. Selecting the Emboss Load selector can load embossing rolls 80 and 82 together.

The embosser control section 207 can also include one or more individual or sets of adjustment selectors. For example, sets of adjustment selectors can include an Increase Value selector and a Decrease Value selector. In some embodiments, each adjustment selector can also include a current value. As shown in FIG. 9, the adjustment selectors can include a Rear Emboss Drive Side Nip Adjustment selector, a Rear Emboss Operator Side Nip Adjustment selector, a Front Emboss Drive Side Nip Adjustment selector, and a Front Emboss Operator Side Nip-Adjustment selector. The Nip Adjustment selectors can be used to increase or decrease an embossing roll nip (i.e., gap). In some embodiments, the nip on each side (i.e., drive or operator) of the parent roll 70 is the same.

The rewinder control section 208 can include a perforation selector. An operator can use the Perforation selector in order to select an upper perforation unit or a lower perforation unit. In some embodiments, only one perforation unit operates at any given time. The rewinder control section 208 can include an Upper Perforation Load/Unload selector and a Lower-Perforation Load/Unload selector that can be used to load and unload a perforation bar 112 in the upper perforation unit and the lower perforation unit, respectively.

The rewinder control section 208 can include a Perforation Angle Adjustment selector. The Perforation Adjustment selector can display an angle at which the perforation bar 112 is currently set. An operator can use an Increase Angle selector and a Decrease Angle selector included in the Perforation Angle Adjustment selector to adjust the perforation length.

The rewinder control section 208 can also include a Rehome Separator selector and a Separator Off selector. Selecting the Rehome Separator selector can bring the separator finger back to a starting or home position after a jam has occurred and has been cleaned out. The Separator Off selector can be selected to turn the separator finger off. Turning the separator finger off can cause the rider roll 130 to move to a starting or home position, which can allow for easier thread-up and/or jogging conditions.

The rewinder control section 208 can include a Run Rewinder Without/With Paper selector. Selecting the Run Rewinder Without/With Paper selector can switch a running mode of the winder between running with paper and running without paper. The running without paper can be used to dry run the rewinder 20. In some embodiments, running the rewinder 20 without paper locks out any web break limit switches and/or sensors. Running with paper can be a normal running condition for the rewinder 20.

The log/core handling section 202 can include a log reject control section 209, a core hopper control section 210, an accumulator control section 211, and a log saw control section 212. The log reject control section 209 can include a Rewinder Log Reject selector and a Tail Sealer Log Reject selector. Each Log Reject selector can include an automatic setting and a manual setting. Placing a Log Reject selector in a manual setting can allow an operator to manually control the opening and closing of a reject gate. In some embodiments, the reject gate remains open until an operator pushes a Log Reject selector again to change the setting to automatic. Placing a Log Reject selector in an automatic setting can allow a processing unit, such as a programmable logic controller (“PLC”), to automatically open and reset the reject gate.

The core hopper control section 210 can include a Core Hopper On/Off selector that can control the inclined core hopper 124 (as shown in FIG. 5). With the selector in the off position, the inclined core hopper 124 can stop indexing logs. In some embodiments, with the selector in the off position, most of the paper winder system 10 stops, excluding the log saw 26 and the outfeed drive of the accumulator.

The accumulator control section 211 can include an Accumulator Infeed Enable selector. In some embodiments, when the Accumulator Infeed Enable selector is selected, the infeed drive is enabled and the accumulator 24 will start to accumulate logs. The accumulator control section 211 can also include an Accumulator Infeed Enable selector. In some embodiments, selecting the Accumulator Infeed Enable selector operates the outfeed drive at a normal running rate or condition. In addition, the accumulator control section 211 can include an Infeed Stop selector and an Outfeed Stop selector. Selecting the Infeed Stop selector can stop the operation of the infeed assembly on the accumulator 24. In some embodiments, selecting the Infeed Stop selector can also eventually stop the tail sealer 22, the rewinder 20, the embosser 16, and the unwind stands components 14. Selecting the Outfeed Stop selector can stop operation of the outfeed assembly of the accumulator 24. In some embodiments, selecting the Outfeed Stop selector also stops operation of the log saw 26.

The log saw 26 can be manually stopped by selecting a Log Saw Stop selector included in the log saw control section 212. Selecting the Log Saw Stop selector can bring the log saw 26 to a normal driven stop. In addition, selecting the Log Saw Stop selector can cause the log saw 26 to be positioned in a starting or home position. In some embodiments, selecting a Log Saw Reset selector resets the log saw 26.

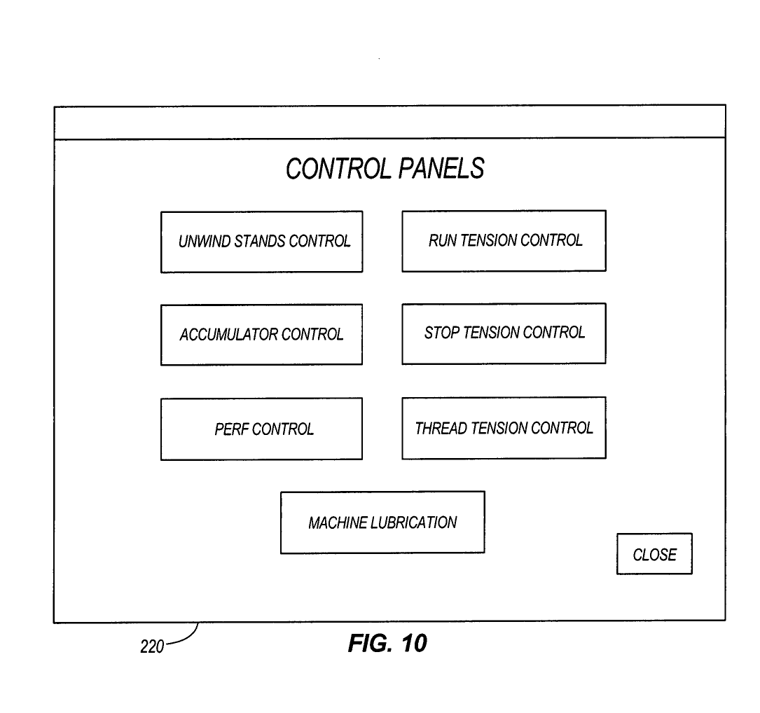

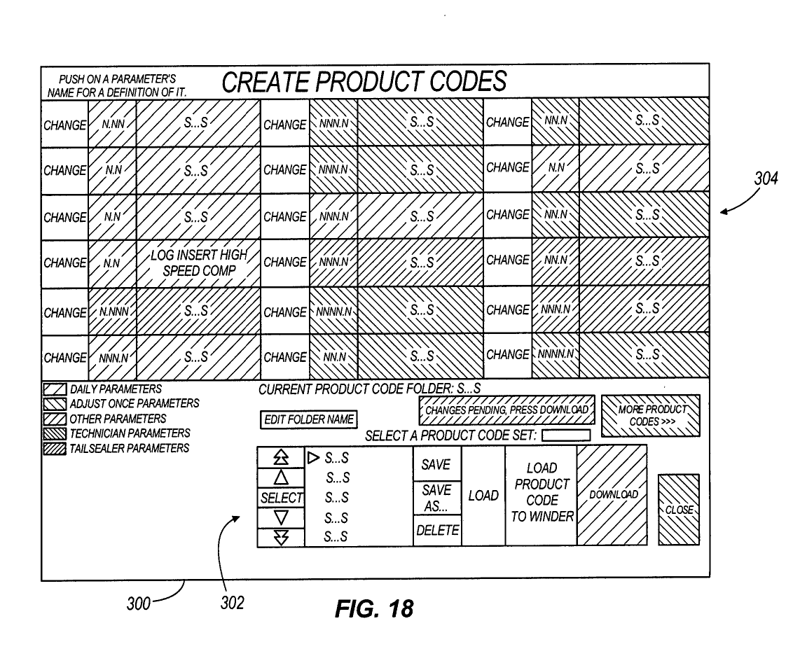

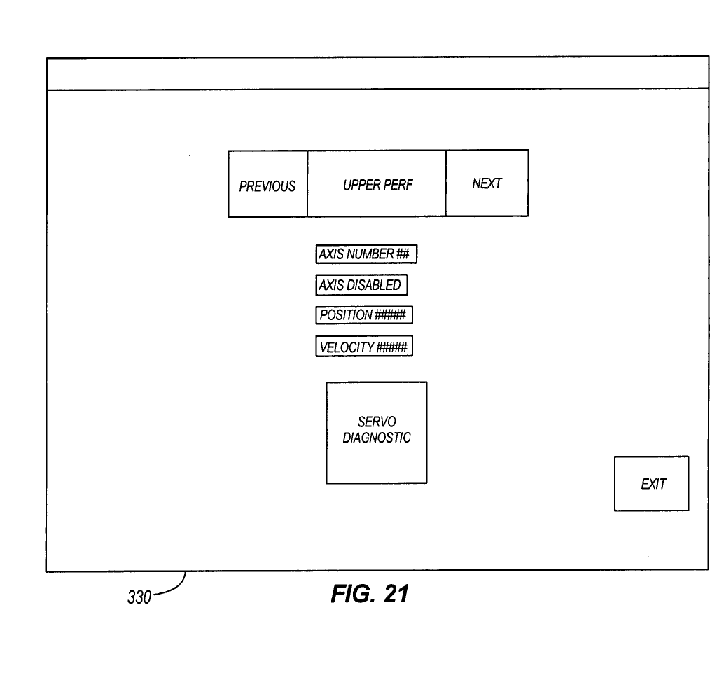

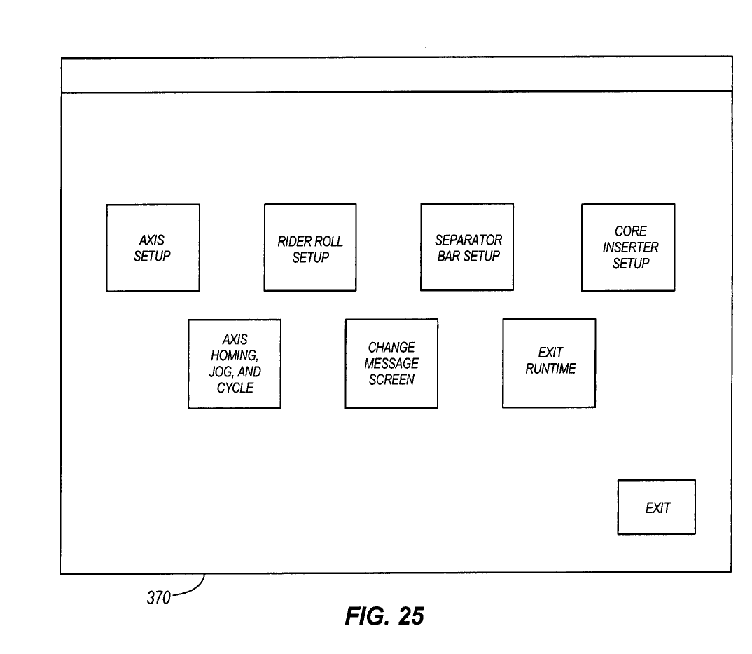

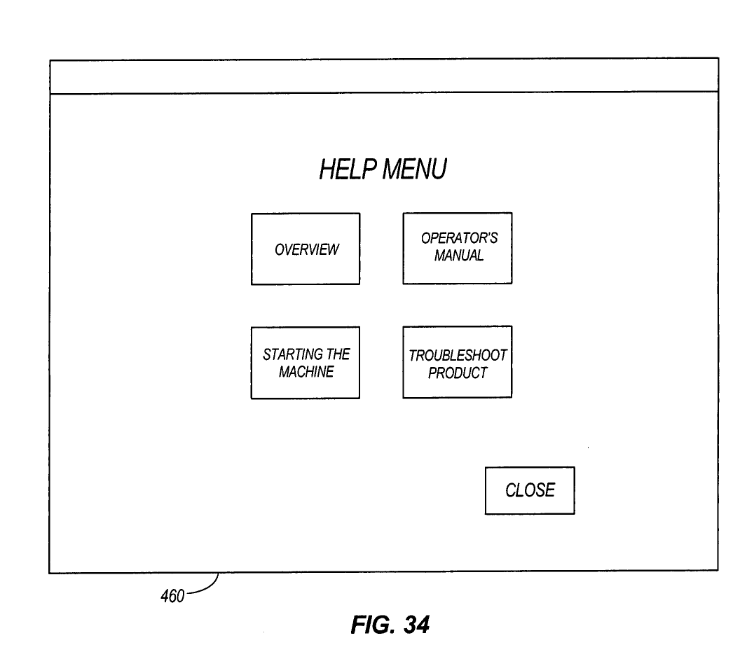

The menu section 203 of the main control screen 200 can include a Control Panels selector, a Set Product Codes selector, a Monitor Servos selector, an Adjust Parameters selector, a Help Menu selector, and a Shut Down selector. Selecting the Control Panels selector can access a control panels screen 220 (as described and illustrated below with respect to FIG. 10). Selecting the Set Product Codes selector can access a create product codes screen 300 (as described and illustrated below with respect to FIG. 18). Selecting the Monitor Servos selector can access a servo monitor screen 330 (as described and illustrated below with respect to FIG. 21). Selecting the Adjust Parameters selector can access a parameter adjustment screen 370 (as described and illustrated below with respect to FIG. 25). Selecting the Help Menu selector can access a help menu screen 460 (as described and illustrated below with respect to FIG. 34). In some embodiments, selecting the Shut Down selector can close the main control screen 200 and/or shut down the control system 12 of the paper winder system 10.

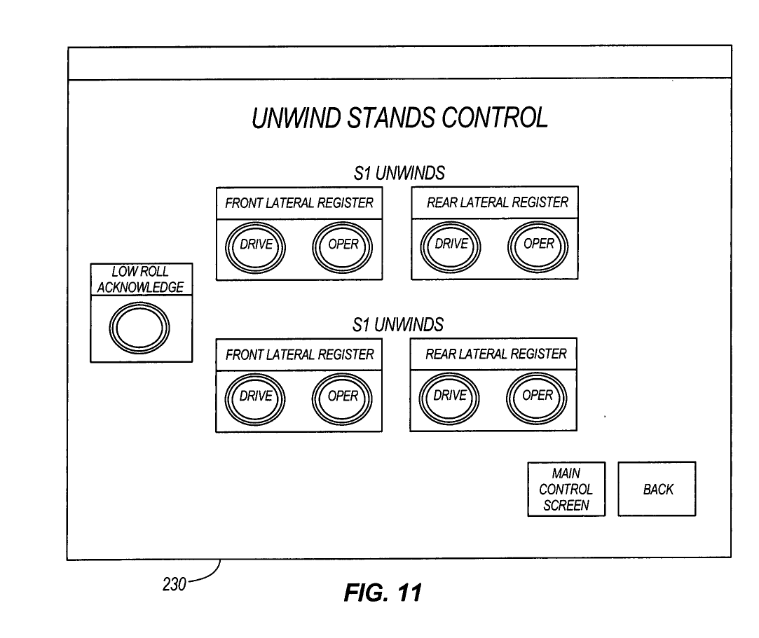

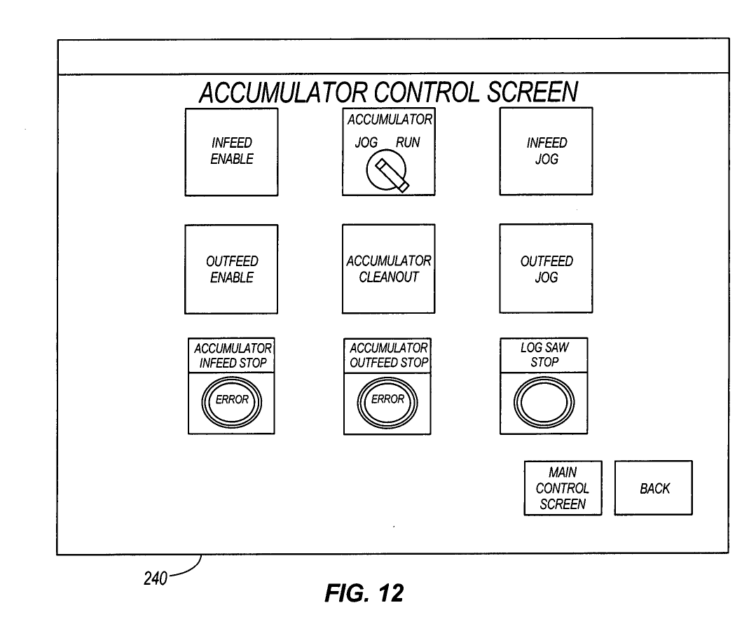

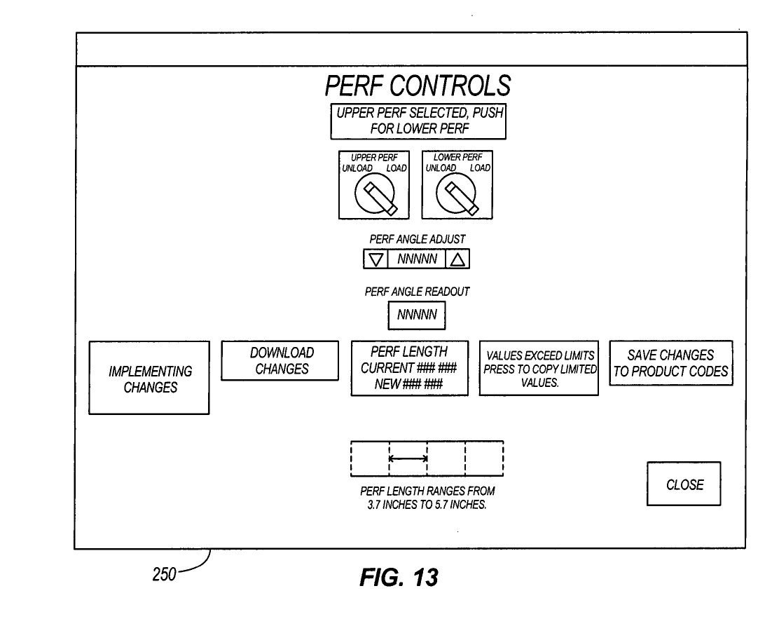

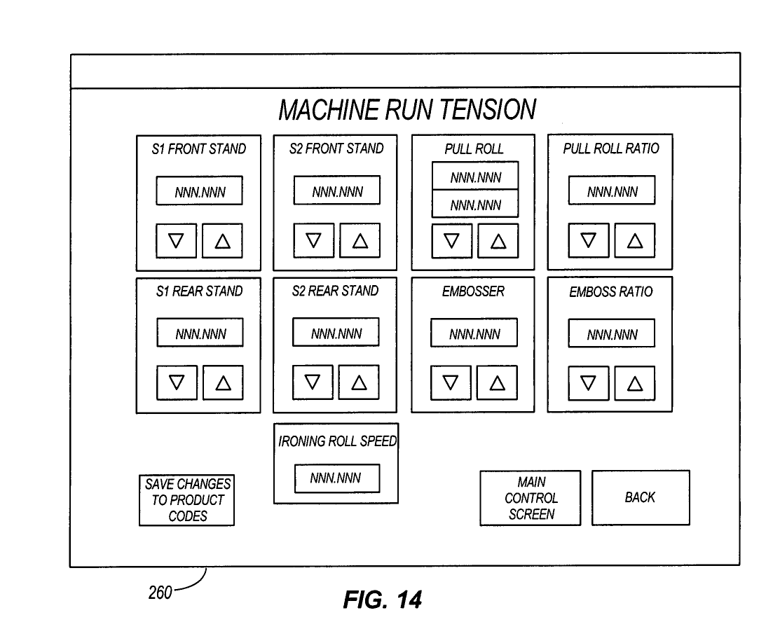

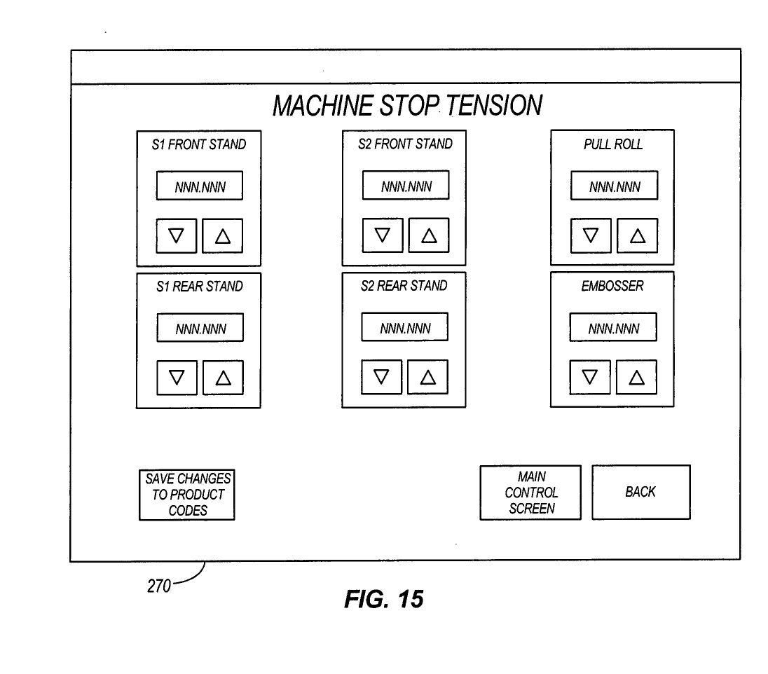

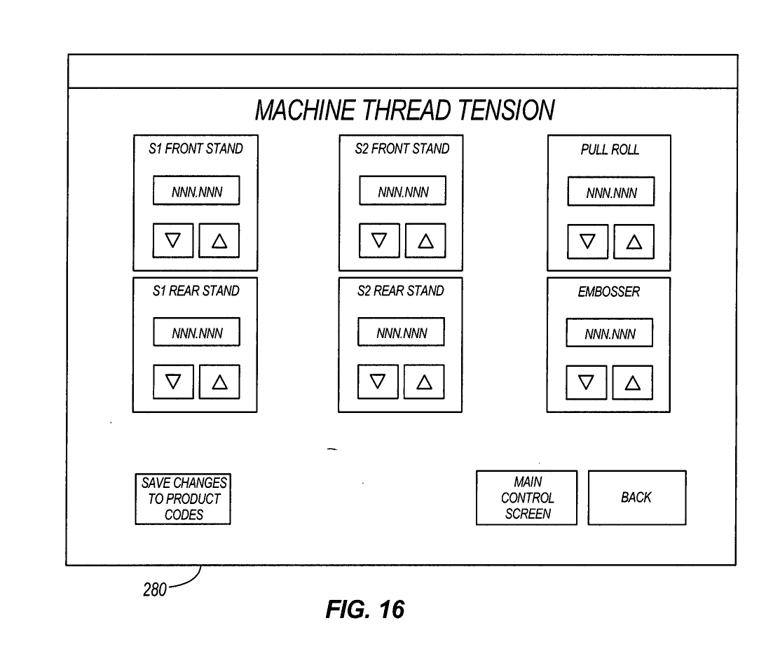

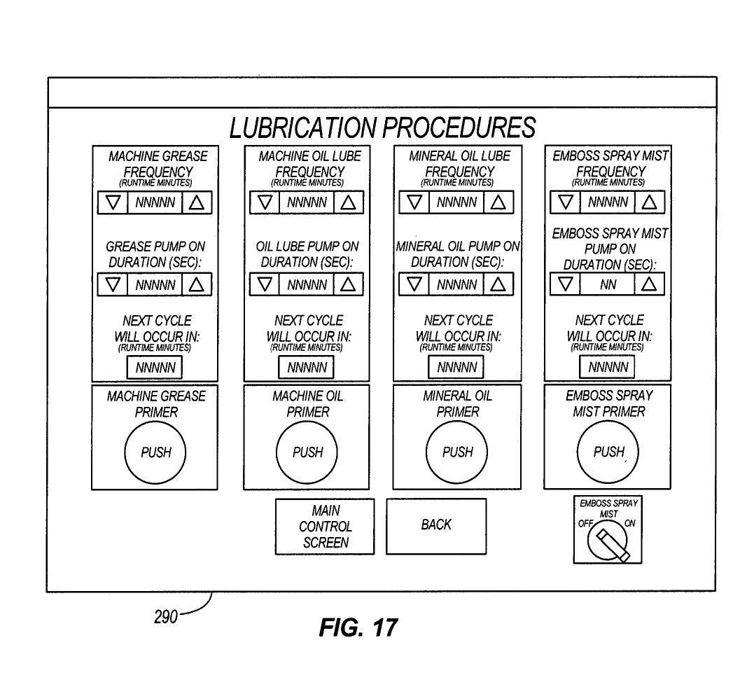

FIG. 10 illustrates a control panels screen 220 of the graphical user interface according to one embodiment of the invention. The control panels screen 220 can appear after the control-panels selector is selected at the main control screen 200. The control panels screen 220 can display fault messages and prompts for obtaining paper winder system operating parameters. The control panels screen 220 can include selectors for accessing the control panels of components included in the paper winder system 10. For example, the control panels screen 220 can include an Monitor Servos selector, an Accumulator Control selector, a Perforation Control selector, a Run Tension Control selector, a Stop Tension Control selector, a Thread Tension Control selector, and a Machine Lubrication selector. Selecting a selector displayed on the control panels screen 220 can access an individual control panel screen associated with a particular component of the paper winder system 10. For example, selecting the Monitor Servos selector can access an unwind stand control screen 230 (as described and illustrated below with respect to FIG. 11). Selecting the Accumulator Control selector can access an accumulator control screen 240 (as described and illustrated below with respect to FIG. 12). Selecting the Perforation Control selector can access a perforation control screen 250 (as described and illustrated below with respect to FIG. 13). Selecting the Run Tension Control selector can access a run tension control screen 260 (as described and illustrated below with respect to FIG. 14). Selecting the Stop Tension Control selector can access a stop tension control screen 270 (as described and illustrated below with respect to FIG. 15). Selecting the Thread Tension Control selector can access a thread tension control screen 280 (as described and illustrated below with respect to FIG. 16). Selecting the Machine Lubrication selector can access a lubrication screen 290 (as described and illustrated below with respect to FIG. 17).

The control panels screen 220 can also include a close selector. Selecting the close selector can close the control panels screen 220. In some embodiments, selecting the close selector can close the currently-displayed screen and display a previously-displayed screen.

FIG. 11 is the unwind stands control screen 230 of the graphical user interface according to one embodiment of the invention. The unwind stand control screen 230 can display fault messages and prompts for obtaining paper winder system 10 operating parameters. The unwind stand control screen 230 can include the Lateral Register selectors, as described and illustrated above with respect to FIG. 9, which can be selected in order to adjust the lateral position of one or more parent rolls 70. The unwind stand control screen 230 can also include the Low Roll Acknowledge selector, also described and illustrated above with respect to FIG. 9.

In some embodiments, the unwind stand control screen 230 includes a Main Control Screen selector and a Back selector. Selecting the main-menu-screen selector can access the main control screen 200. Selecting the Back selector can display the previously-displayed screen.

FIG. 12 is the accumulator control screen 240 of the graphical user interface according to one embodiment of the invention. The accumulator control screen 240 can appear after the Accumulator Control selector is selected at the control panels screen 220. The accumulator control screen 240 can display fault messages and prompts for obtaining paper winder system 10 operating parameters. The accumulator control screen 240 can include the Accumulator Infeed Enable selector, the Accumulator Outfeed Enable selector, the Infeed Stop selector, the Outfeed Stop selector, and the Log Saw Stop selector as described and illustrated above with respect to FIG. 9.

As shown in FIG. 12, the accumulator control screen 240 also includes an Accumulator Jog/Run selector. The Accumulator Jog/Run selector can be used set the accumulator 24 in a jog mode or a run mode. In a jog mode, an operator can use a Jog Infeed selector and a Jog Outfeed selector in order to jog the accumulator 24. Selecting the Jog Infeed selector can jog the infeed drive to the accumulator 24. In some embodiments, the infeed drive can be jogged to clear out a jammed log at the infeed assembly 164 of the accumulator 24 (as shown in FIG. 7). Similarly, selecting the Jog Outfeed selector can jog the outfeed drive of the accumulator 24. In some embodiments, the outfeed drive 166 may need to be jogged to clear out a jammed log at the outfeed assembly 166 of the accumulator 24 (as shown in FIG. 7).

The accumulator control screen 240 can also include a Main Control Screen selector and a Back selector.

FIG. 13 is the perforation control screen 250 according of the graphical user interface to one embodiment of the invention. The perforation control screen 250 can appear after the Perforation Controls selector is selected at the control panels screen 220. The perforation control screen 250 can display fault messages and prompts for obtaining paper winder system 10 operating parameters. The perforation control screen 250 can include the Perforation selector, the Upper Perforation Load/Unload selector, the Lower Perforation Load/Unload selector, and the Perforation Angle Adjustment selector, as described and illustrated above with respect to FIG. 9.

In addition, the perforation control screen 250 can include a separate perforation angle readout that displays a current angle of the perforation bar 112 (as shown in FIG. 4). The perforation control screen 250 can also include a Perforation Length Current/New display that indicates a current perforation length and a new perforation length.

In some embodiments, the accumulator control screen 250 includes a Values Exceed Limits selector. The Values Exceed Limits selector can indicate that new values exceed value limits. In some embodiments, selecting the Values Exceed Limits selector can change new values provided by an operator to valid values that fall within a valid range of values. The perforation control screen 250 can also display valid range limits. For example, the accumulator control screen 250 can display perforation length range limits that indicate valid ranges of perforation length values.

In some embodiments, once an operator is satisfied with the new values set using the perforation control screen 250, an operator can select the Download Changes selector. The Download Changes selector can download the changes to the one or more perforation units (as shown in FIG. 4) of the paper winder system 10. While the changes are being downloaded and the perforation units are being adjusted accordingly, the perforation control screen 250 can display or highlight an Implementing Changes indicator. The perforation control screen 250 can also include a Save Changes to Product Codes selector that will be explained in more detail below.

In some embodiments, the perforation control screen 250 includes an Ironing Roll Speed display (not shown) that indicates the current speed of the ironing roll 114 (as shown in FIG. 4) while the rewinder 20 is running. The current speed can include a percentage based on the speed of the ironing roll 114 to the speed of the upper winding roll 116. In some embodiments, the perforation control screen 250 can also include an Ironing Roll Speed Adjustment selector. The Ironing Roll Speed Adjustment selector can include an Increase Speed selector and a Decrease Speed selector that an operator can use in order to adjust the speed of the ironing roll 114. In some embodiments, the perforation control screen 250 can also display a current running speed (not shown) of the rewinder 20. The running speed can be displayed in logs per minute. In addition, the perforation control screen 250 can include a Close selector.

FIG. 14 is the machine run tension screen 260 of the graphical user interface according to one embodiment of the invention. The machine run tension screen 260 can appear after the Run Tension selector is selected at the control panels screen 220. The machine run tension screen 260 can display fault messages and prompts for obtaining paper winder system 10 operating parameters. The machine run tension screen 260 can include one or more Unwind Stand Tension selectors. Each Unwind Stand Tension selector can include a Front Unwind Stand Run Tension selector and a Rear Unwind Stand Run Tension selector. Each Front Unwind Stand Run Tension selector and Rear Unwind Stand Run Tension selector can include an Increase Tension selector and a Decrease Tension selector that can be used to adjust the minimum and maximum tension exerted on the paper web by the unwind stand components 14 (as shown in FIG. 2) when the paper winder system 10 is running. Each Front Unwind Stand Run Tension selector and Rear Unwind Stand Run Tension selector can also display current and/or adjusted tension minimum and maximum values for the unwind stand components 14.

The machine run tension screen 260 can include a Pull Roll Run Tension selector. The Pull Roll Run Tension selector can include an Increase Run Tension selector and a Decrease Run Tension selector for adjusting the minimum and maximum tension exerted on the paper web by the pull roll 104 (as shown in FIG. 4) when the paper winder system 10 is running. In some embodiments, the Pull Roll Run Tension selector can include Increase Run Tension selectors and Decrease Run Tension selectors for multiple pull rolls 104. The Pull Roll Run Tension selector can also display current and/or adjusted tension minimum and maximum tensions for the pull rolls 104.

The machine run tension screen 260 can include an Embosser Run Tension selector. The Embosser Run Tension selector can include an Increase Run Tension selector and a Decrease Run Tension selector for adjusting the minimum and maximum tension exerted on the paper web by the embosser 16 (as shown in FIG. 3) when the paper winder system 10 is running. The Embosser Run Tension selector can also display current and/or adjusted tension minimum and maximum values for the embosser 16.

The machine run tension screen 260 can include a Pull Roll Ratio selector and an Emboss Ratio selector. The Pull Roll Ratio selector can include an Increase Ratio selector and a Decrease Ratio selector that an operator can use to adjust a pull roll ratio in relation to the embosser 16. The Emboss Ratio selector can include an Increase Ratio selector and a Decrease Ratio selector that an operator can use to adjust an emboss ratio between the embosser 16 and the upper winding roll 116. The machine run tension screen 260 can also include the Save Changes to Product Codes selector that will be explained in more detail below. In some embodiments, the machine run tension screen 260 includes the Ironing Roll Speed display and the Ironing Roll Speed Adjustment selector, as described above with respect to FIG. 13. In some embodiments, the run tension screen can include a Main Control selector and a Back selector.

FIG. 15 is the machine stop tension screen 270 of the graphical user interface according to one embodiment of the invention. The machine stop tension screen 270 can appear after the Stop Tension selector is selected at the control panels screen 220. The machine stop tension screen 270 can display fault messages and prompts for obtaining paper winder system 10 operating parameters. The machine stop tension screen 270 can include a Thread/Run Mode selector (not shown). The Thread/Run Mode selector can be selected to toggle between a run mode and a thread mode of the rewinder 20. In some embodiments, the run mode is a normal running mode of the rewinder 20, and the thread mode is used to thread-up the rewinder 20.

The machine stop tension screen 270 can include one or more unwind-stand-stop-tension selectors. Each unwind-stand-stop-tension selectors can include a Front Unwind Stand Stop Tension selector and a Rear Unwind Stand Stop Tension selector. Each Front Unwind Stand Stop Tension selector and Rear Unwind Stand Stop Tension selector can include an Increase Stop Tension selector and a Decrease Stop Tension selector that can be used to adjust the minimum and maximum tension exerted on the paper web by the unwind stand components 14 (as shown in FIG. 2) when the paper winder system 10 is running and a stop condition occurs. Each Front Unwind Stand Stop Tension selector and Rear Unwind Stand Stop Tension selector can also display current and/or adjusted tension minimum and maximum values for the unwind stand components 14.

The machine stop tension screen 270 can include a Pull Roll Stop Tension selector. The Pull Roll Stop Tension selector can include an Increase Stop Tension selector and a Decrease Stop Tension selector for adjusting the minimum and maximum tension exerted on the paper web by a pull roll 104 (as shown in FIG. 4) when the paper winder system 10 is running and a stop condition occurs. In some embodiments, the Pull Roll Stop Tension selector can include Increase Stop Tension selectors and Decrease Stop Tension selectors for multiple pull rolls 104. The Pull Roll Stop Tension selector can also display current and/or adjusted tension minimum and maximum values for the pull rolls 104.

The machine stop tension screen 270 can include an Embosser Stop Tension selector. The Embosser Stop Tension selector can include an Increase Stop Tension selector and a Decrease Stop Tension selector for adjusting the minimum and maximum tension exerted on the paper web by the embosser 16 (as shown in FIG. 3) when the paper winder system 10 is running and a stop condition occurs. The Embosser Stop Tension selector can also display adjusted tension minimum and maximum values for the embosser 16.

The machine stop tension screen 270 can also include the Save Changes to Product Codes selector that will be explained in more detail below. In some embodiments, the machine top tension screen 270 can include a Main Control selector and a Back selector.

FIG. 16 is the machine thread tension screen 280 of the graphical user interface according to one embodiment of the invention. The thread tension screen 280 can appear after the Thread Tension selector is selected at the control panels screen 220. The thread tension screen 280 can display fault messages and prompts for obtaining paper winder system 10 operating parameters.

The machine thread tension screen 280 can include one or more Unwind Stand Thread Tension selectors. Each Unwind Stand Thread Tension selectors can include a Front Unwind Stand Thread Tension selector and a Rear Unwind Stand Thread Tension selector. Each Front Unwind Stand Thread Tension selector and Rear Unwind Stand Thread Tension selector can include an Increase Thread Tension selector and a Decrease Thread Tension selector that can be used to adjust the minimum and maximum tension exerted on paper web by the unwind stand components 14 when the paper winder system 10 is being threaded. Each Front Unwind Stand Thread Tension selector and Rear Unwind Stand Thread Tension selector can also display current and/or adjusted tension minimum and maximum values for the unwind stand components 14.

The machine thread tension screen 280 can include a Pull Roll Thread Tension selector. The Pull Roll Thread Tension selector can include an Increase Thread Tension selector and a Decrease Thread Tension selector for adjusting the minimum and maximum tension exerted on the paper web by a pull roll 104 (as shown in FIG. 4) when the paper winder system 10 is being threaded. In some embodiments, the Pull Roll Thread Tension selector can include Increase Thread Tension selectors and Decrease Thread Tension selectors for multiple pull rolls 104. The Pull Roll Thread Tension selector can also display adjusted tension minimum and maximum values for the pull rolls 104.

The machine thread tension screen 280 can include an Embosser Thread Tension selector. The Embosser Thread Tension selector can include an Increase Thread Tension selector and a Decrease Thread Tension selector for adjusting the minimum and maximum tension exerted on the paper web by the embosser 16 (as shown in FIG. 3) when the paper winder system 10 is being threaded. The Embosser Thread Tension selector can also display adjusted tension minimum and maximum values for the embosser 16.

The machine thread tension screen 280 can also include the Save Changes to Product Codes selector that will be explained in more detail below. In some embodiments, the machine thread tension screen 280 can include a Main Control screen selector and a Back selector.

FIG. 17 is a machine lubrication procedures screen 290 of the graphical user interface according to one embodiment of the invention. The machine lubrication procedures screen 290 can appear after the Machine Lubrication selector is selected at the control panels screen 220. The machine lubrication procedures screen 290 can display fault messages and prompts for obtaining paper winder system operating parameters.

The machine lubrication procedures screen 290 can include a Machine Grease Adjustment selector, a Machine Oil Lube Adjustment selector, a Mineral Oil Lube Adjustment selector, and an Emboss Spray Mist Adjustment selector. The Machine Lubrication Adjustment selectors can be used to adjust the lubrication application and/or routine of an automatic lubrication system for the rewinder 20.

Each Machine Lubrication Adjustment selector can include a Frequency selector, a Duration selector, and a Next Cycle Will Occur selector. Each Frequency selector can include an Increase Frequency selector and a Decrease Frequency selector that can be used in order to increase or decrease lubrication frequency. Each Frequency selector can also display an adjusted lubrication frequency value specified using the Increase Frequency selector and/or the Decrease Frequency selector. In some embodiments, the lubrication frequency value can be displayed in run-time minutes.

Each Duration selector can include an increase-duration selector and a decrease-duration selector that can be used to increase or decrease lubrication duration. Each Duration selector can also display an adjusted lubrication duration value specified using the Increase Duration selector and/or the Decrease Duration selector. In some embodiments, the lubrication duration values can be displayed in seconds.

Each Next Cycle Will Occur selector can include a prompt for obtaining a duration remaining before a next lubrication cycle occurs. In some embodiments, each Next Cycle Will Occur selector displays the entered remaining duration value. In some embodiments, the remaining duration value is entered and displayed in run-time minutes.

Each Machine Lubrication Adjustment selector can also include a Lubrication Primer selector. Selecting a Lubrication Primer selector can allow an operator to manually operate a lubrication machine pump. In some embodiments, the lubrication machine pump includes a Lincoln® lubrication machine pump sold by Lincoln Industrial Corporation. To initiate a manual operation, an operator can push and hold a Lubrication Primer selector until a system pressure is reached. In some embodiments, the machine pump cycles once each time the Lubrication Primer selector is selected.

In some embodiments, the Emboss Spray Mist Adjustment selector includes an Emboss Spray Off/Mist/On selector that can be used to turn an emboss spray on and off or set the emboss spray to mist. In some embodiments, the lubrication procedures screen 280 can include a Main Control Screen selector and a Back selector.

FIG. 18 is the create product codes screen 300 of the graphical user interface according to one embodiment of the invention. The create product code screen 300 can appear after the Set Product Codes selector is selected at the main control screen 200. Using the create product codes screen 300, an operator can change product codes for product changeovers. An operator can also use the create product codes screen 300 to adjust individual operating parameters for optimal production with the paper winder system 10.

In some embodiments, to load a new set of product codes for a product changeover, an operator can select a product code in a select product code section 302. An operator can use an Up selector and a Down selector to scroll through possible sets of product codes. An operator can also use an Up Page selector and a Down Page selector to scroll through multiple possible sets of product codes at once.

Once a desired product code set is highlighted in the select product code section 302, an operator can choose a Select button. An operator can then load the selected product code set by choosing a Load selector.

After an operator has loaded a particular product code set, a set of parameters associated with the product code set can be displayed in a parameter section 304. In some embodiments, the parameters can be color-coded based on an estimated frequency of adjustment. For example, green can represent parameters that can be modified on a daily basis, light blue can represent parameters that can be modified on random schedules, dark blue can represent parameters that can be changed on a one-time basis, purple can represent tail sealer parameters, and red can represent technician parameters. In some embodiments, this color-coding scheme can be used through the graphical user interface described herein.

An operator can make parameter adjustments by selecting a Change selector associated with each parameter displayed in the parameter section 304. In some embodiments, selecting a Change selector can access a numeric keypad on which an operator can enter a new parameter value. Once new parameter values have been entered, an operator can select a return key on the keypad to return to the create product codes screen 300.

After an operator has modified parameters, an operator can load the modifications by selecting a Load Product Code to Rewinder selector. An operator can also download the modifications by selecting a Download selector. Selecting a Save or Save As selector can save the modifications.

To create and save a new product code set, an operator can enter desired parameters using the Change selectors shown in FIG. 18. An operator can then select a Save As selector. In some embodiments, a keypad can be displayed on which an operator can enter a name for the new product code set.

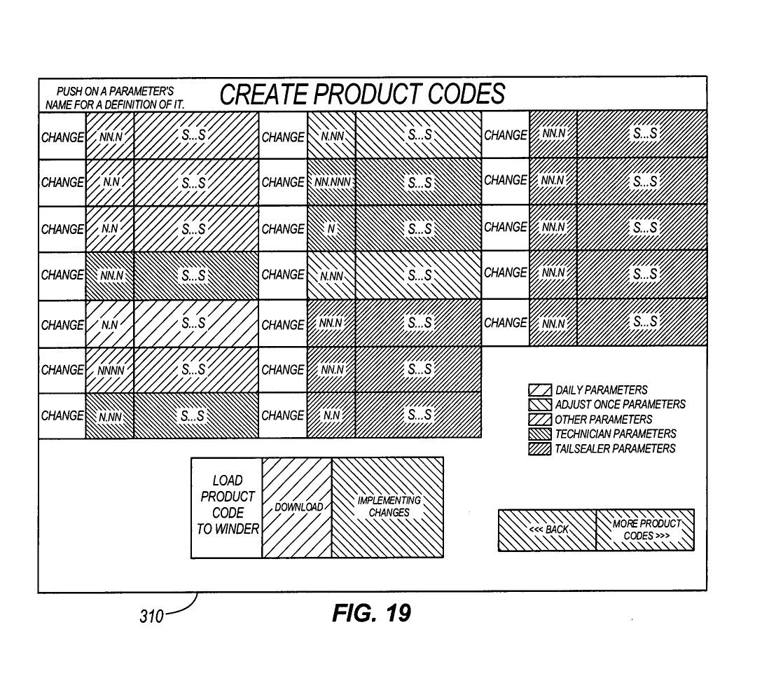

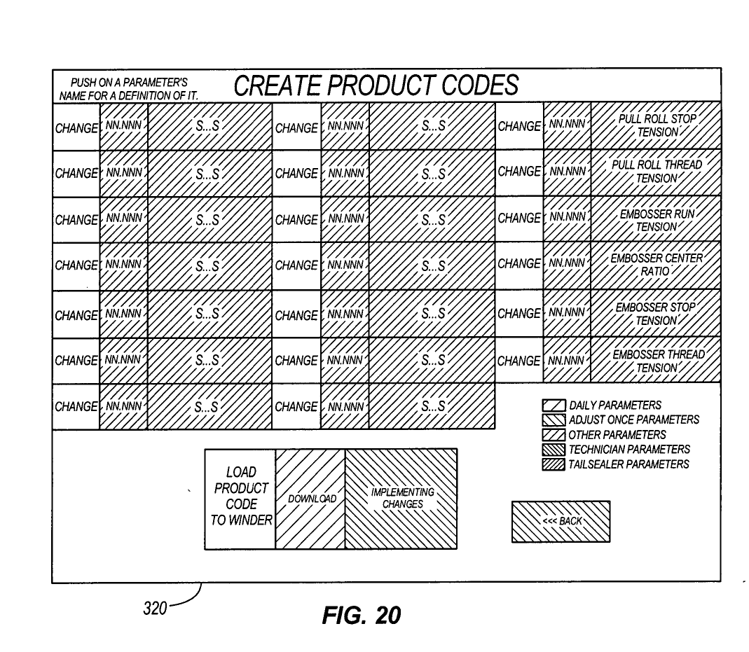

FIGS. 19 and 20 are additional create product codes screens 310 and 320 of the graphical user interface according to one embodiment of the invention. Screens 310 and 320 can be continuations of the set product codes screen 300 in that more product codes can be changed on the additional screens.

FIG. 21 is a monitor servos screen 330 of the graphical user interface according to one embodiment of the invention. The monitor servos screen 330 can appear after the Monitor Servos selector is selected at the main control screen 200. The monitor servos screen 330 can display fault messages and prompts for obtaining paper winder system 10 operating parameters.

The monitor servos screen 330 can include a Previous selector and a Next selector. The Previous selector and the Next selector can be used to scroll through servo axes. In some embodiments, the currently-selected servo axis is also displayed on the monitor servos screen 330.

The monitor servos screen 330 can include an Axis Number, an Axis Disabled/Enabled status, an Axis Position, and an Axis Velocity. The Axis Number can indicate a number of a currently-selected axis. The Axis Disabled/Enabled status can inform an operator as to whether a currently-selected axis is enabled. The Axis Position can indicate a position of a currently-selected axis, and the Axis Velocity can indicate a velocity of the currently-selected axis.

The monitor servos screen 330 can also include a Servo Diagnostic selector. Selecting the Servo Diagnostic selector can access a servo diagnostic main screen 370 (as described and illustrated below with respect to FIG. 25). In addition, the monitor servos screen 330 can include an Exit selector.

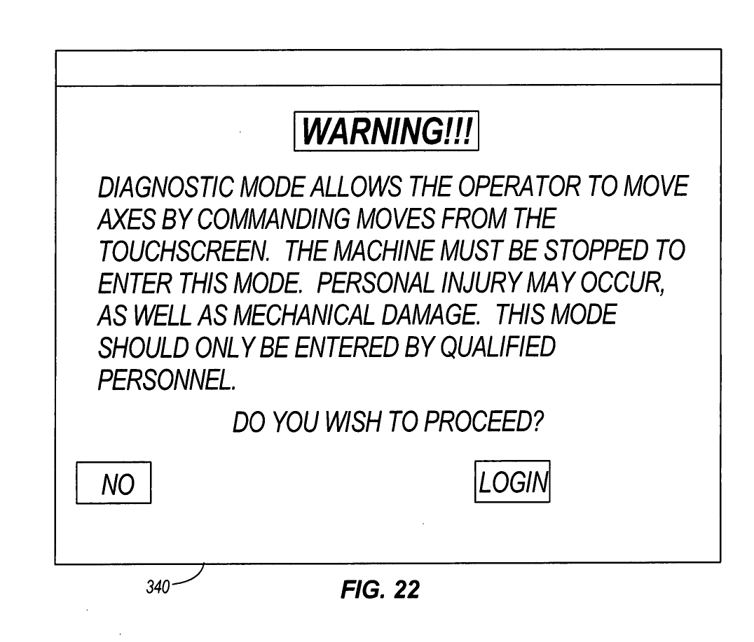

FIG. 22 is a diagnostic confirmation screen 340 of the graphical user interface according to one embodiment of the invention. The diagnostic confirmation screen 340 can appear after selecting the Servo Diagnostic selector on the servo monitor screen 330. The diagnostic confirmation screen 340 can display fault messages and prompts for obtaining paper winder system 10 operating parameters. The diagnostic confirmation screen 340 can also display a warning message that informs an operator of safety issues involved with using servo diagnostic functions.

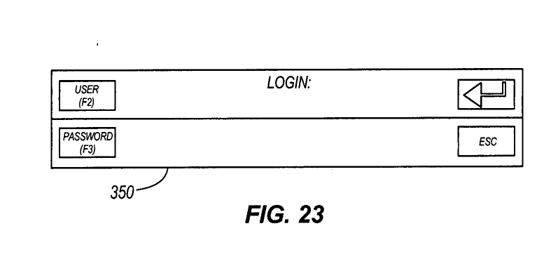

The diagnostic confirmation screen 340 can include a No selector and a Login selector. The diagnostic confirmation screen 340 can prompt an operator to select the Login selector in order to proceed and continue using servo diagnostic functions. In some embodiments, selecting the Login selector can access a login screen 350 (as described and illustrated below with respect to FIG. 23)

The diagnostic confirmation screen 340 can prompt an operator to select the No selector in order to cancel servo diagnostic functions. Selecting the No selector can close the diagnostic confirmation screen 340 and can display a previously-displayed screen, such as the servo monitor screen 330.

FIG. 23 is a login screen 350 according of the graphical user interface to one embodiment of the invention. The login screen 350 can appear after selecting the Login selector on the diagnostic confirmation screen 340. The login screen 350 can include a User selector and a Password selector. An operator can select the User selector to access a keypad that an operator can use to enter a username. Similarly, an operator can select the Password selector to access a keypad that an operator can use to enter a password. The login screen 350 can include an Enter selector that an operator can select after entering his or her username and password. The login screen 350 can also include an Escape selector that an operator can select to cancel the login process. In some embodiments, canceling the login process can close the login screen 350 and display a previously-displayed screen, such as the diagnostic confirmation screen 340.

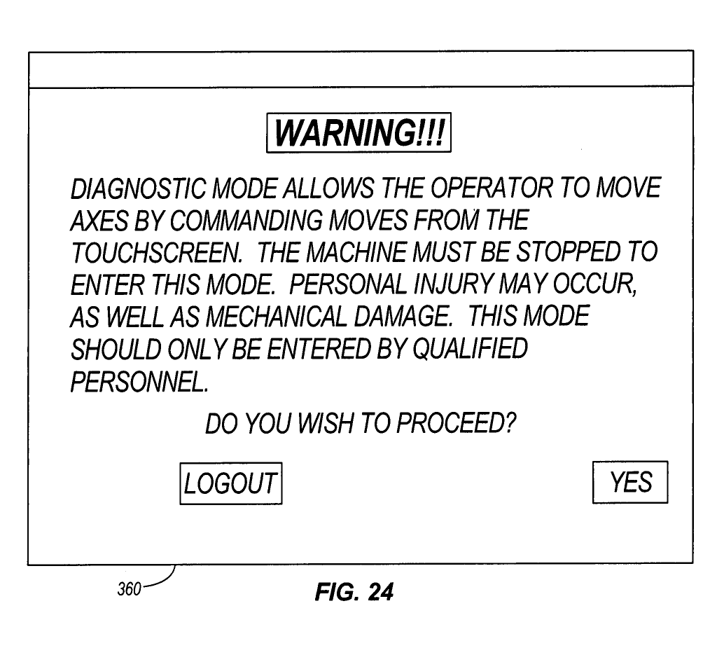

FIG. 24 is a login confirmation screen 360 of the graphical user interface according to one embodiment of the invention. The login confirmation screen 360 can appear after an operator has entered a valid username and password on the login screen 350. The login confirmation screen 360 can display fault messages and prompts for obtaining paper winder system 10 operating parameters. The login confirmation screen 360 can also display a warning message that informs an operator of safety issues involved with using servo diagnostic functions.

The login confirmation screen 360 can include a Logout selector and a Yes selector. The login confirmation screen 360 can prompt an operator to select the Logout selector in order to cancel servo diagnostic functions. In some embodiments, selecting the Logout selector can close the login confirmation screen 360 and display a previously-displayed screen, such as the diagnostic confirmation screen 340. Selecting the Logout selector can also lock out password protected functions that were unlocked when the operator entered a valid username and password on the login screen 350. The login confirmation screen 360 can prompt an operator to select the Yes selector to continue with servo diagnostic functions.

FIG. 25 is a servo diagnostic main screen 370 of the graphical user interface according to one embodiment of the invention. The servo diagnostic main screen 370 can appear after selecting the Servo Diagnostic selector on the monitor servos screen 330. In some embodiments, the servo diagnostic main screen 370 can appear after an operator has selected the Servo Diagnostic selector and entered a valid username and password on the login screen 350.

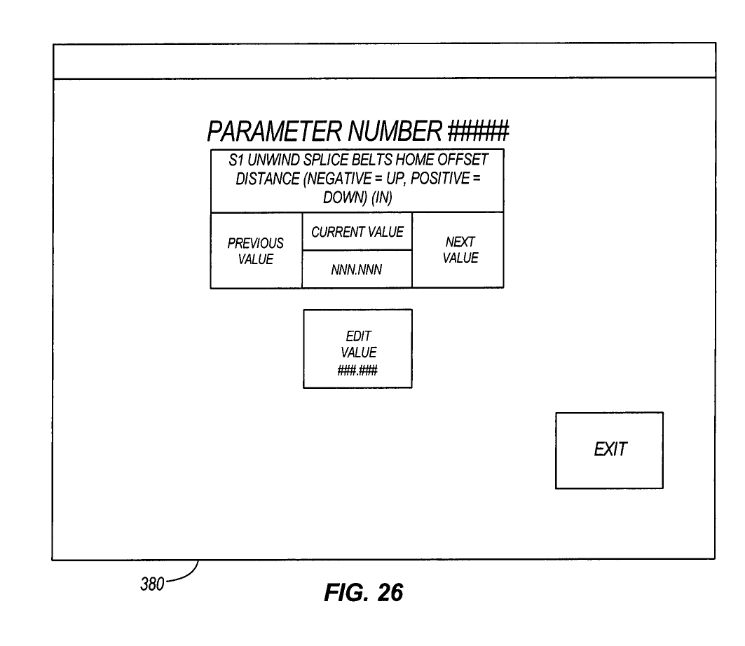

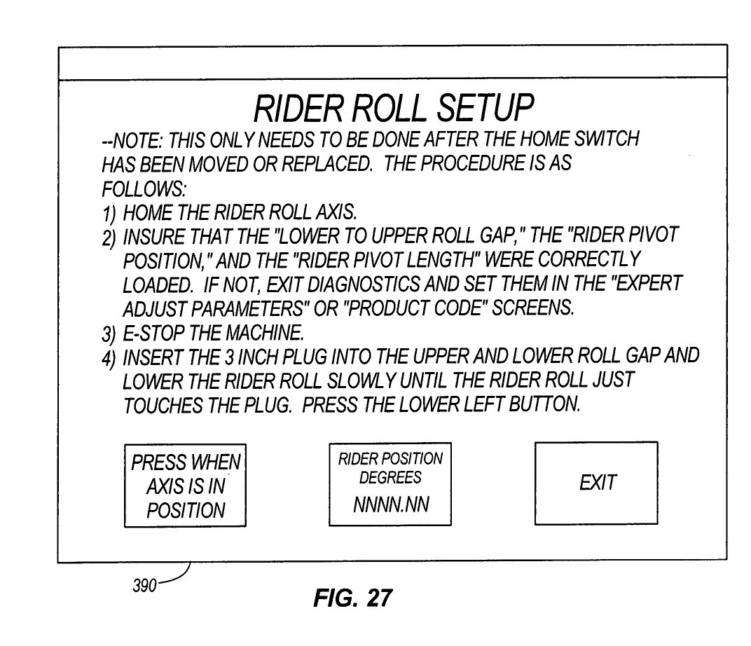

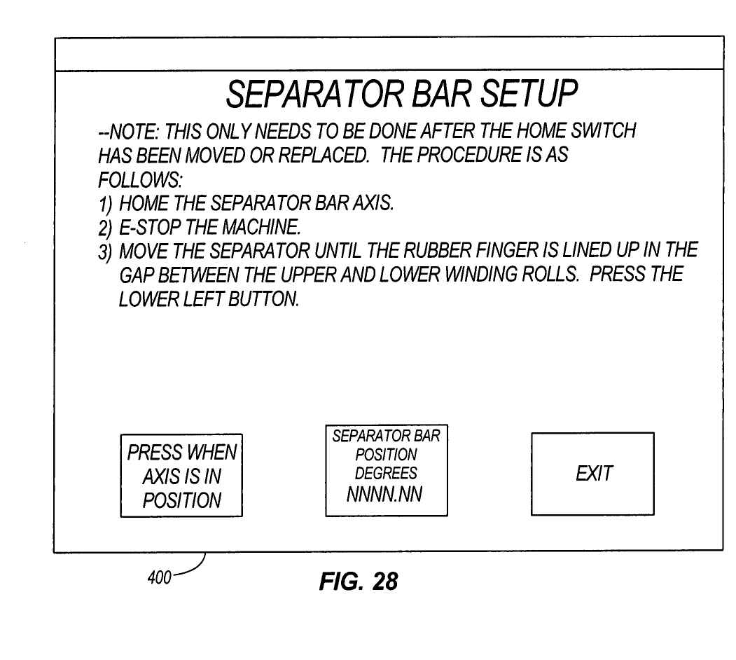

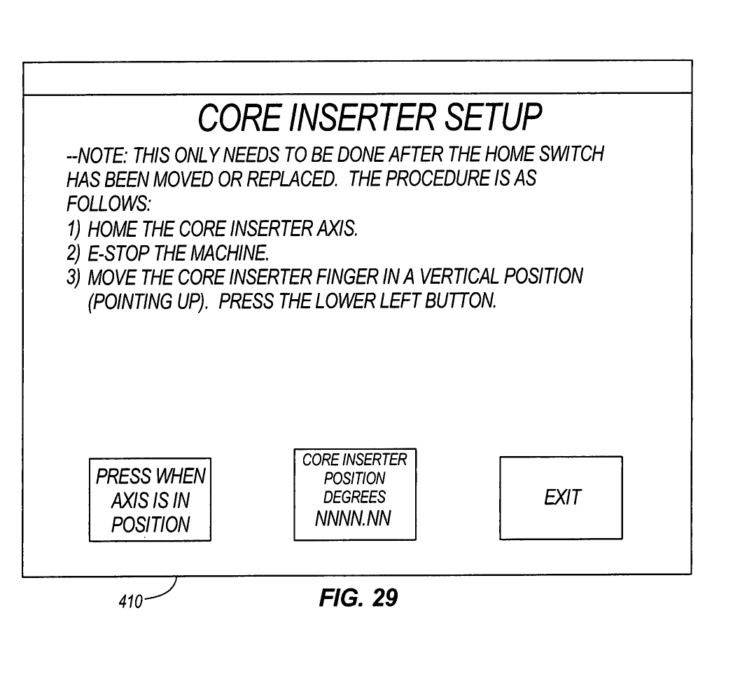

The servo diagnostic main screen 370 can display fault messages and prompts for obtaining paper winder system 10 operating parameters. The servo diagnostic main screen 370 can include an Axis Setup selector, a Rider Roll Setup selector, a Separator Bar Setup selector, and a Core Inserter Setup selector. An operator can select the Axis Setup selector in order to access an axis setup screen 380 (as described and illustrated below with respect to FIG. 26). Similarly, an operator can select the Rider Roll Setup selector in order to access a rider roll setup screen 390 (as described and illustrated below with respect to FIG. 27). Selecting the Separator Bar Setup selector can access a separator bar setup screen 400 (as described and illustrated below with respect to FIG. 28), and selecting the Core Inserter Setup selector can access a core inserter setup screen 410 (as described and illustrated below with respect to FIG. 29).

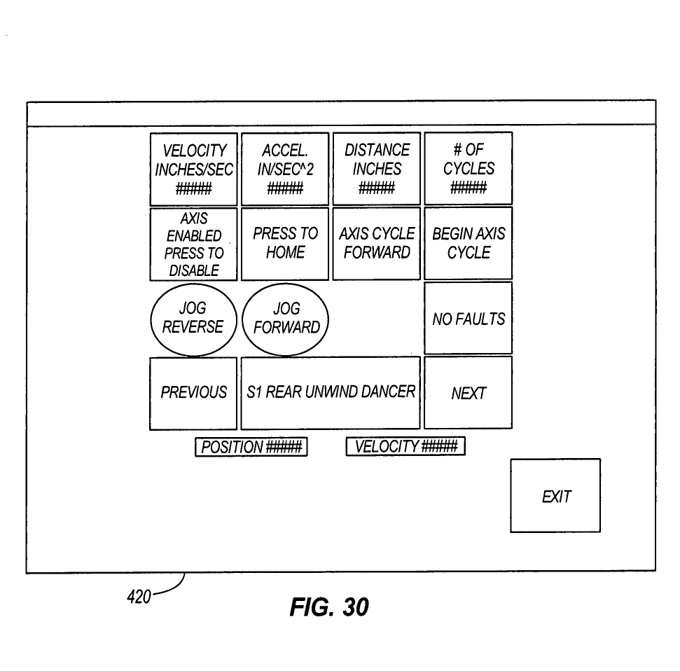

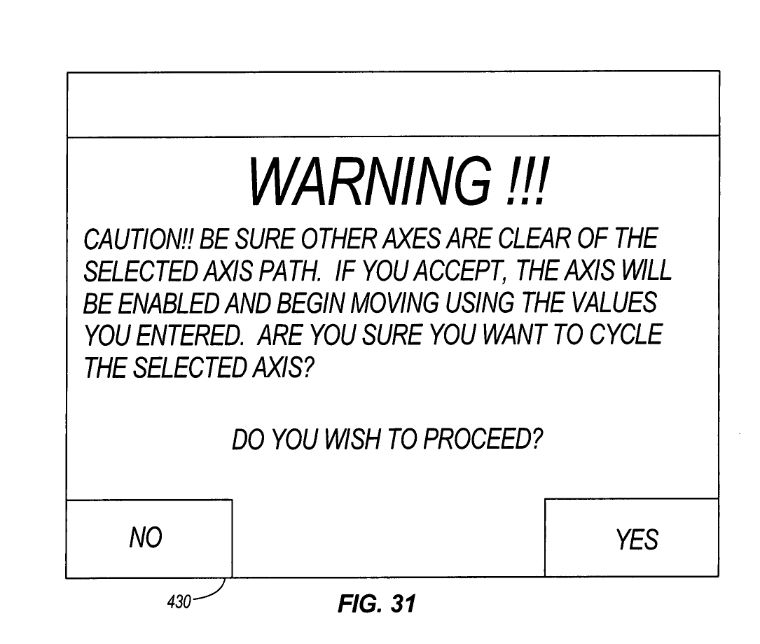

The servo diagnostic main screen 370 can also include an Axis Homing Job and Cycle selector that an operator can select in order to access an axis homing, axis jog, and axis cycle screen 420 (as described and illustrated below with respect to FIG. 30). In addition, the servo diagnostic main screen 370 can include a Change Message Screen selector. An operator can select the Change Message Screen selector in order to access a change message screen 430 (as described and illustrated below with respect to FIG. 31).

In some embodiments, the servo diagnostic main screen 370 can include a Help selector that an operator can select in order to access a help menu screen 460 (as described and illustrated below with respect to FIG. 34). The servo diagnostic main screen 370 can also include an Exit selector.

FIG. 26 is an axis setup screen 380 of the graphical user interface according to one embodiment of the invention. The axis setup screen 380 can appear after selecting the Axis Setup selector on the servo diagnostic main screen 370. The axis setup screen 380 can display fault messages and prompts for obtaining paper winder system 10 operating parameters.

The axis setup screen 380 can include a parameter number that indicates a number of a currently-selected parameter. The axis setup screen 380 can also include a description that provides a corresponding description of a currently-selected parameter. In some embodiments, a parameter can be selected by using a Previous selector and a Next selector. An operator can use the Previous selector and the Next selector to scroll through a list of available parameters. A value of a currently-selected parameter can also be displayed on the axis setup screen 380.

Once a parameter is selector, an operator can use an Edit Value selector to edit the value of the currently-selected parameter. In some embodiments, selecting the Edit Value selector can access a numeric keypad on which an operator can enter a parameter value. The axis setup screen 380 can also include an Exit selector.

FIG. 27 is a rider roll setup screen 390 of the graphical user interface according to one embodiment of the invention. The rider roll setup screen 390 can appear after selecting the Rider Roll Setup selector on the servo diagnostic main screen 370. The rider roll setup screen 390 can display fault messages and prompts for obtaining paper winder system 10 operating parameters. The rider roll setup screen 390 can also display instructions on setting up the rider roll 130. The instructions can include a recommended sequence or use of selecting particular selectors included on the rider roll setup screen 390. For example, the instructions can indicate when an operator should select a Press When Axis is in Position selector in order to indicate when an axis of the rider roll 130 is in a desired position.

The rider roll setup screen 390 can include a rider position that can indicate a current position of a rider roll 130. The rider roll setup screen 390 can also include an Exit selector.

FIG. 28 is a separator bar setup screen 400 of the graphical user interface according to one embodiment of the invention. The separator bar setup screen 400 can appear after selecting the Separator Bar Setup selector on the servo diagnostic main screen 370. The separator bar setup screen 400 can display fault messages and prompts for obtaining paper winder system 10 operating parameters. The separator bar setup screen 400 can also display instructions for an operator on setting up a separator bar. In some embodiments, the instructions can included a recommended sequence or use of particular selectors included on the separator bar setup screen 400. For example, the instructions can indicate when an operator should select a Press When Axis is in Position selector.

The separator bar setup screen 400 can also include a Separator Bar Position value that indicates a current position of a separator bar. The separator bar setup screen 400 can also include an Exit selector.

FIG. 29 is a core inserter setup screen 410 of the graphical user interface according to one embodiment of the invention. The core inserter setup screen 410 can appear after selecting the Core Inserter Setup selector on the servo diagnostic main screen 370. The core inserter setup screen 410 can display fault messages and prompts for obtaining paper winder system 10 operating parameters. The core inserter setup screen 410 can also display instructions for an operator regarding setting up a core inserter (as shown in FIG. 5). In some embodiments, the instructions can include a recommended sequence or use of particular selectors included on the core inserter setup screen 410. For example, the instructions can indicate when an operator should select a Press When Axis is in Position selector.

The core inserter setup screen 410 can also include a Core Inserter Position that indicates a current position of a core inserter. The core inserter setup screen 410 can also include an Exit selector.

FIG. 30 is an axis homing, axis jog, axis cycle screen 420 of the graphical user interface according to one embodiment of the invention. The axis homing, axis jog, axis cycle screen 420 can appear after selecting the Axis Homing Jog Cycle selector on the servo diagnostic main screen 370. The axis homing, axis jog, axis cycle screen 420 can display fault messages and prompts for obtaining paper winder system 10 operating parameters. The axis homing, axis jog, axis cycle screen 420 can also include a Faults Present Select to Clear selector that can be used to clear fault messages displayed on the axis homing, axis jog, axis cycle screen 420. In some embodiments, if there are no faults, the selector can be disabled and can display a message, such as “No Faults.”

The axis homing, axis jog, axis cycle screen 420 can include a Previous selector and a Next selector. An operator can use the Previous selector and the Next selector to scroll through a list of servo axes in order to select a particular servo axis. In some embodiments, a currently-selected servo axis is also displayed on the axis homing, axis jog, axis cycle screen 420. A current position value and a current velocity value for a currently-selected axis can also be displayed on the axis homing, axis jog, axis cycle screen 420.

The axis homing, axis jog, axis cycle screen 420 can include Velocity, Acceleration, Distance, and Number of Cycles values for a currently-selected axis. In some embodiments, the axis homing, axis jog, axis cycle screen 420 can also include Adjust selectors that an operator can select in order to modify the value of the Velocity, the Acceleration, the Distance, and/or the Number of Cycles for a currently-selected axis.

The axis homing, axis jog, axis cycle screen 420 can include an Axis Enabled Select to Disable selector. Selecting the Axis Enabled Select to Disable selector can change the condition of a currently-selected axis to disabled. In some embodiments, the Axis Enabled Select to Disable selector changes based on the condition of a currently-selected axis. For example, when the currently-selected axis is enabled, the selector can include an Axis Enabled Select to Disable selector in order to disable the axis. When the currently-selected axis is disabled, the selector can include an Axis Disabled Select to Disable selector in order to enable the axis. Changing the selector based on the condition of a currently-selected axis can provide an indication of a current condition of an axis. Separate selectors can also be used and one of the selectors can be disabled based on a current condition of a currently-selected axis.

The axis homing, axis jog, axis cycle screen 420 can include a Select to Home selector that can be selected in order to move an axis to a home position for a currently-selected axis.

If an operator desires to cycle a currently-selected axis, an operator can select the Axis Cycle Forward Reverse selector in order to choose a direction to cycle the currently-selected axis. To begin an axis cycling procedure, an operator can select a Begin Axis Cycle selector. In some embodiments, an axis cycle confirmation screen 430 (as described and illustrated below with respect to FIG. 31) is displayed before axis cycling beings. Once the cycling procedure has started and is being performed, the Begin Axis Cycle selector can be disabled and can display a message, such as “Axis Cycling.”

The axis homing, axis jog, axis cycle screen 420 can include a Jog Reverse selector and a Jog Forward selector that can be used to jog a currently-selected axis in a reverse direction or forward direction, respectively. In addition, the axis homing, axis jog, axis cycle screen 420 can include an Exit selector.

FIG. 31 is an axis cycle confirmation screen 430 of the graphical user interface according to one embodiment of the invention. The axis cycle confirmation screen 430 can appear after selecting the Begin Axis Cycle selector on the axis homing, axis jog, axis cycle screen 420. The axis cycle confirmation screen 430 can display fault messages and prompts for obtaining paper winder system 10 operating parameters. The axis cycle confirmation screen 430 can also display a warning message that informs an operator of safety issues involved with using axis cycle functions.

The axis cycle confirmation screen 430 can include a No selector and a Yes selector. After reading the warning message, an operator can cancel axis cycling functions by selecting the No selector. Selecting the No selector can also display a previously-displayed screen, such as the axis homing, axis jog, axis cycle screen 420.

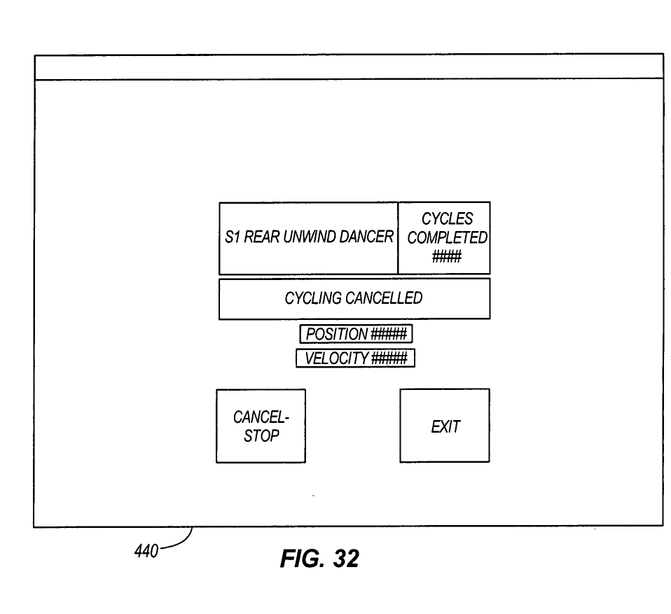

An operator can also continue with axis cycling functions by selecting the Yes selector. In some embodiments, selecting the Yes selector accesses a cycle monitor screen 440, as shown in FIG. 32. The cycle monitor screen 440 can display fault messages and prompts for obtaining paper winder system 10 operating parameters.

The cycle monitor screen 440 can include an Axis Currently Cycling display, a Number of Cycles Completed display, a Status display, a Position display and a Velocity display. The cycle monitor screen 440 can include a Cancel/Stop selector that an operator can select to cancel an axis cycle function. In addition, the cycle monitor screen can include an Exit selector.

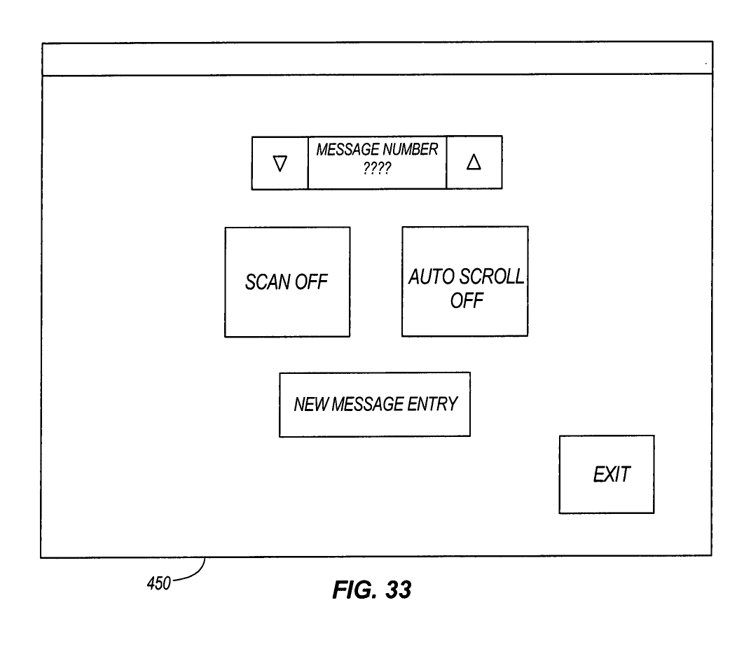

FIG. 33 is a change message screen 450 of the graphical user interface according to one embodiment of the invention. The change message screen 450 can appear after selecting the Change Message selector on the servo diagnostic main screen 370. The change message screen 450 can display fault messages and prompts for obtaining paper winder system 10 operating parameters.

The change message screen 450 can include a Message Number selector. An operator can select the Message Number selector in order to access a numeric keypad on which the operator can enter a specific message number. The Message Number selector can also display a number of a currently-selected message. In some embodiments, the Message Number selector includes an Up selector and a Down selector. An operator can use the Up selector and Down selector to scroll through messages.

The change message screen 450 can include a Scan On/Off selector. Selecting the Scan On/Off selector can start and stop a message scanning feature. The message scanning feature can allow an operator to scroll through messages using the Up selector and Down selector. In some embodiments, the message scanning features must be stopped before an operator can change a message. The change message screen 450 can also include an Automatic Scroll On/Off selector. Selecting the Automatic Scroll On/Off selector can start and stop an automatic message scanning feature that automatically scrolls through messages, without requiring an operator to use the Up selector and the Down selector. In some embodiments, the automatic message scanning feature must be turned off before an operator can change a message.

The change message screen 450 can include a New Message Entry selector. An operator can select the New Message Entry selector in order to change text of a currently-selected message. In some embodiments, selecting the New Message Entry selector can access a keypad screen that allow an operator to type in or edit a message. The change message screen 450 can also include an Exit selector.

FIG. 34 is a help menu screen 460 of the graphical user interface according to one embodiment of the invention. The help menu screen 460 can appear after selecting the Help Menu selector on the main control screen 200. The help menu screen 460 can display fault messages and prompts for obtaining paper winder system 10 operating parameters.

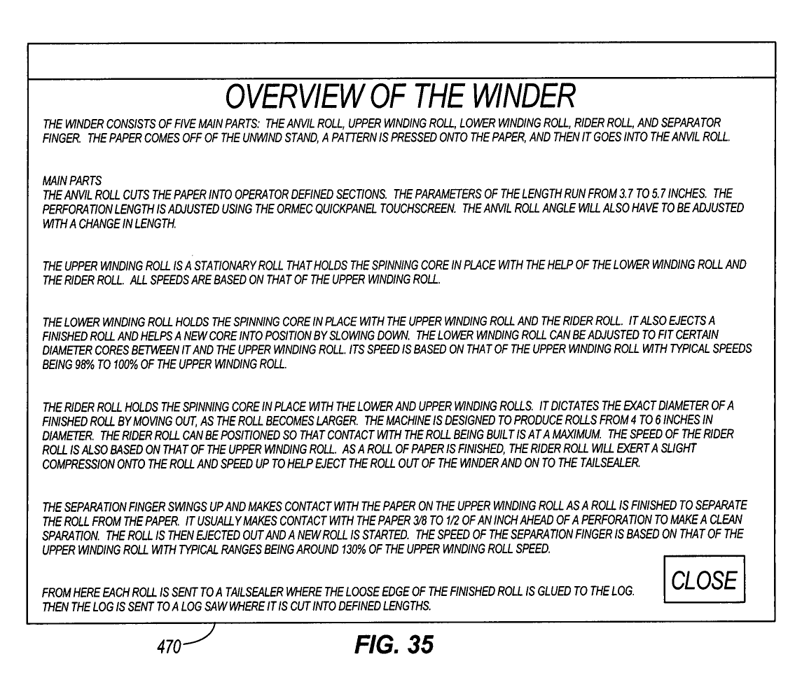

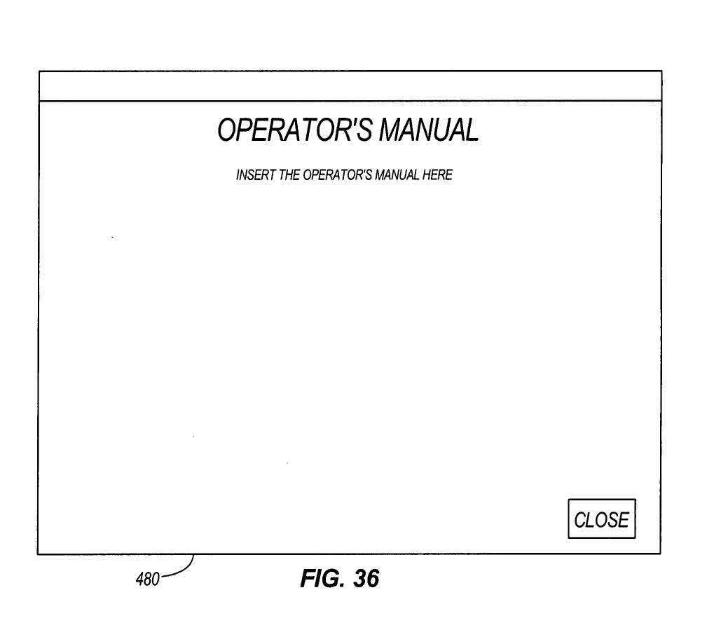

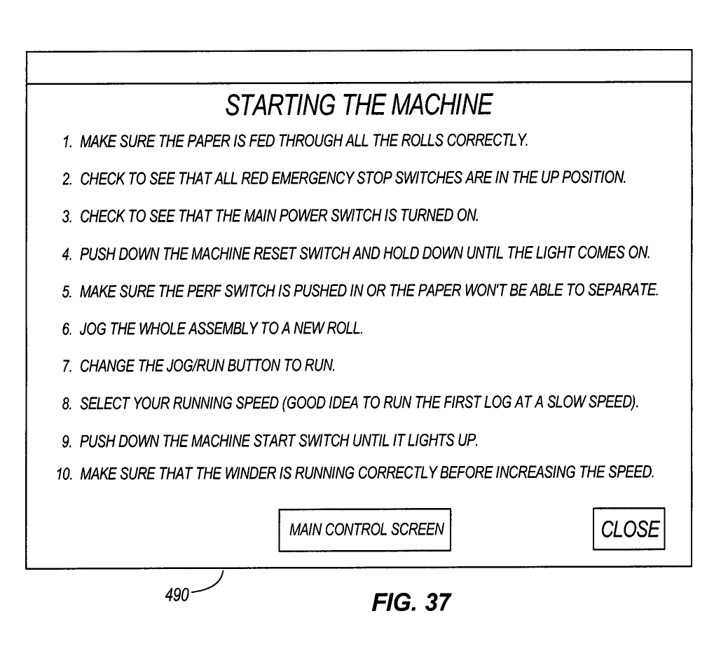

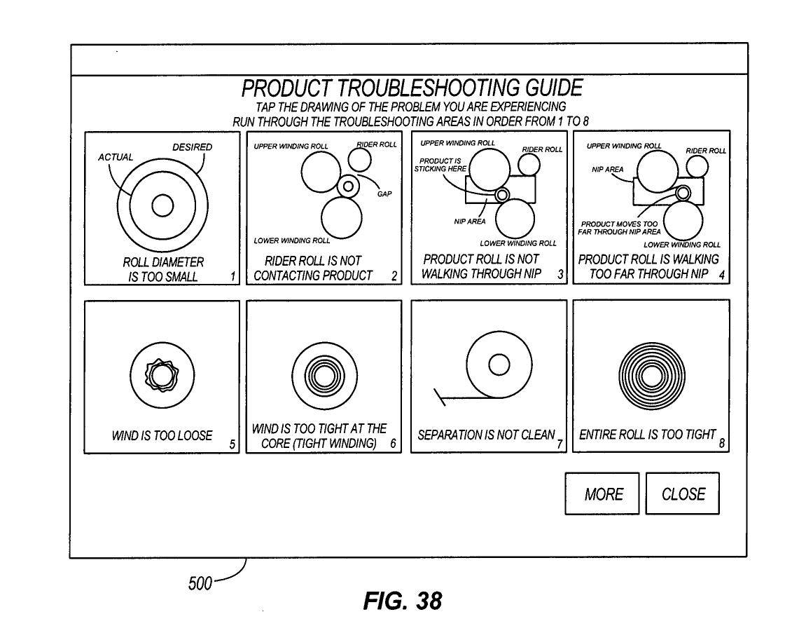

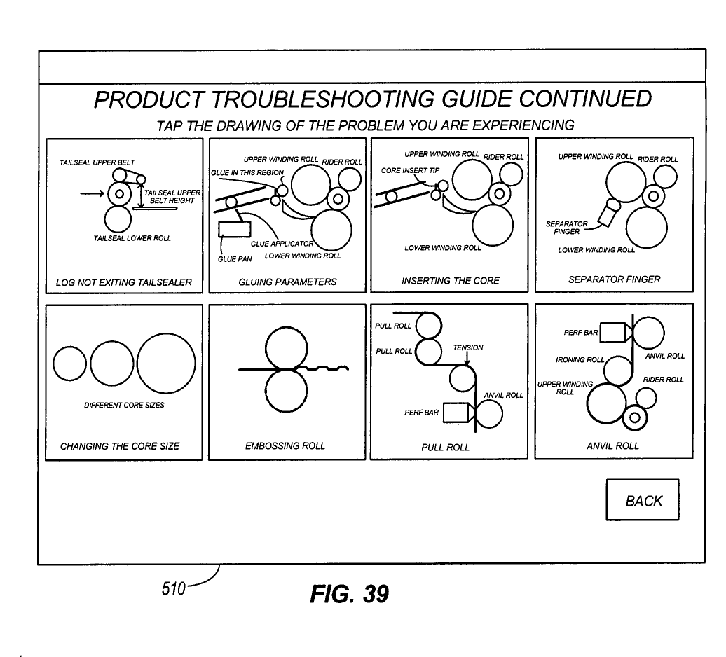

The help menu screen 460 can include an Overview selector, an Operator Manual selector, a Starting the Machine selector, and a Troubleshoot Product selector. Selecting the Overview selector can access an overview screen 470 that includes an overview of operation of the paper winder system (as described and illustrated below with respect to FIG. 35). Selecting the Operator Manual selector can access an operator's manual screen 480 that includes an electronic version of an operation and maintenance manual of the paper winder system (as described and illustrated below with respect to FIG. 36). Selecting the Starting the Machine selector can access a starting the machine screen 490 that provides a starting sequence for the paper winder system (as described and illustrated below with respect to FIG. 37). Selecting the Troubleshoot Product selector an access a product troubleshooting screen 500 that provides a product troubleshooting guide (as described and illustrated below with respect to FIGS. 38 and 39).

FIG. 35 is an overview screen 470 of the graphical user interface according to one embodiment of the invention. The overview screen 470 can appear after selecting the Overview selector on the help menu screen 460. The overview screen 470 can provide a general overview of an operational sequence of the paper winder system 10. The overview screen 470 can also display fault messages and prompts for obtaining paper winder system 10 operating parameters. In addition, the overview screen 470 can include a Close selector.

FIG. 36 is an operator's manual screen 480 of the graphical user interface according to one embodiment of the invention. The operator's manual screen 480 can appear after selecting the Operator Manual selector on the help menu screen 460. The operator's manual screen 480 can provide an electronic version of an operation and maintenance manual for the paper winder system 10. The operator's manual screen 480 can display fault messages and prompts for obtaining paper winder system 10 operating parameters. The operator's manual screen 480 can also include a Close selector.

FIG. 37 is a starting the machine screen 490 of the graphical user interface according to one embodiment of the invention. The starting the machine screen 490 can appear after selecting the Starting the Machine selector on the help menu screen 460. The starting the machine screen 490 can provide instructions for an operator on starting procedures for the paper winder system 10. The starting the machine display can display fault messages and prompts for obtaining paper winder system 10 operating parameters. The starting the machine screen 490 can also include a Close selector.

FIG. 38 is a product troubleshooting screen 500 of the graphical user interface according to one embodiment of the invention. The product troubleshooting screen 500 can appear after selecting the Troubleshoot Product selector on the help menu screen 460. The product troubleshooting screen 500 can help an operator troubleshoot the paper winder system 10. The product troubleshooting screen 500 can also display fault messages and prompts for obtaining paper winder system 10 operating parameters.

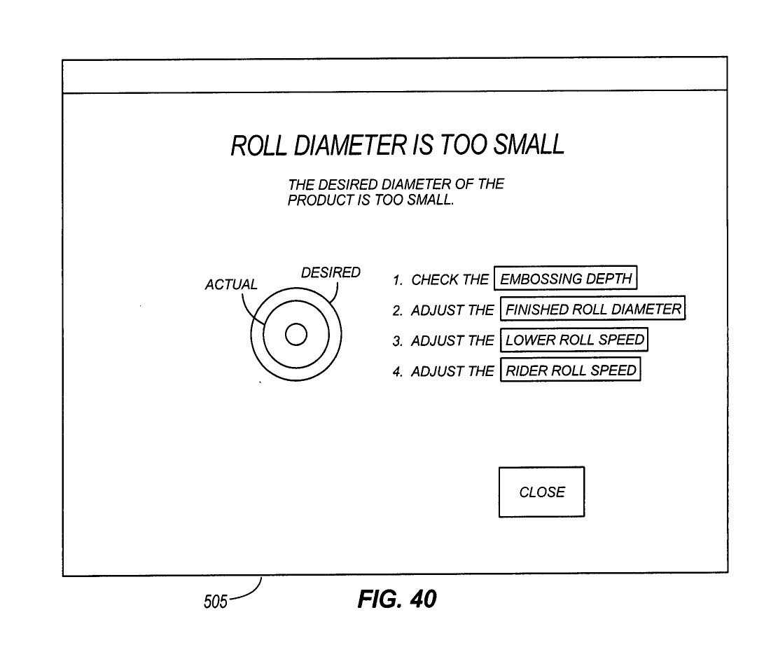

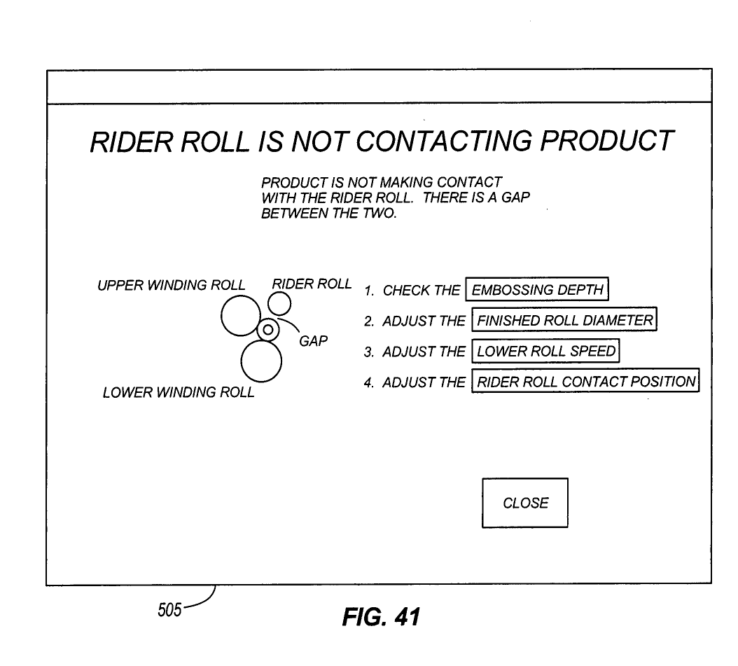

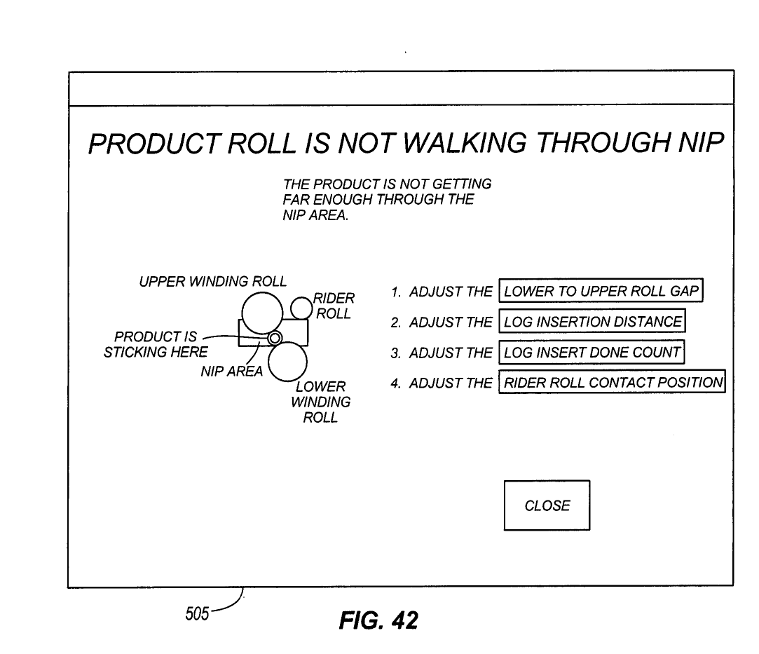

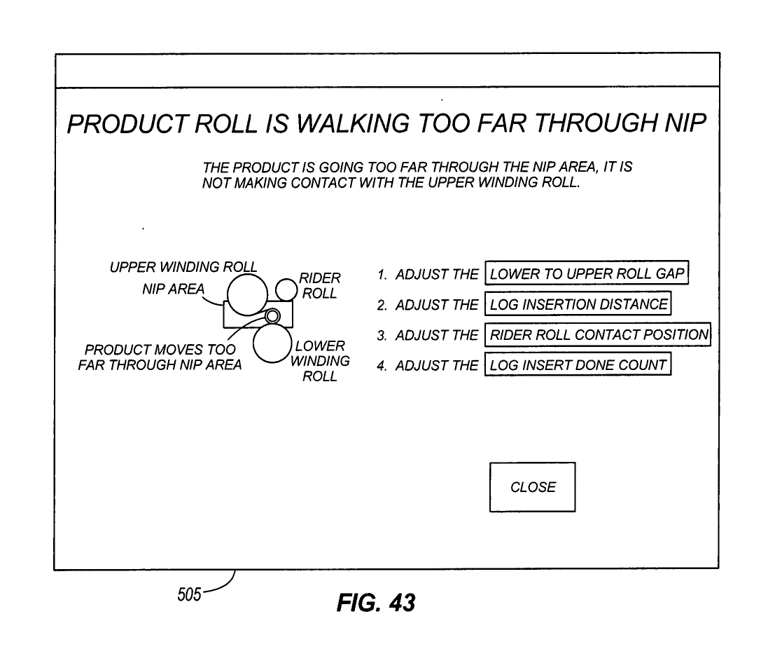

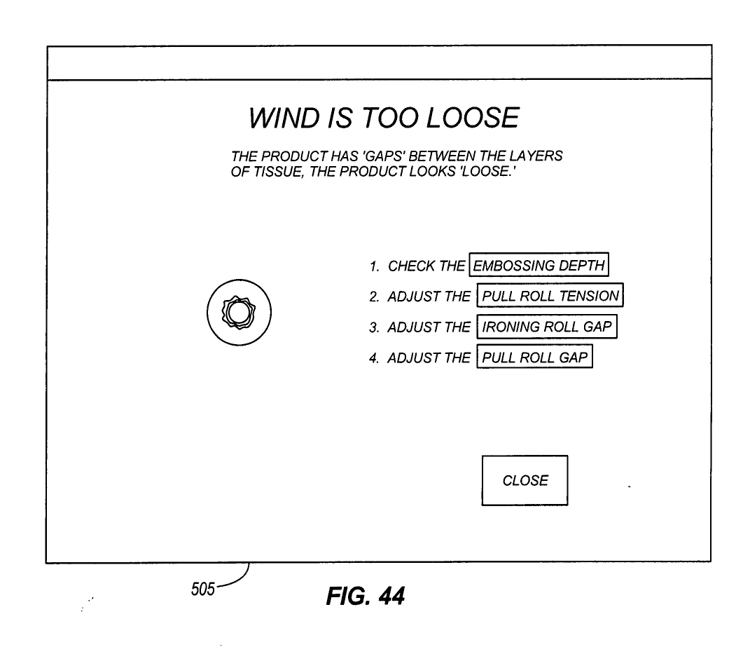

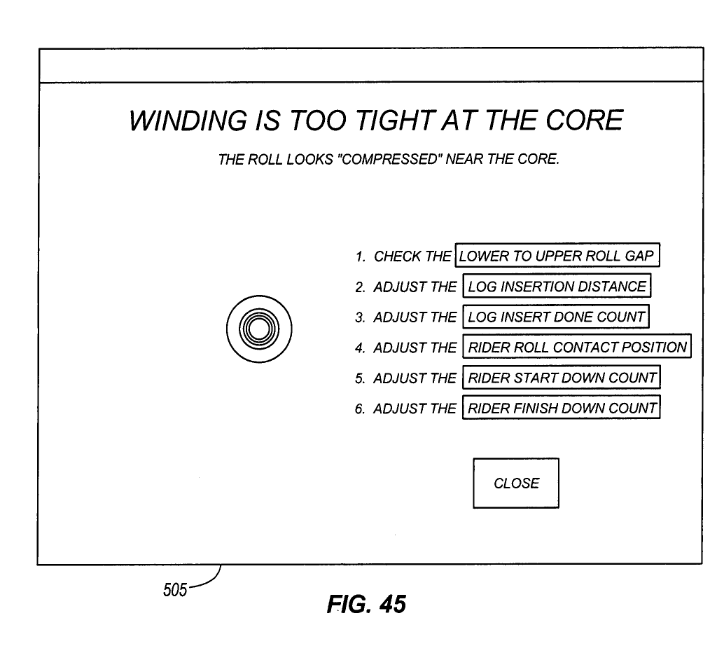

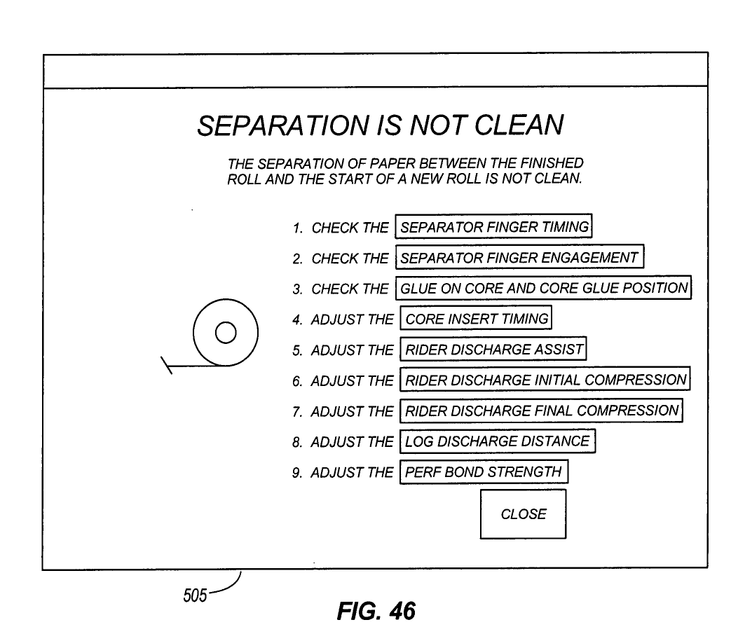

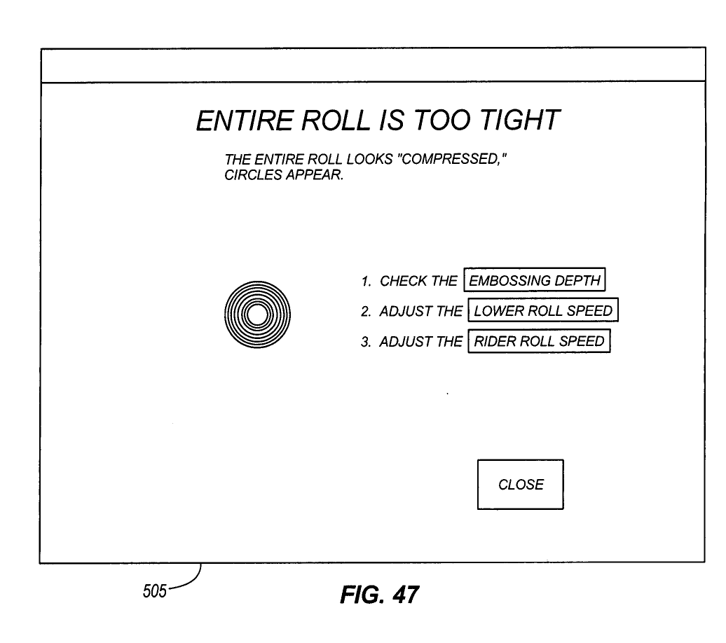

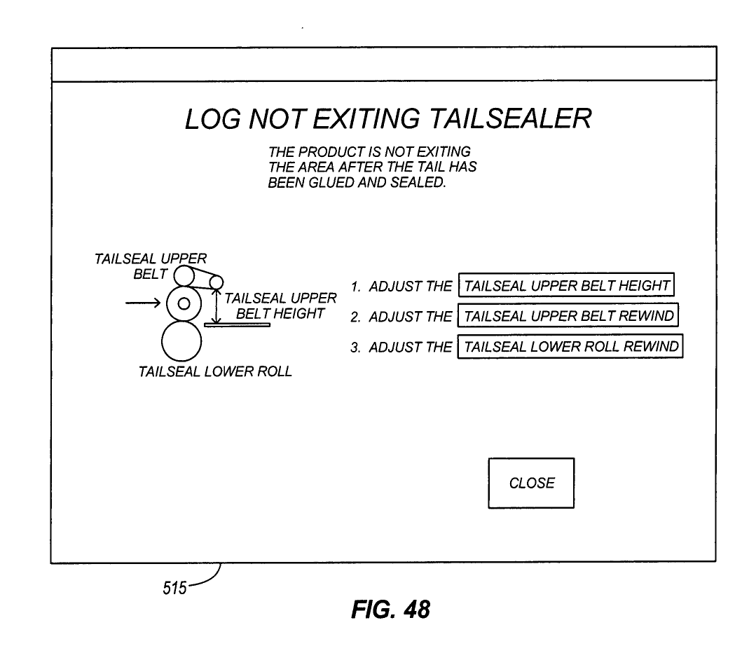

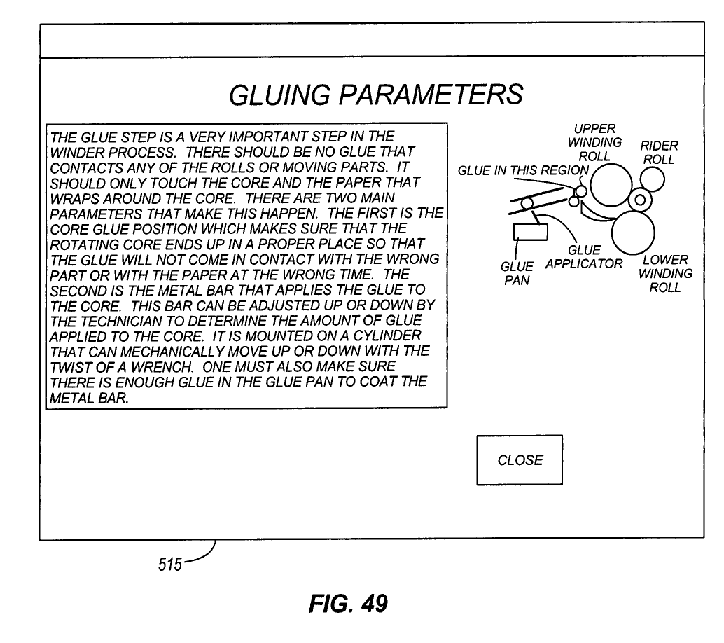

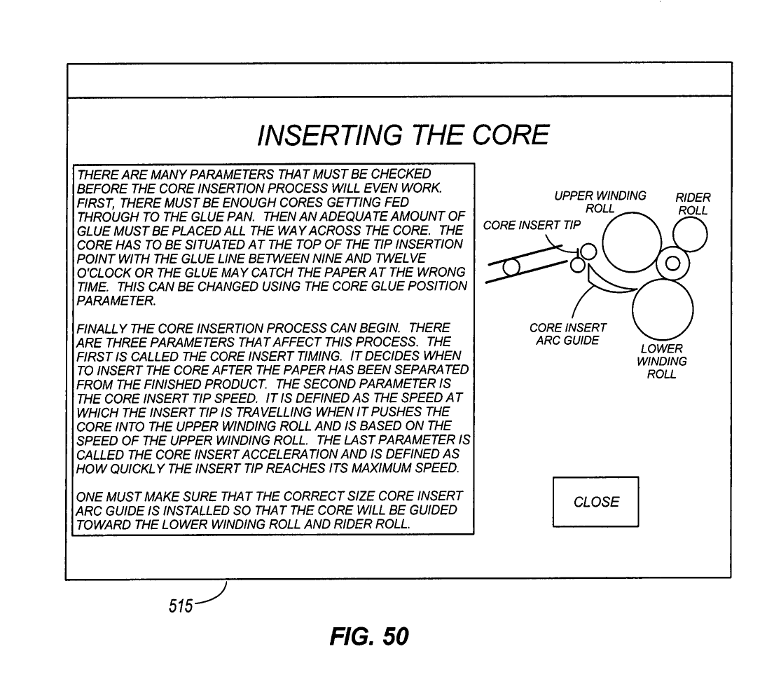

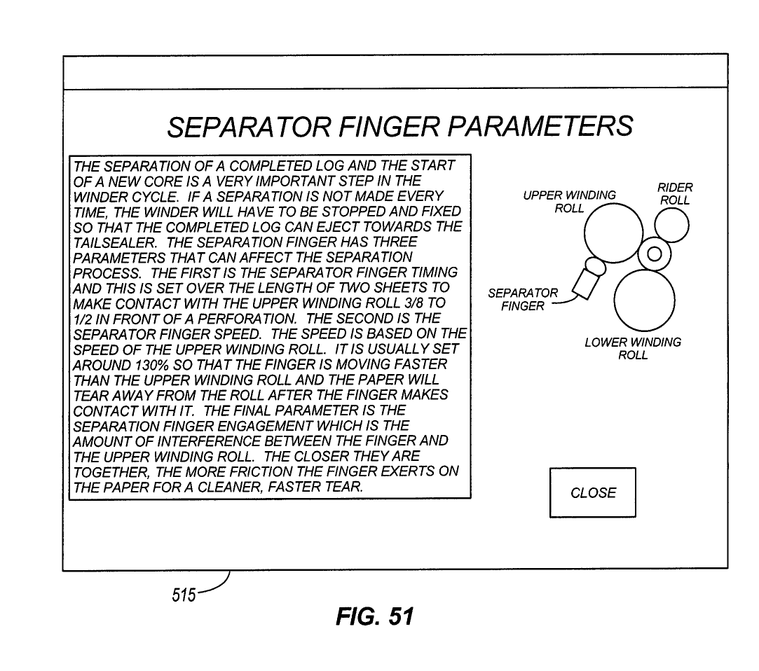

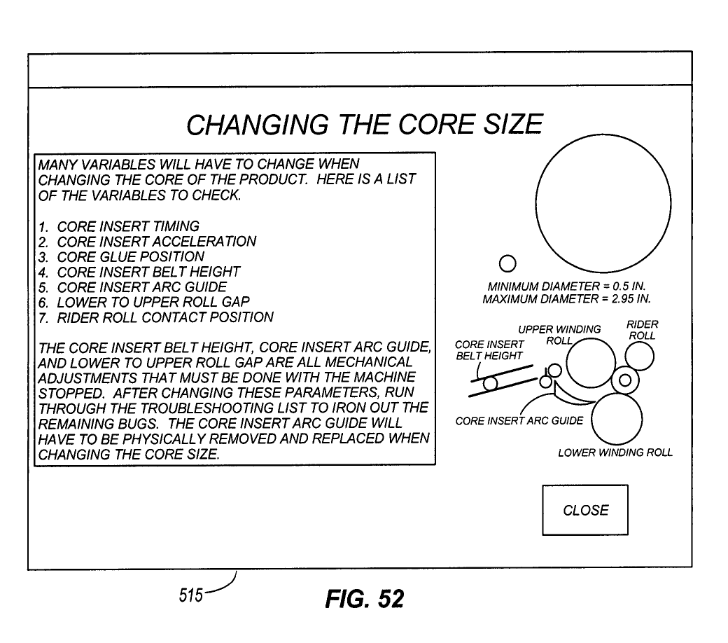

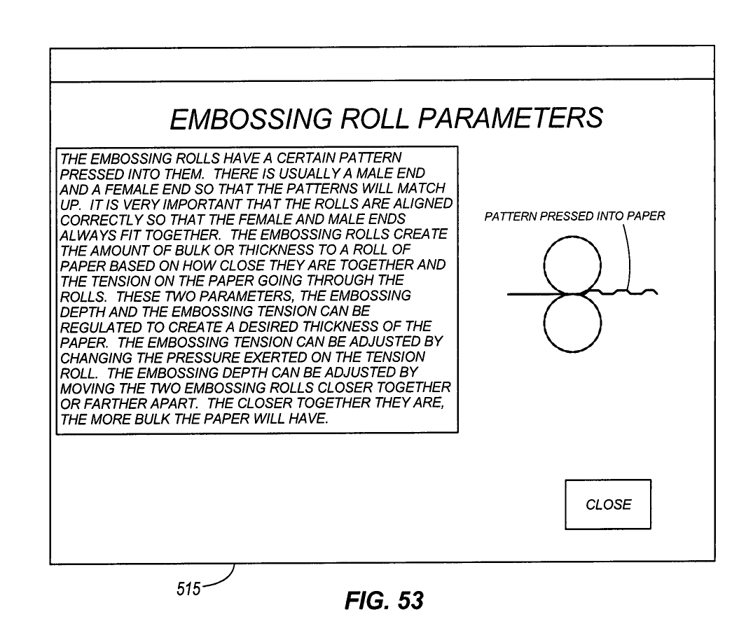

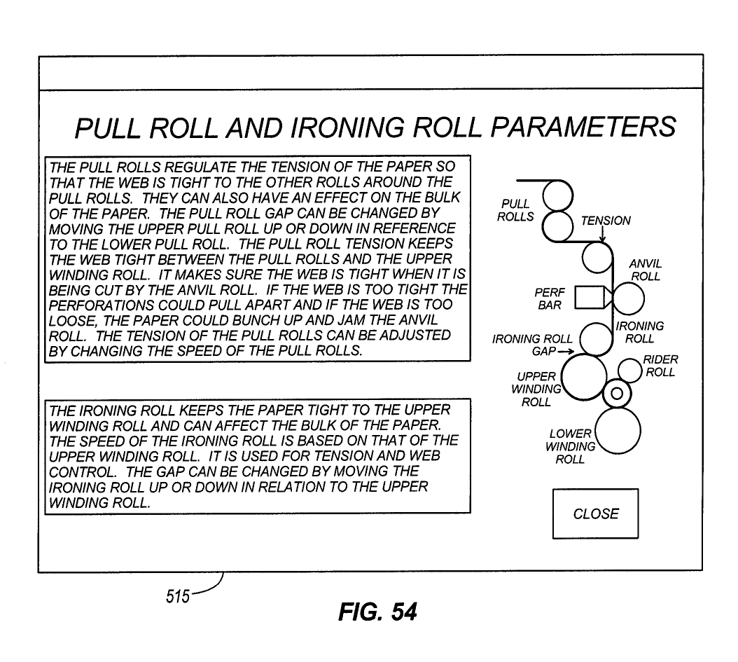

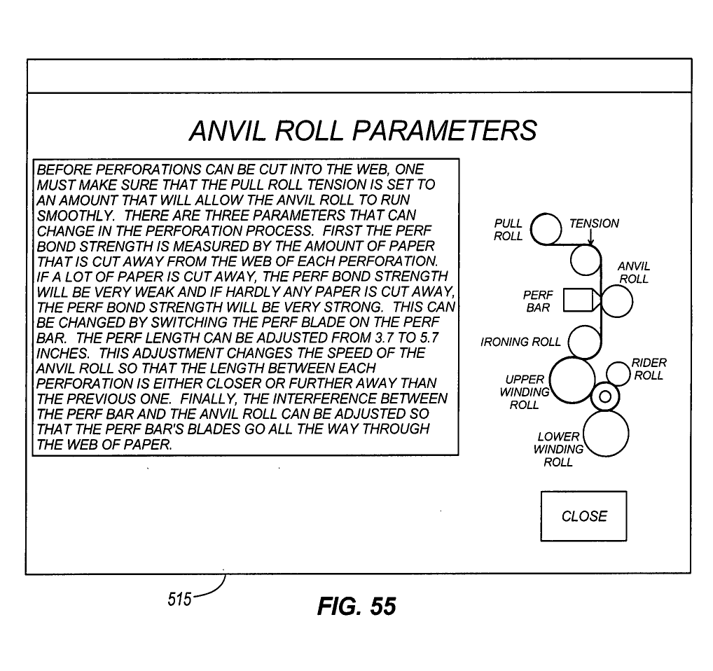

In some embodiments, the product troubleshooting screen 500 can include one or more Problem selectors. The product troubleshooting screen 500 can prompt an operator to select one of the Problem selectors in order to indicate one or more problems that the operator is experiencing with the paper winder system 10. Selecting one of the Problem selectors can access a troubleshooting help screen 505 (examples of which are shown and described with respect to FIGS. 40-55) that instructs an operator on procedures to correct the corresponding product quality issues. In some embodiments, each Problem selector can also include a figure or illustration of a problem in order to guide an operator to select a Problem selector.

In some embodiments, the product troubleshooting screen 500 can include a More selector that can be selected in order to access additional Problem selectors on an additional product troubleshooting screen 510, as shown in FIG. 39. The additional product troubleshooting screen 510 can include a Back selector that when selected can close the additional product troubleshooting screen 500 and display the product troubleshooting screen 500 of FIG. 38. As shown in FIG. 38, the product troubleshooting screen 500 can also include a Close selector.

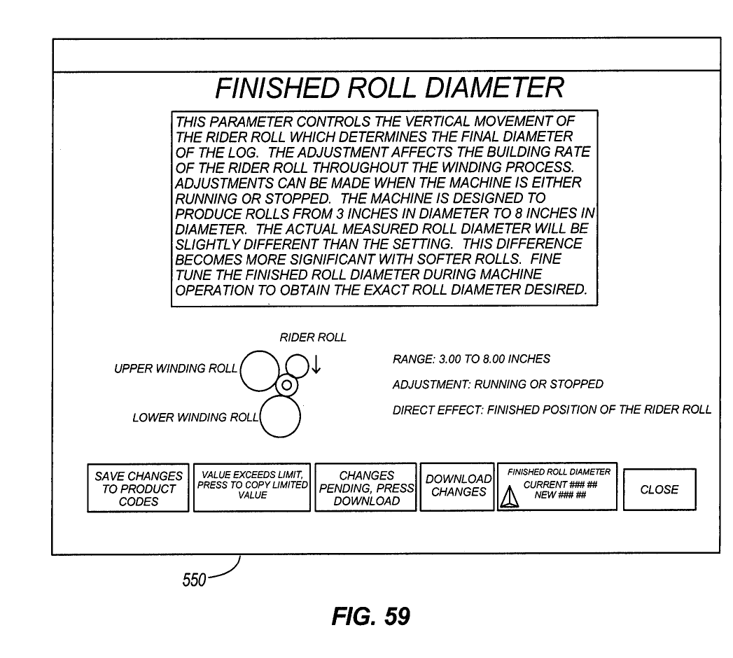

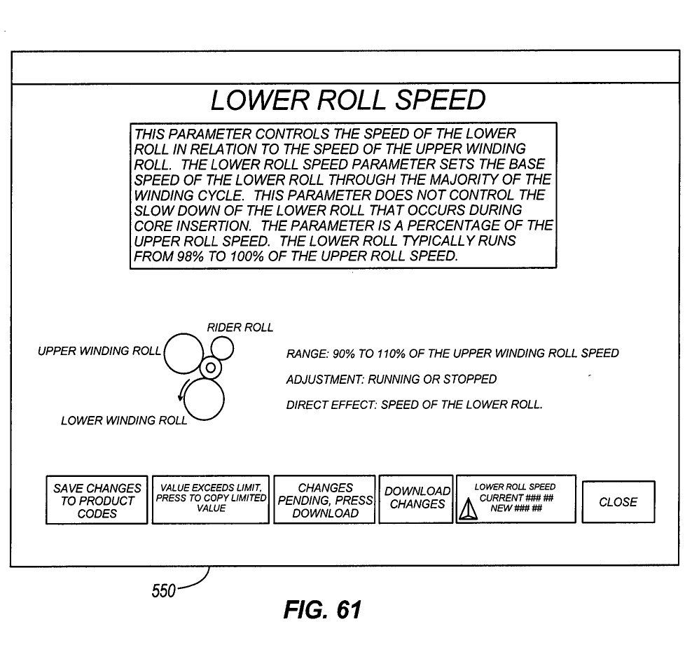

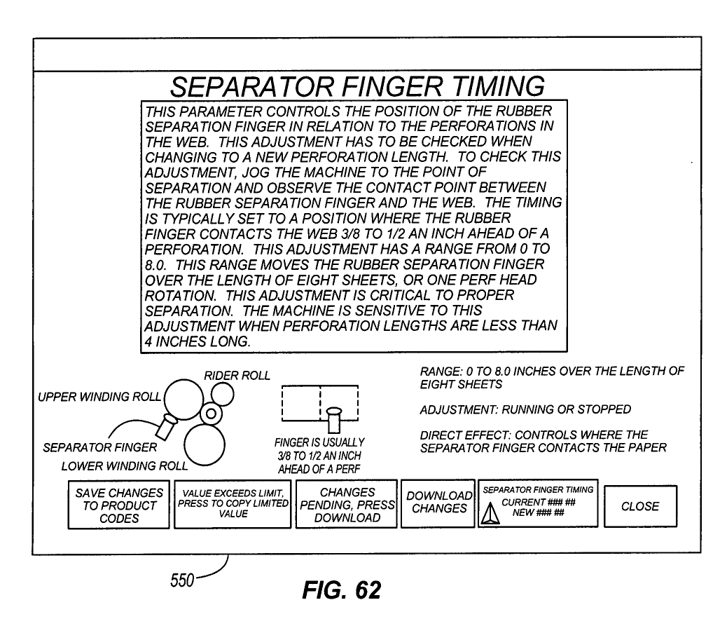

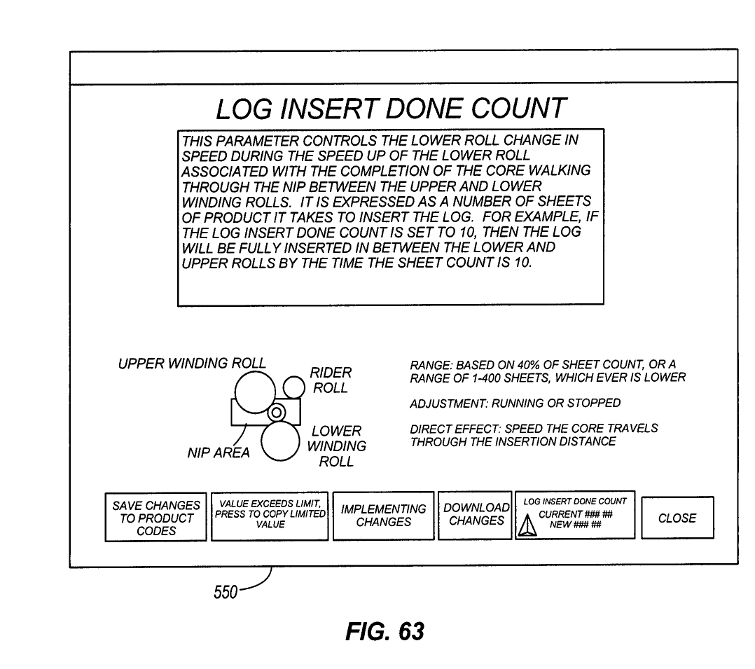

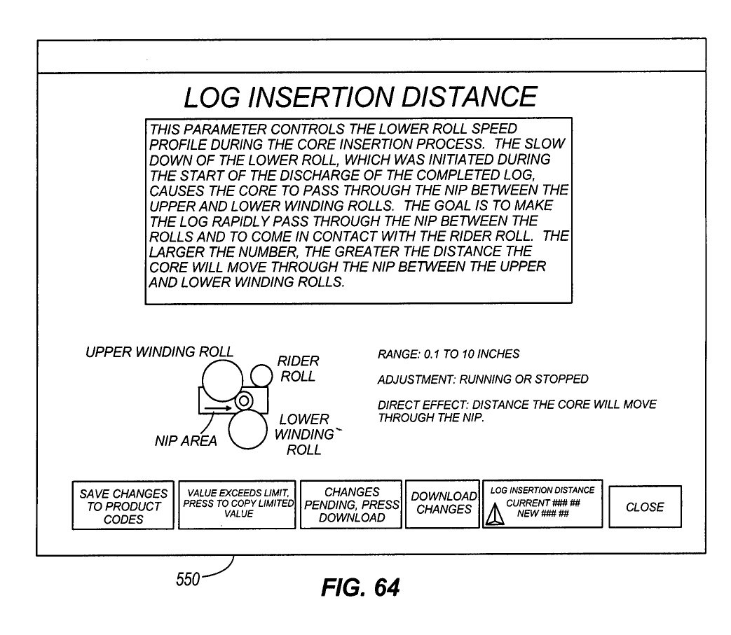

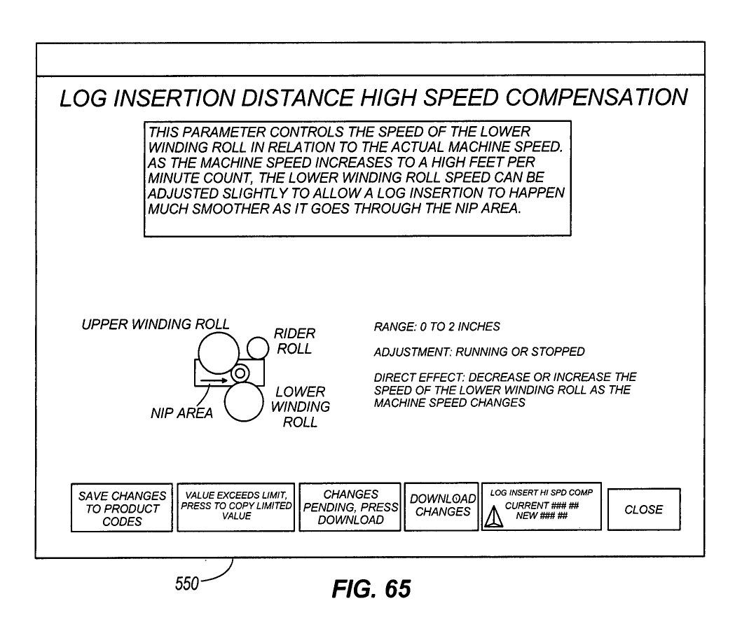

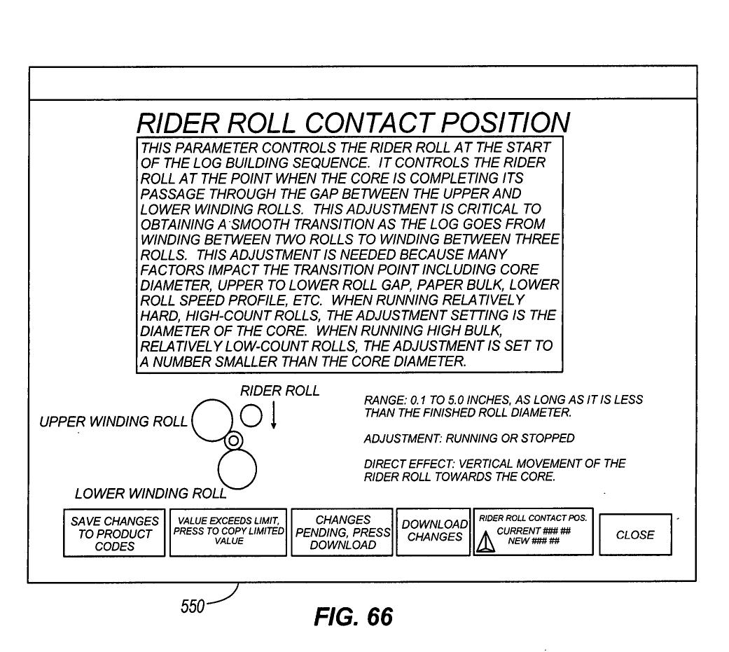

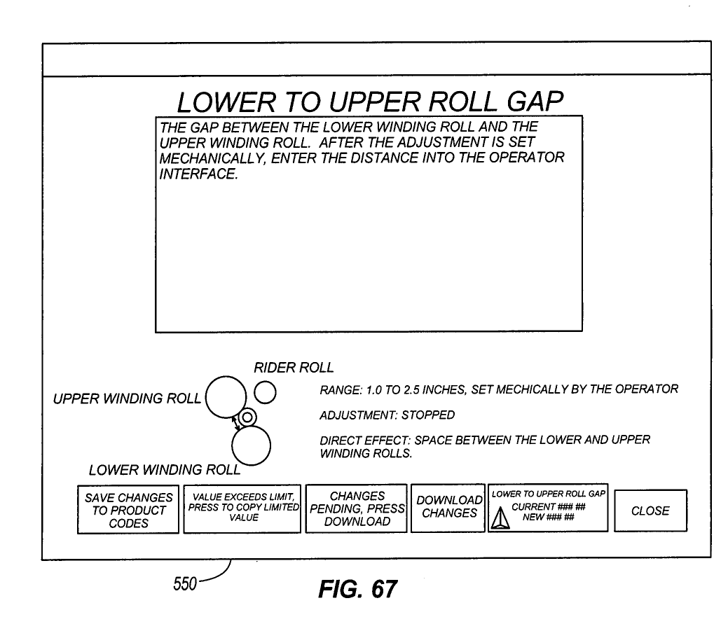

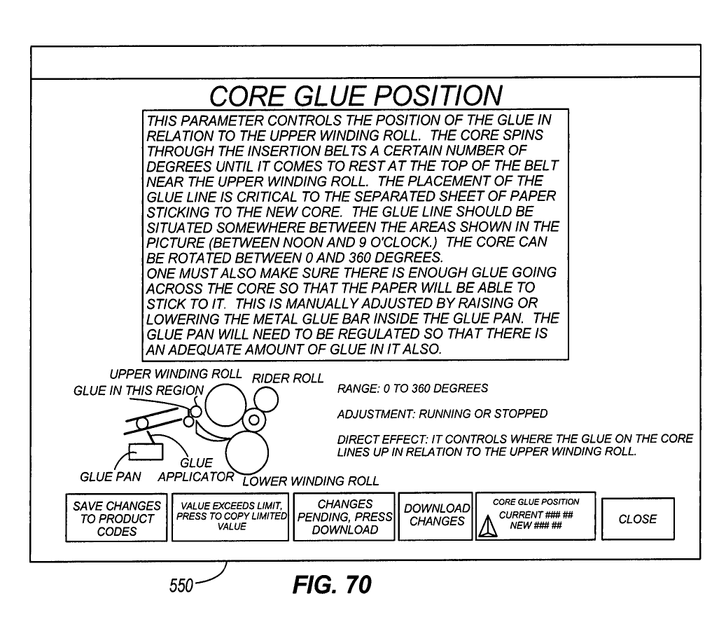

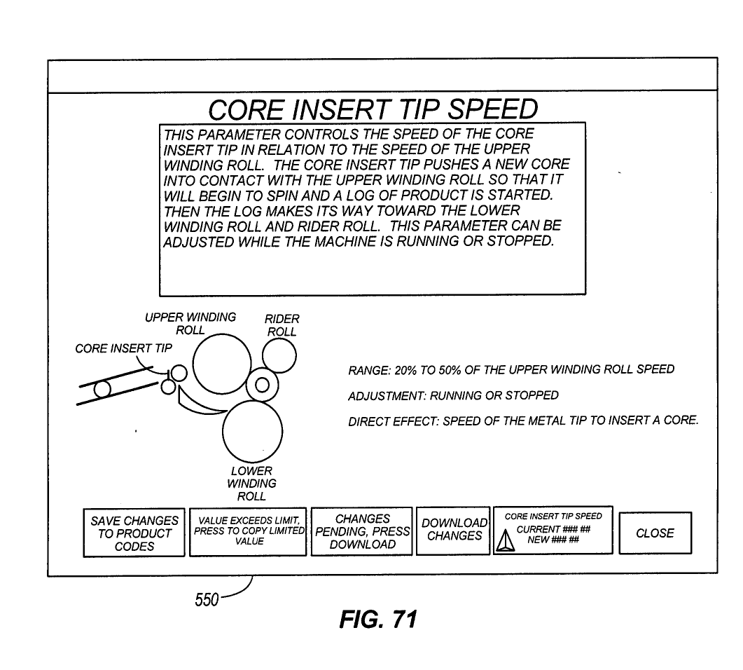

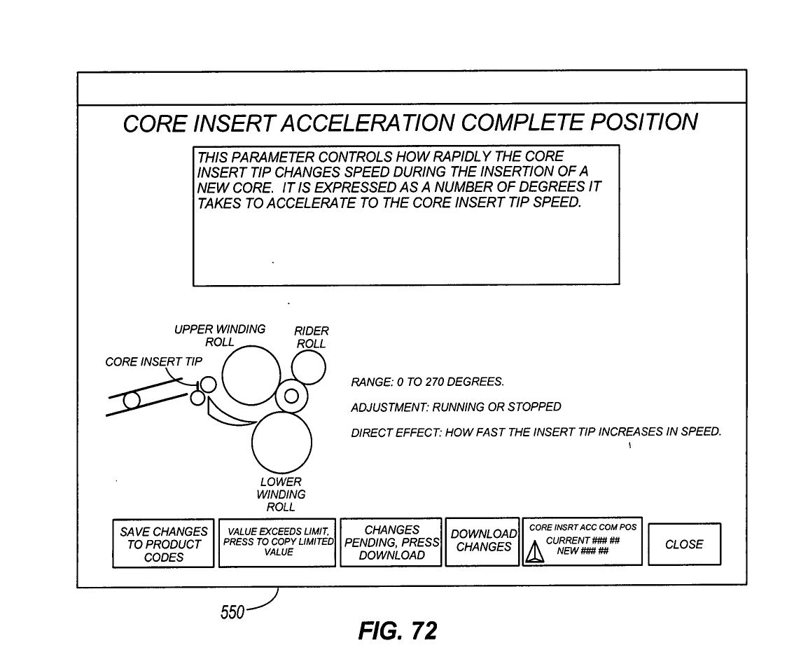

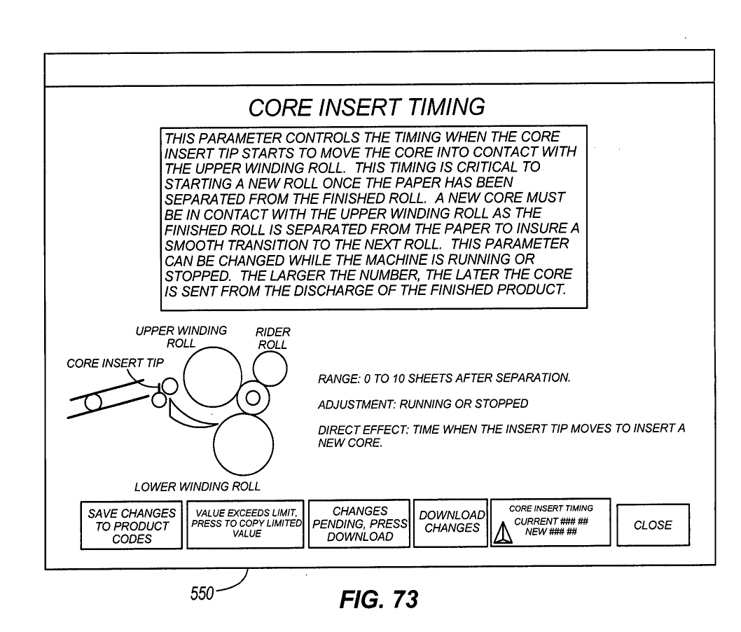

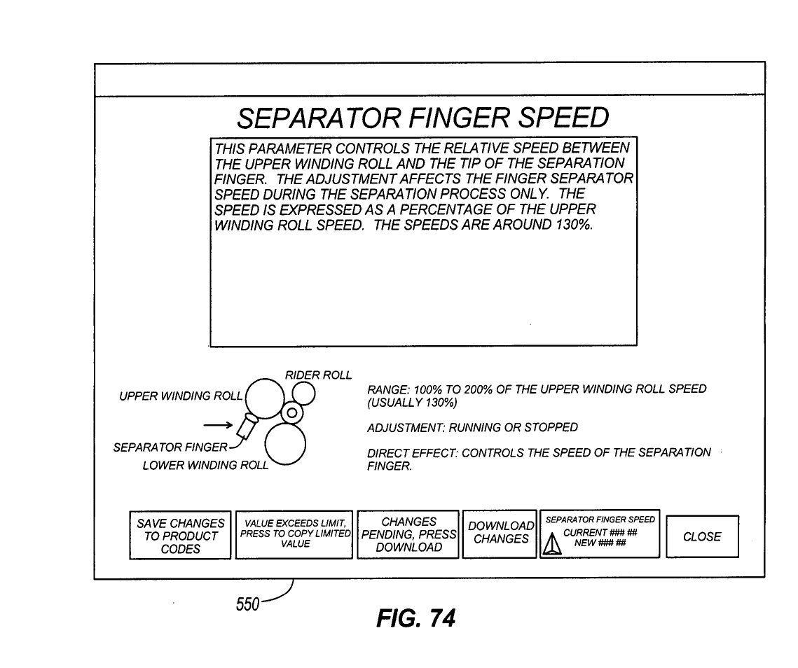

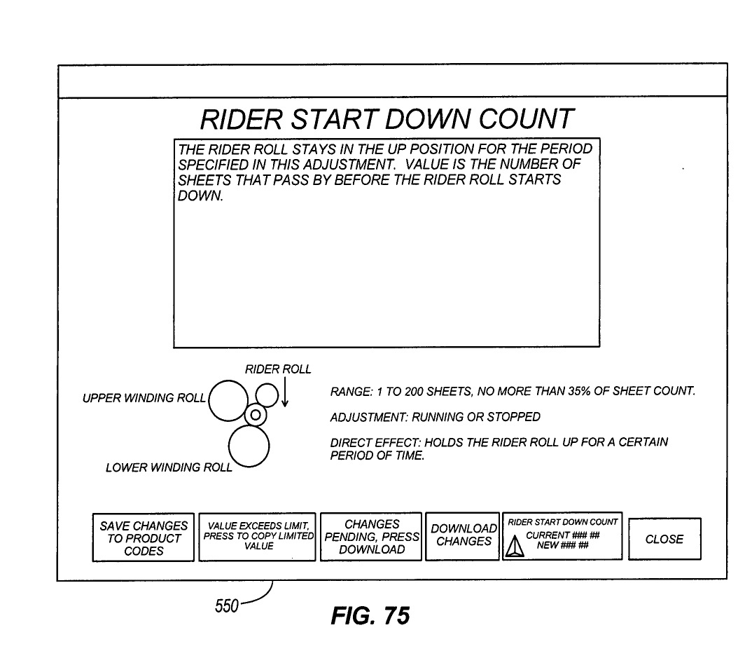

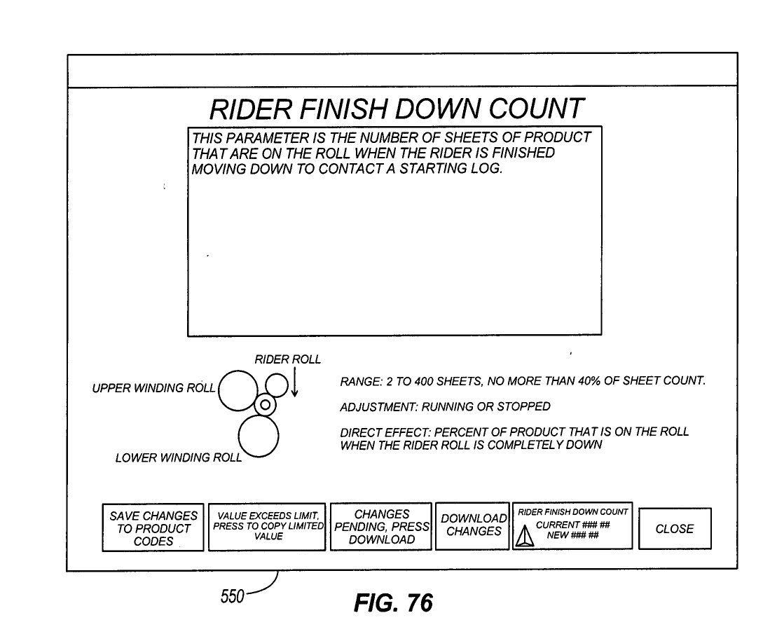

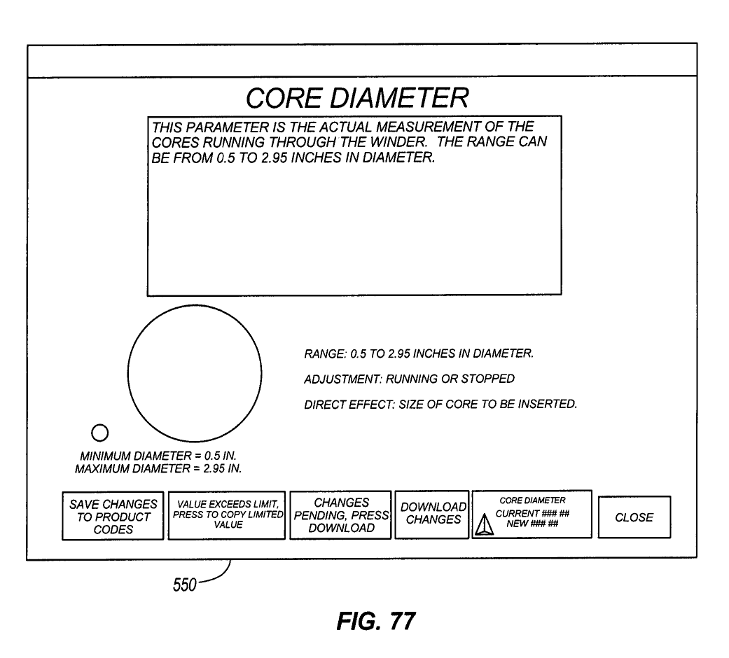

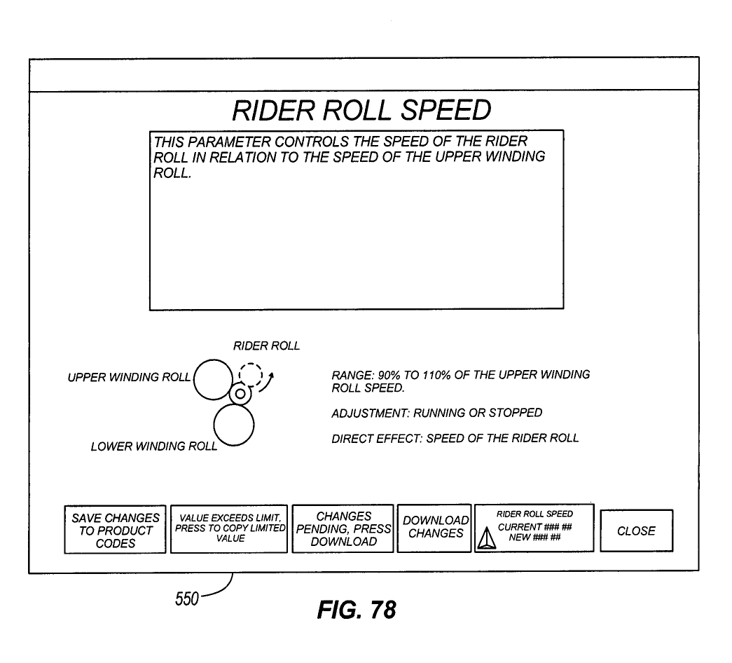

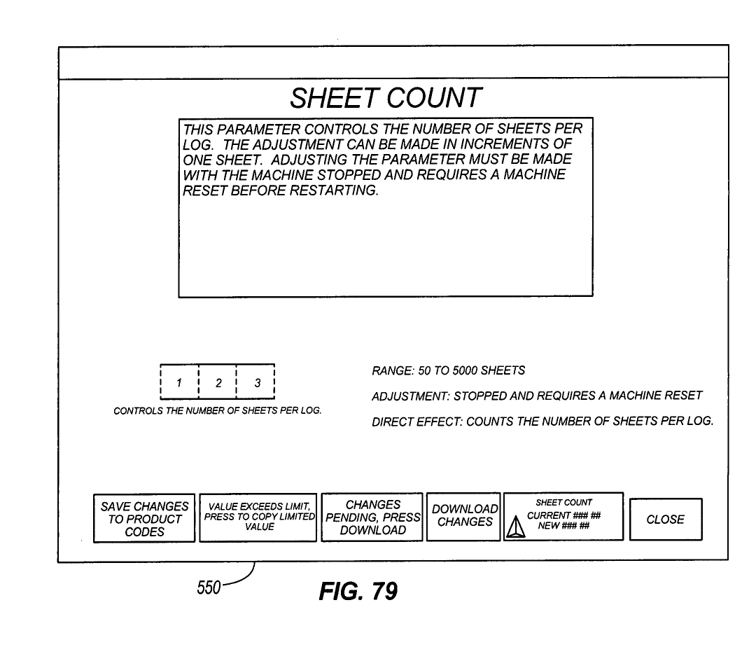

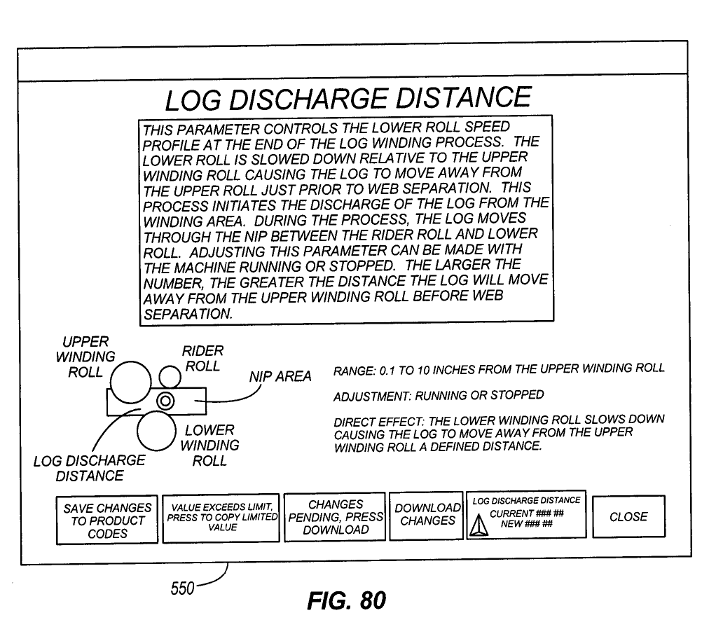

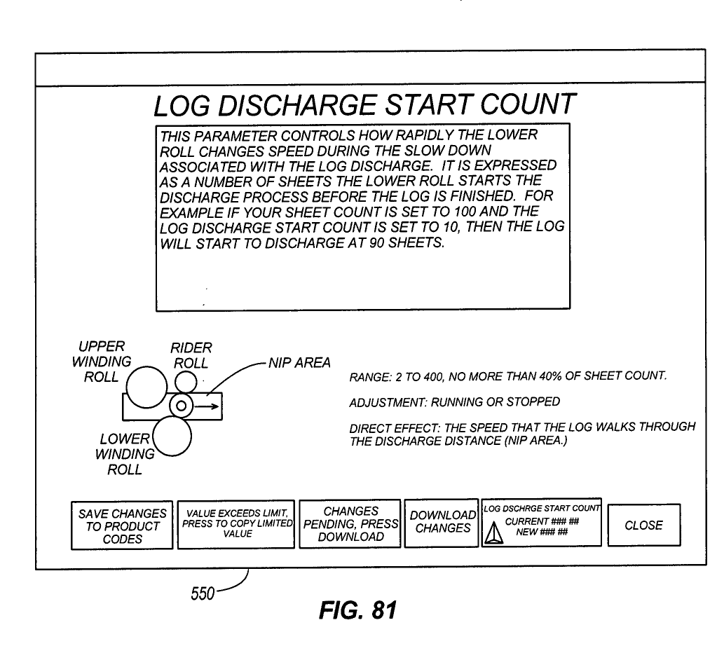

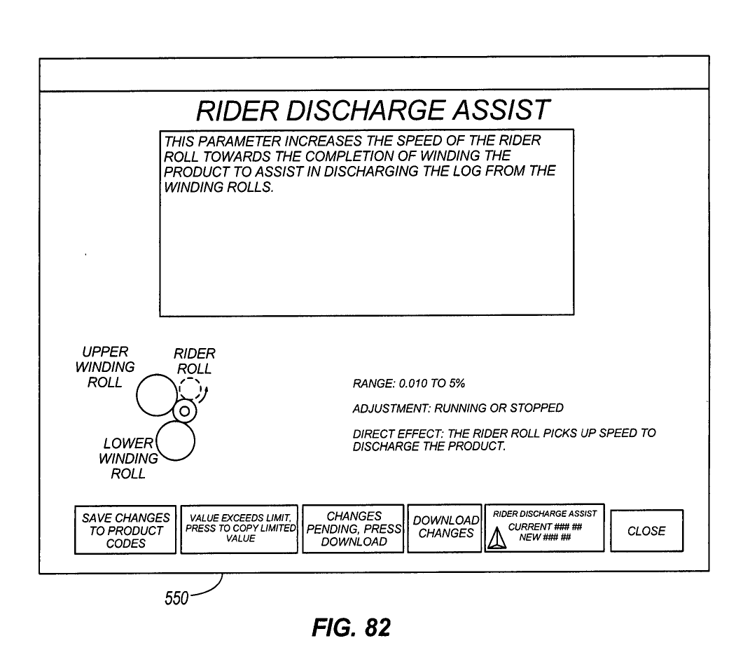

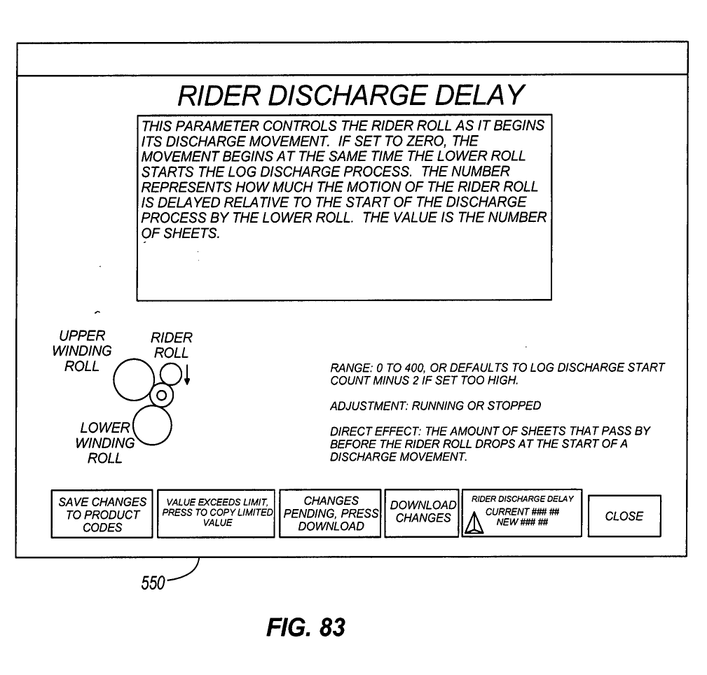

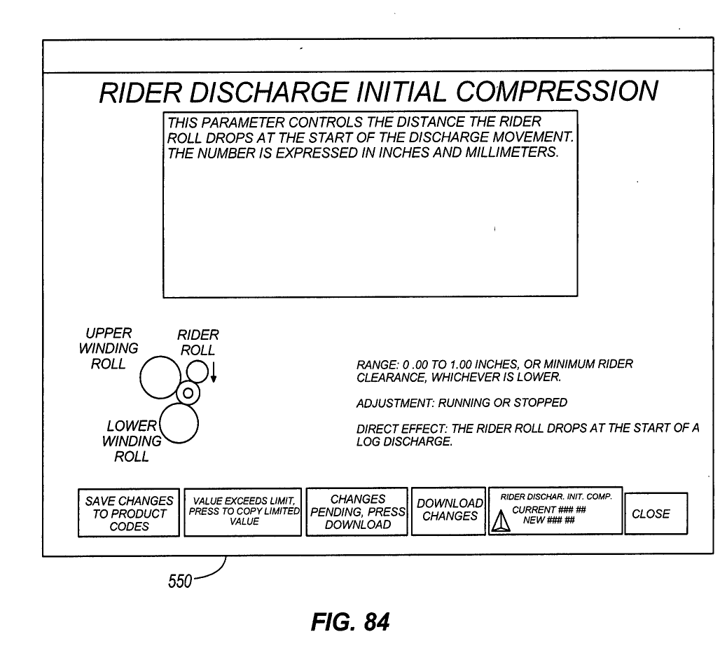

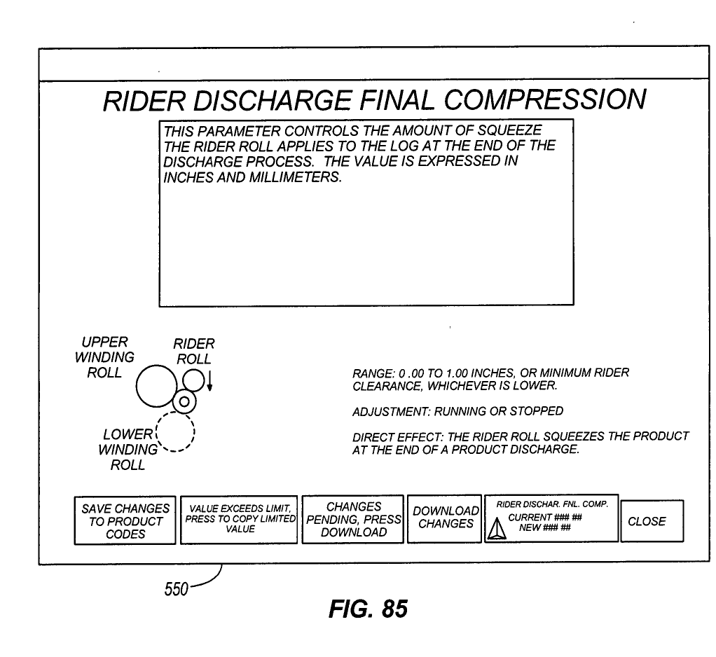

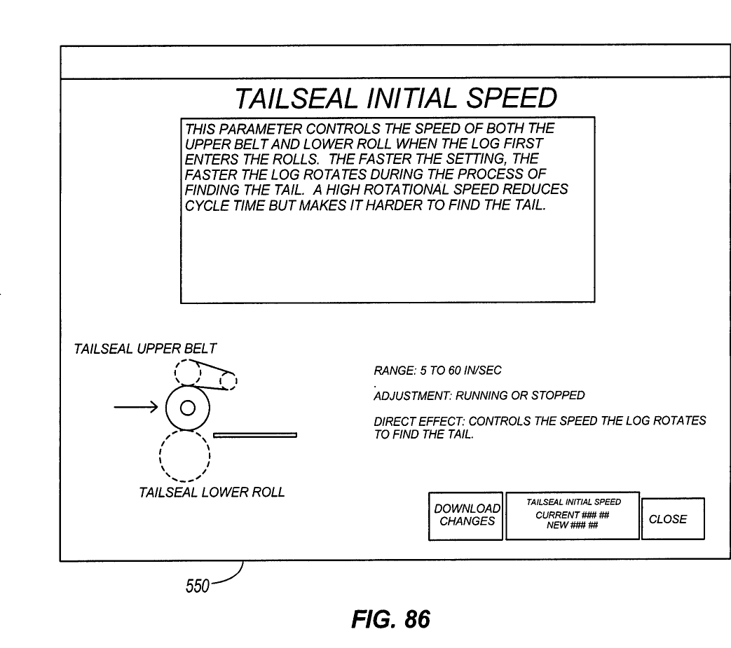

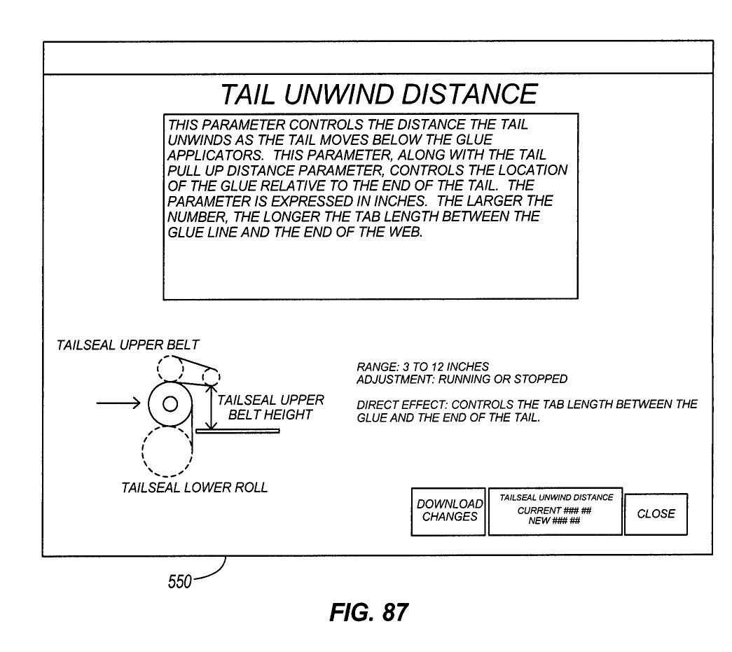

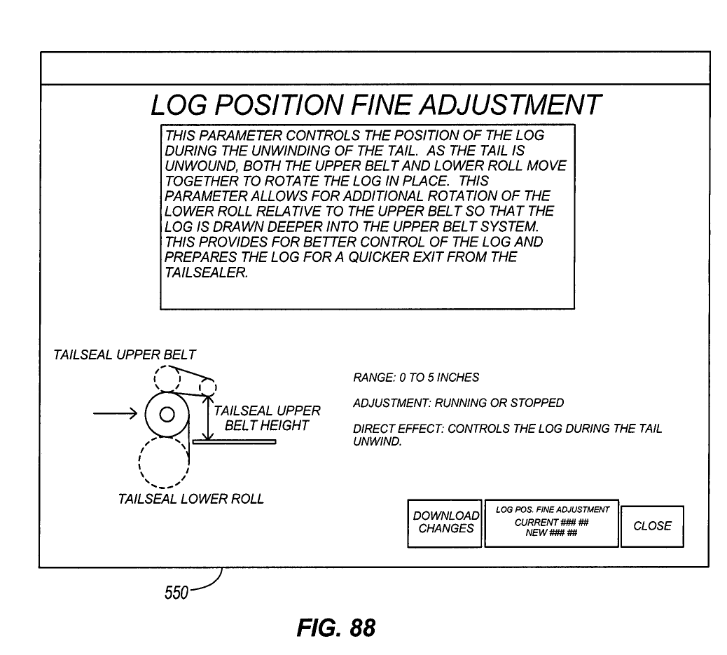

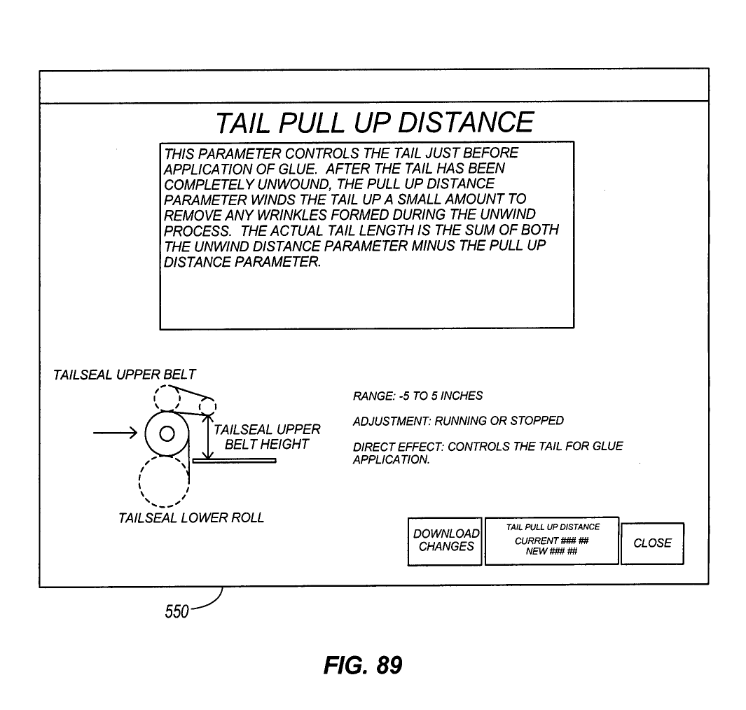

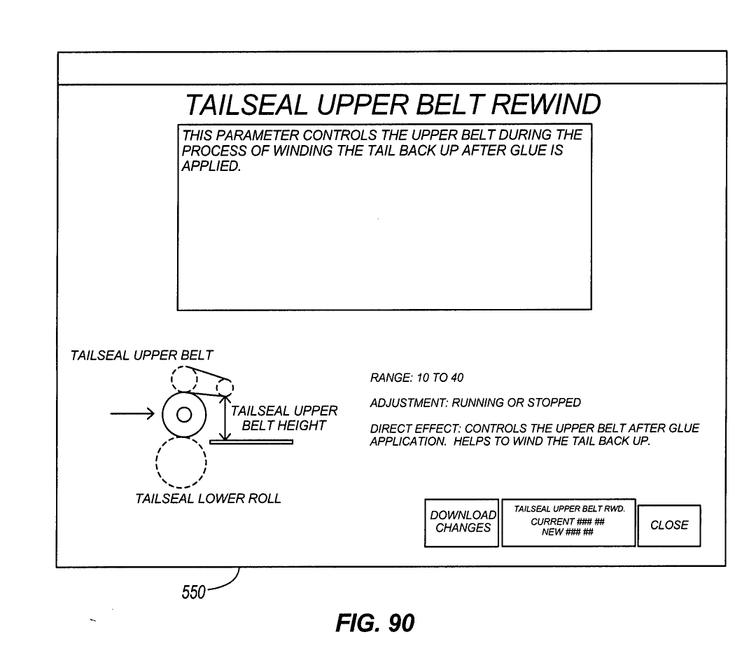

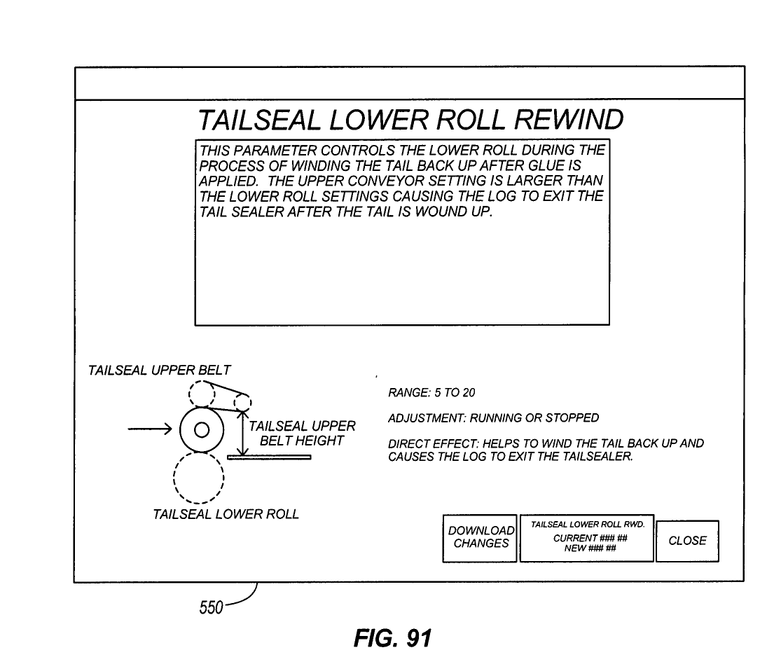

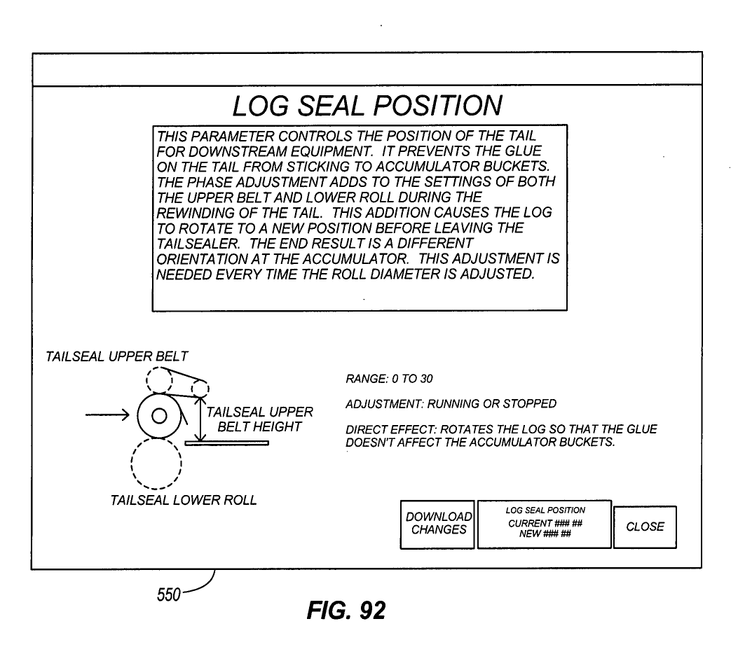

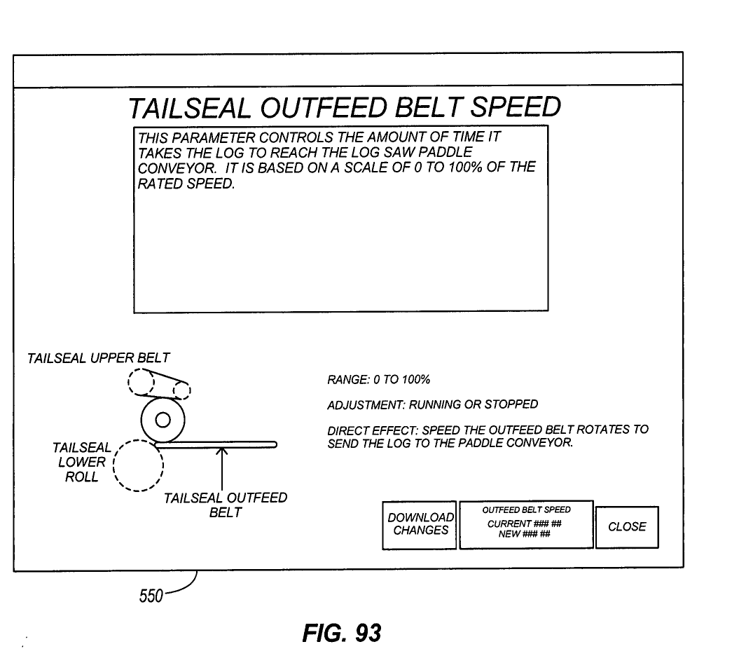

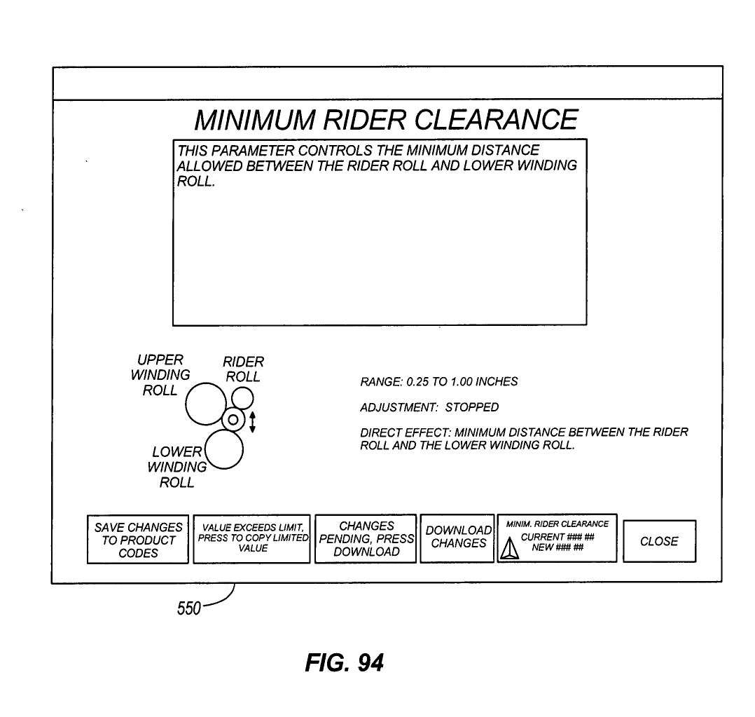

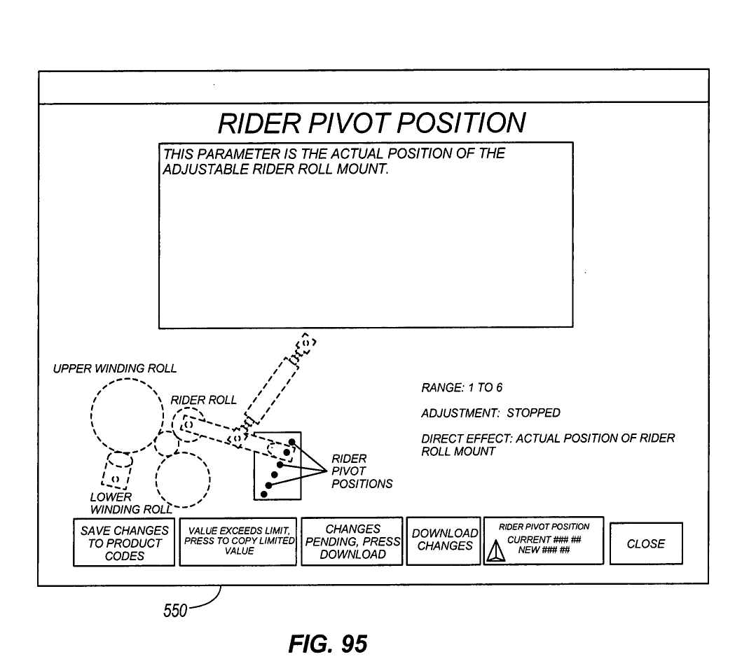

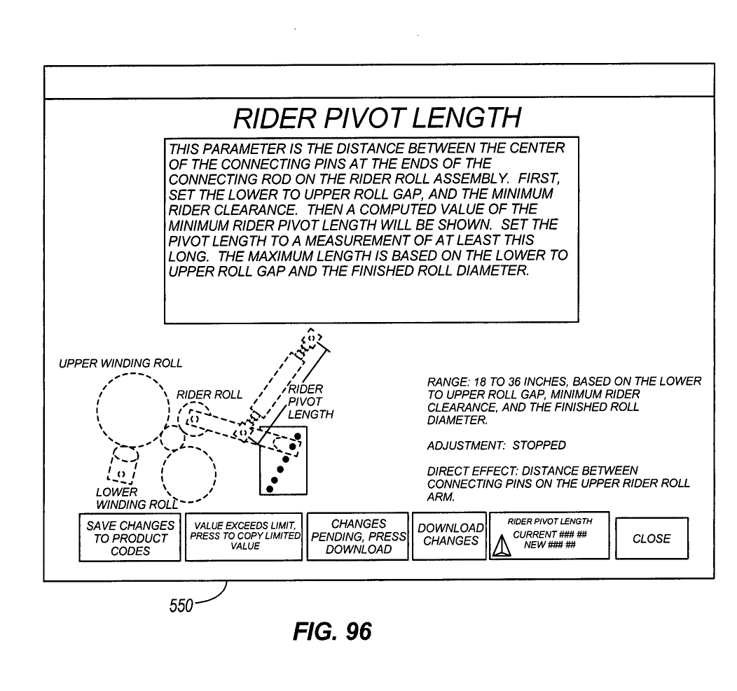

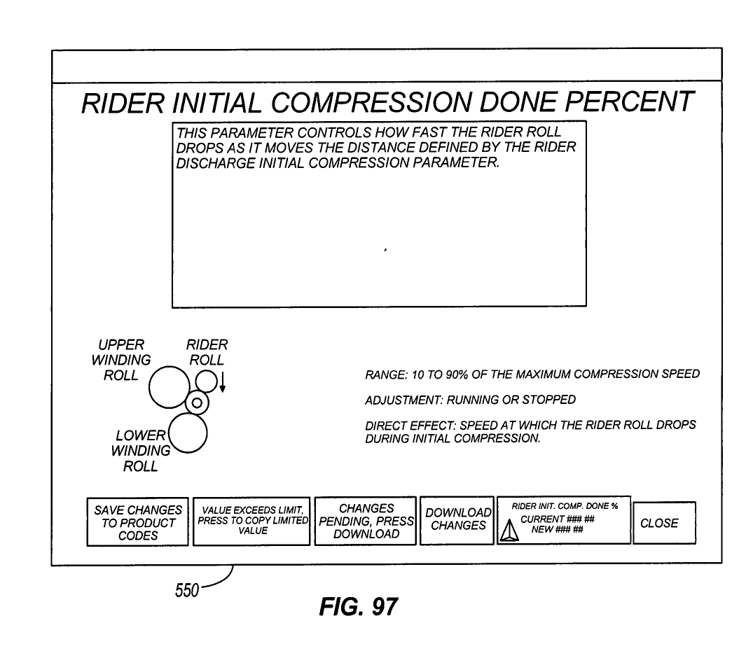

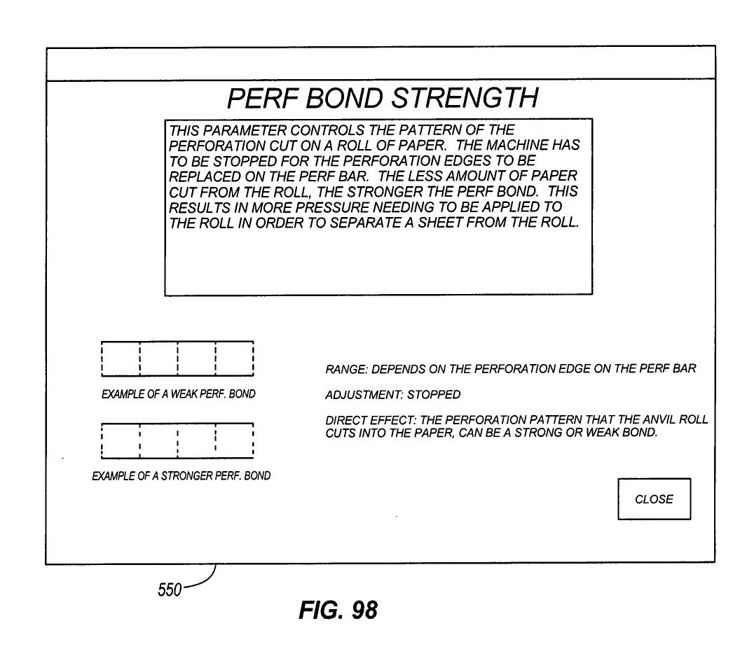

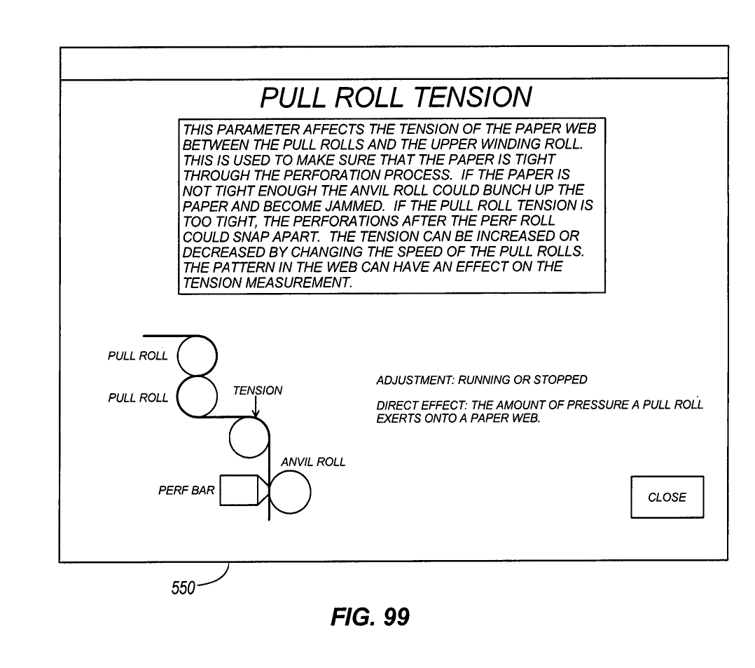

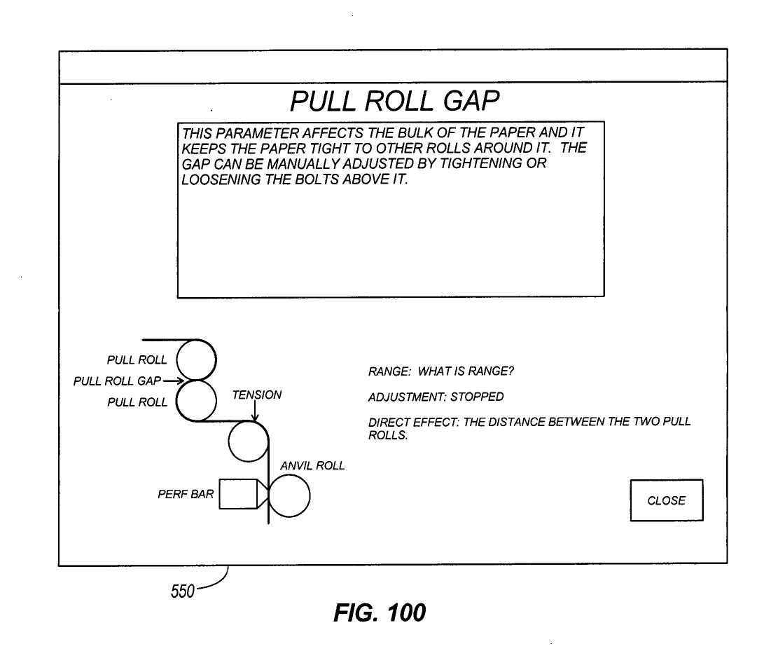

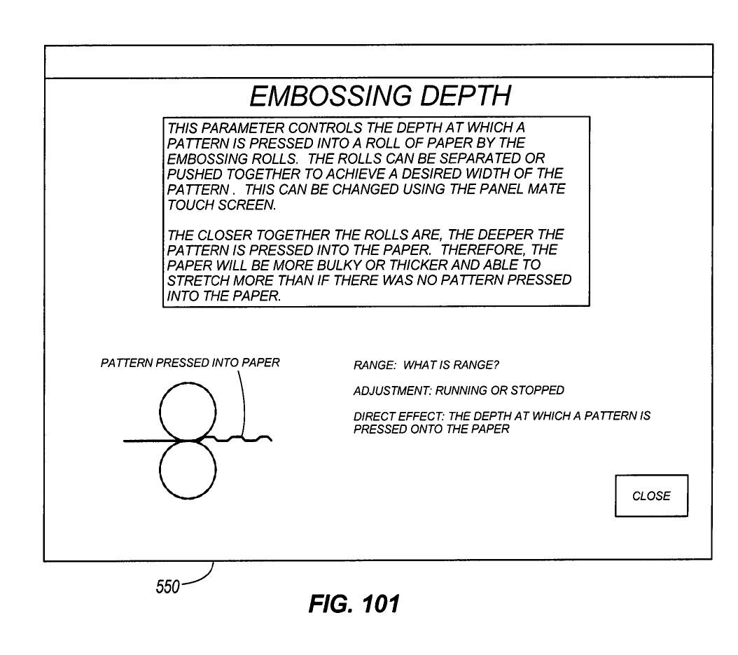

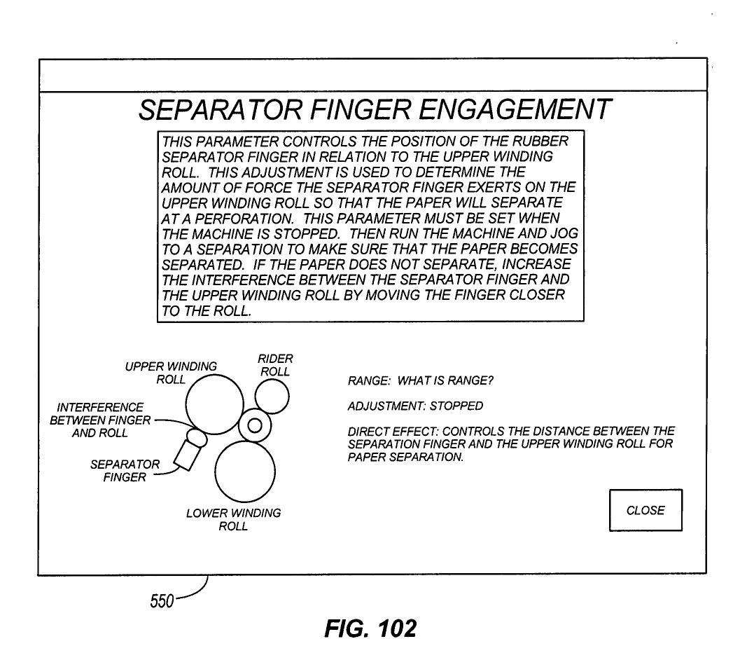

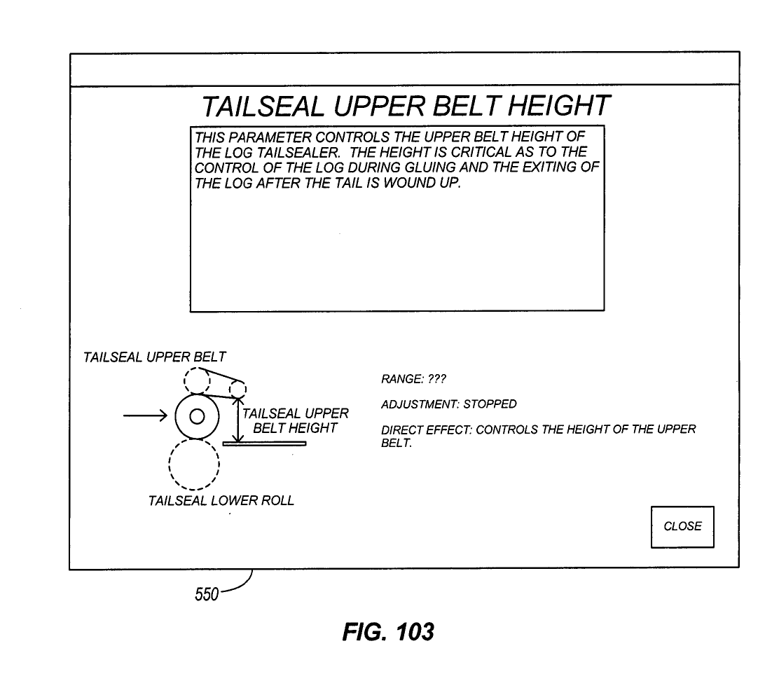

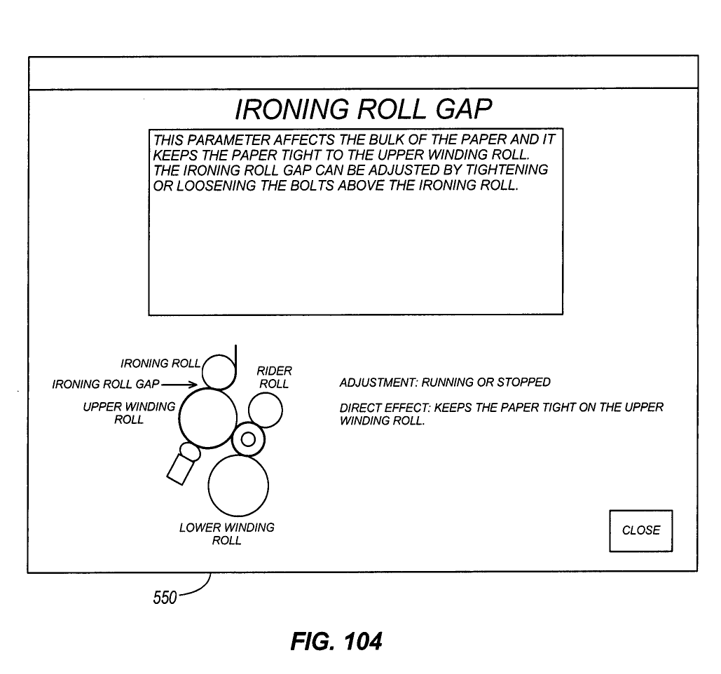

FIGS. 40-55 are troubleshooting help screens 505 of the graphical user interface according to one embodiment of the invention. Each one of the troubleshooting help screens 505 can be accessed by selecting a Problem selector on the product troubleshooting screens 500 and 510. As shown in FIGS. 40-55, each troubleshooting help screen 505 can include a description of a problem. In addition, each troubleshooting help screen 505 can include a figure or illustration that represents a problem or a configuration of the paper winder system 10 that may be causing the problem. In some embodiments, each troubleshooting help screen 505 can include a recommended sequence of actions or checks for an operator to take in order to solve a problem. Each troubleshooting help screen 505 can include links to function definition screens, as shown and described with respect to FIGS. 59-104. A user can access one or more of the function definition screens of FIGS. 59-104 in order to obtain additional information for diagnosing problems. Each troubleshooting help screen 505 can also include a Close selector.

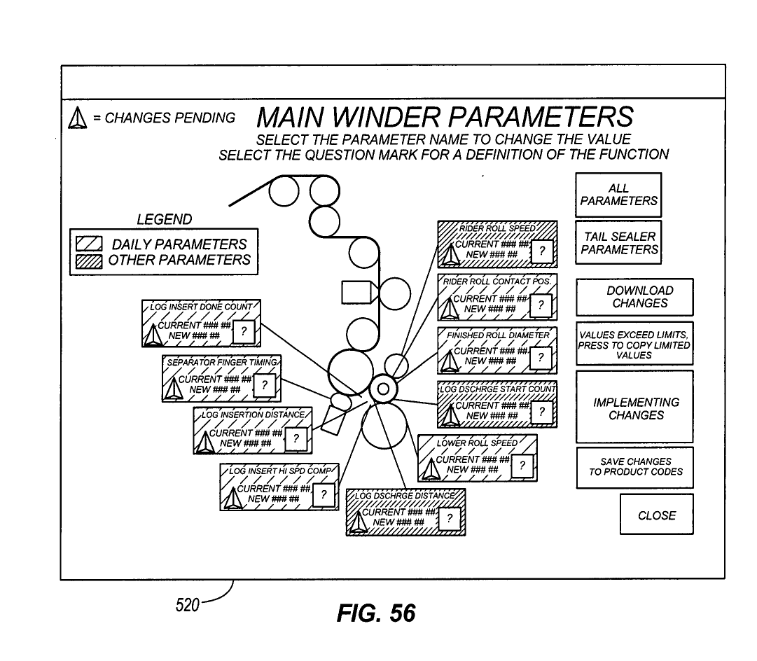

FIG. 56 is a change parameters screen for main winder parameters 520 of the graphical user interface according to one embodiment of the invention. The change parameters screen 520 can appear after selecting the Adjust Parameters selector on the main control screen 200. In some embodiments, the change parameters screen 520 can include parameters for the rewinder 20. The change parameters screen 520 can allow an operator to adjust paper winder system 10 operating parameters. The change parameters screen 520 can also display fault messages and prompts for obtaining paper winder system 10 operating parameters.

The change parameters screen 520 can include one or more parameter fields. An operator can use each parameter field to adjust a parameter according to which the paper winder system 10 operates. Each parameter field can include an Adjust Parameter selector (e.g., represented by a box with a parameter name) and a Function Description selector (e.g., represented by a “?”). An operator can select the Adjust Parameter selector to change a value of a parameter. Selecting an Adjust Parameter selector can access a numeric keypad on which an operator can change the value of that parameter. In some embodiments, an operator can also change a value of a selected parameter on a function definition screen accessed by selecting the Function Definition selector (e.g., each “?” box).

An operator can select a Function Description selector in order to access a function definition screen 550 that describes the selected parameter. A function definition screen 500 can also display terms and instructions for adjusting the selected parameter. FIGS. 59-104 illustrate function definition screens 550 of the graphical user interface according to one embodiment of the invention, all of which are not necessarily accessed via the change parameters screen 520 for the main winder parameters.

In some embodiments, the change parameters screen 520 can also include a figure and/or a map. Each parameter field can indicate a position or location on the figure or map where adjustments to a parameter influence the operation of the paper winder system 10, or particular components thereof.

The parameter fields can be grouped into one or more parameter categories. In some embodiments, parameters fields can be grouped into categories depending on the type of parameters, the frequency of adjustment of the parameters, the type of user typically making the adjustment, etc. The parameter fields can be color-coded in order to indicate parameter categories. The change parameters screen 520 can also include a parameter legend that indicates the different parameter categories. In some embodiments, the parameter fields can be color-coded, as described with respect to the create product codes screen shown in FIG. 18. For example, green can represent parameters that can be modified on a daily basis, light blue can present parameters that can be modified on random schedules, dark blue can represent parameters that can be changed on a one-time basis, purple can represent tail sealer parameters, and red can represent technician parameters.

As shown in FIG. 56, the parameter fields included in a daily parameter category can include a finished roll diameter parameter field, a perforation length parameter field, a lower roll speed parameter field, a separator finger timing parameter field, a log insert done count parameter field, a log insertion distance parameter field, a log insertion distance high speed compensation parameter field, and a rider roll contact position parameter field. The parameter fields included in an adjust-once parameter category can include a core glue position parameter field, a core insert tip speed parameter field, a core insert acceleration complete position parameter field, a core insert timing parameter field, a separator finger speed parameter field, a rider start down count parameter field, a rider finish down count parameter field, and a core diameter parameter field. The parameter fields included in an other parameter category can include a rider roll speed parameter field, a sheet count parameter field, a log discharge start count parameter field, a rider discharge assist parameter field, a rider discharge delay parameter field, a rider discharge initial compression parameter field, and a rider discharge final compression parameter field. The parameter fields included in a tail sealer parameter category can include a tail seal initial speed parameter field, a tail unwind distance parameter field, a log position fine adjustment parameter field, a tail pull up distance parameter field, a tail seal upper belt rewind parameter field, a tail seal lower roll rewind parameter field, a log seal position parameter field, and a tail seal outfeed belt speed parameter field. The parameter fields included in a technician parameter category can include a minimum rider clearance parameter field, a rider pivot position, a rider pivot length, and a rider initial compression done percent parameter field.

Each parameter field can include a current parameter value and a new parameter value. Each parameter field can also include a changes pending indicator (e.g., a triangle on each parameter field box) that specifies whether changes are currently pending to be implemented for a parameter. For example, the changes pending indicator can indicate whether an operator has adjusted the value of parameter, but the adjusted parameter has not yet been implemented or downloaded to components of the paper winder system 10. In some embodiments, selecting a Download Changes selector can download and implement currently-pending values.

The change parameters screen 520 can include a Save Changes to Product Codes selector. Selecting the Save Changes to Product Codes selector can access the create products codes screen 320, as illustrated and described above with respect to FIG. 18.

In some embodiments, parameter changes entered by an operator can be checked to ensure that the modified values are within a range of valid values. If one or more newly-adjusted values are invalid, the change parameters screen 520 can include a Values Exceed Limits selector. If one or more newly-adjusted values lie outside the range of valid values, selecting the Values Exceed Limits selector can cause the invalid values to be automatically changed. In some embodiments, selecting the Values Exceed Limits selector can cause the invalid values to be automatically changed to a valid value closest to the invalid value.

Once parameter adjustments have been made, an operator can select the Download Changes selector to implement parameter value changes. After selecting the Download Changes selector, the parameter adjustment screen can display a message, such as “Implementing Changes.”

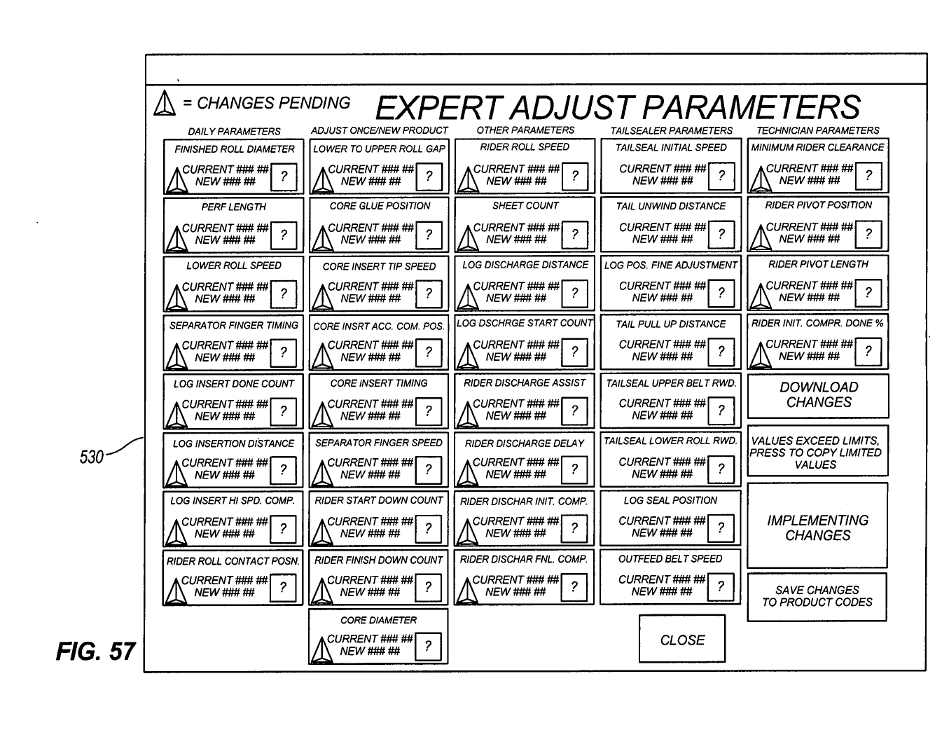

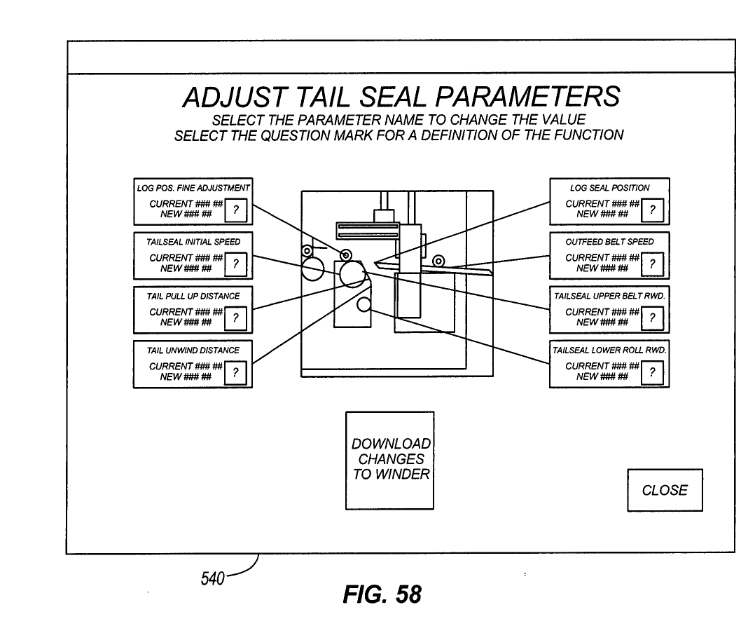

The change parameters screen 520 can include an All Parameters selector and a Tail Sealer Parameters selector. In some embodiments, selecting the All Parameters selector can display substantially all the parameters associated with the paper winder system 10 on another change parameters screen 530 (as described and illustrated below with respect to FIG. 57). Selecting the Tail Sealer Parameters selector can display another change parameters screen 540 (as described and illustrated below with respect to FIG. 58). The change parameters screen 520 can also include a Close selector.

FIG. 57 is a change parameters screen for expert adjust parameters 530 of the graphical user interface according to one embodiment of the invention. The change parameters screen 530 can be displayed after selecting the All Parameters selector on the change parameters screen 520. The change parameters screen 530 can include one or more parameter fields. An operator can use each parameter field to adjust a parameter of the paper winder system 10. Each parameter field can include an Adjust Parameter selector and a Function Definition selector as shown and described with respect to FIG. 56. An operator can select the Adjust Parameter selector in order to adjust the value of a parameter. Selecting an Adjust Parameter selector can access numeric keypad can be displayed on which an operator can change the value of a parameter. In some embodiments, an operator can also change the value of a selected parameter on a function definition screen.

An operator can select the Function Definition selector (e.g., the “?” box) in order to access a function definition screen 550 that describes a parameter. The function definition screens 550 can also display terms and instructions for adjusting a parameter.

In some embodiments, the change parameters screen 530 can indicate parameter categories. For example, the change parameters screen 530 can indicate daily-adjusted parameters, once-adjusted parameters (e.g., when a new product is introduced), tail sealer parameters, technician parameters, etc. In some embodiments, the parameter fields can be color-coded to in order to indicate parameter categories, as described above with respect to the create product codes screen of FIG. 18. For example, green can represent parameters that can be modified on a daily basis, light blue can present parameters that can be modified on random schedules, dark blue can represent parameters that can be changed on a one-time basis, purple can represent tail sealer parameters, and red can represent technician parameters. In some embodiments, the change parameters screen 530 can include a legend that specifies what parameter categories the colors represent. Parameter fields can also be grouped in color-coded columns or other subsections of the change parameters screen 530 and can be labeled as a particular parameter category.

Each parameter field can include a current parameter value and a new parameter value. In addition, each parameter field can include a Changes Pending indicator (e.g., a triangle) that specifies whether changes are currently pending and ready to be implemented.

The change parameters screen 530 can include a Save Changes to Product Codes selector. Selecting the Save Changes to Product Codes selector can access the create products codes screen 320, as illustrated and described above with respect to FIG. 18.

In some embodiments, parameter changes entered by an operator can be checked to ensure that the modified values are within a range of valid values. If one or more new values are invalid, the change parameters screen 530 can include a Values Exceed Limits selector. If one or more modified values lie outside the range of valid values, selecting the Values Exceed Limits selector can cause the invalid values to be automatically changed to a valid value. In some embodiments, selecting the Values Exceed Limits selector can cause the invalid values to be automatically changed to a valid value closest to the invalid value.

Once parameter adjustments have been made, an operator can select a Download Changes selector to implement pending parameter value changes. After selecting the Download Changes selector, the change parameters screen 530 can display a message, such as “Implementing Changes.” The change parameters screen 530 can also include a Close selector.

FIG. 58 is a change parameters screen for tail seal parameters 540 of the graphical user interface according to one embodiment of the invention. In some embodiments, the tail sealer change parameters screen 540 can include operating parameters for the tail sealer 22. The change parameters screen 540 can be displayed after selecting the Tail Sealer Parameters selector on the change parameters screen 520, as described and illustrated above with respect to FIG. 56. The change parameters screen 540 can include one or more parameter fields. An operator can use each parameter field to adjust a parameter of the tail sealer 22 of the paper winder system 10. Each parameter field can include an Adjust Parameter selector and a Function Definition selector. An operator can select the Adjust Parameter selector in order to adjust the value of a parameter. Selecting any of the Adjust Parameter selectors on the change parameters screen 540 can access numeric keypad on which an operator can change the value of that parameter. In some embodiments, an operator can also change a value of a selected parameter on a function definition screen 550.

An operator can select a Function Definition selector (e.g., a “?” box) in order to access a function definition screen 550 that describes a parameter. The function definition screens 550 can also display terms and instructions for adjusting a parameter.

In some embodiments, the change parameters screen 540 can also include a figure and/or a map of the tail sealer 22 and/or other components of the paper winder system 10. Each parameter field can indicate a position or location on the figure or map where adjustments to the parameter can influence the operation of the paper winder system 10, or in particular the tail sealer 22.

Each parameter field can include a current parameter value and a new parameter value. In addition, each parameter field can display a Changes Pending indicator (e.g., a triangle) that specifies whether changes are currently pending and ready to be implemented.

In some embodiments, the change parameters screen 540 can include a Save Changes to Product Codes selector (not shown). Selecting the Save Changes to Product Codes selector can access the create products codes screen 320, as illustrated and described above with respect to FIG. 18.

In some embodiments, parameter changes entered by an operator can be checked to ensure that the modified values are within a range of valid values. If one or more new values are invalid, the change parameters screen 540 can include a Values Exceed Limits selector. If one or more modified values lie outside the range of valid values, selecting the Values Exceed Limits selector can cause the invalid values to be automatically changed to a valid value. In some embodiments, selecting the Values Exceed Limits selector can cause the invalid values to be automatically changed to a valid value closest to the invalid value.

Once parameter adjustments have been made, an operator can select a Download Changes to Winder selector to implement pending parameter value changes. After selecting the Download Changes to Winder selector, the change parameters screen 540 can display a message, such as “Implementing Changes.” The change parameters screen 540 can also include a Close selector.

FIGS. 59-104 are function definition screens 550 of the graphical user interface according to one embodiment of the invention. Each function definition screen shown in FIGS. 59-104 can be accessed by selecting a Function Definition selector (e.g., a “?” box) included in a parameter field on the change parameters screens 520, 530, and 540, as described and illustrated above with respect to FIGS. 56-58.

In some embodiments, as shown in FIGS. 59-104, each function definition screen 550 can include a function description. The function description can describe the functionality of a selected parameter and how adjusting the parameter can affect the operation of the paper winder system 10. The function description can also indicate when changes to a parameter can be made. For example, particular parameters may only be able to be changed while the paper winder system 10, or particular components thereof, is not running. Some parameters may be able to be changed while the paper winder system 10 is running. In addition, the function description can indicate a range of valid parameter values that a parameter can be changed to.

Each function definition screen 550 can include a figure and/or a map that indicates components or a portion of the paper winder system 10 that can be affected by changes to a parameter. Each function definition screen 550 can also include a Parameter Value Range, an Adjustment Requirement, and a Direct Effect Description. The Parameter Value Range can indicate a valid range of values for a parameter. The Adjustment Requirement can provide instructions for making an adjustment, such as when the paper winder system 10, or components thereof, are running or stopped. The Direct Effect Requirement can indicate an effect that changing a parameter has on operation the paper winder system 10, such as changing a physical position of one or more rolls; changing a sheet length of finished product; changing the speed, position, and/or moveable distance of one or more rolls; changing the speed or path of a inserted core; changing the sequence or timing of interacting components of the paper; etc.

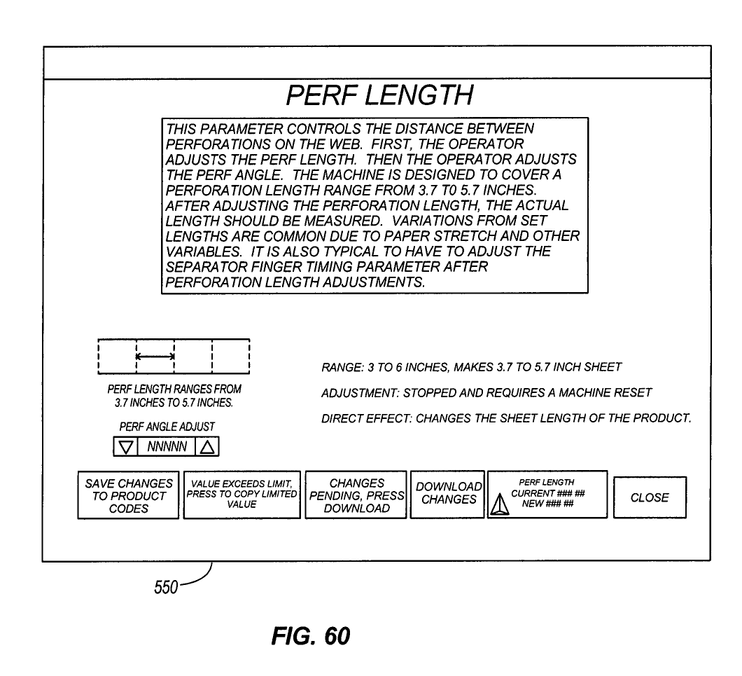

Each function definition screen 550 can include the parameter field that was selected in order to access that particular function definition screen 550. The parameter field can include the current parameter value and the new parameter value. In addition, the parameter field can include an Adjust Parameter selector that an operator can select in order to change the value of the parameter. As shown in FIG. 60, in some embodiments, a function definition screen 550 can include a parameter adjuster (e.g., Perforation Angle Adjust) that can include an Increase Value selector and a Decrease Value selector. An operator can use the Increase Value selector and the Decrease Value selector in order to adjust the value of a parameter or another related parameter.

In some embodiments, each function definition screen 550 can include a Save Changes to Product Codes selector. Selecting the Save Changes to Product Codes selector can access the create products codes screen 320, as illustrated and described above with respect to FIG. 18. Each function definition can also include a Value Exceeds Limit selector, a Changes Pending selector, and/or a Download Changes selector, as described above with respect to FIGS. 56-58.

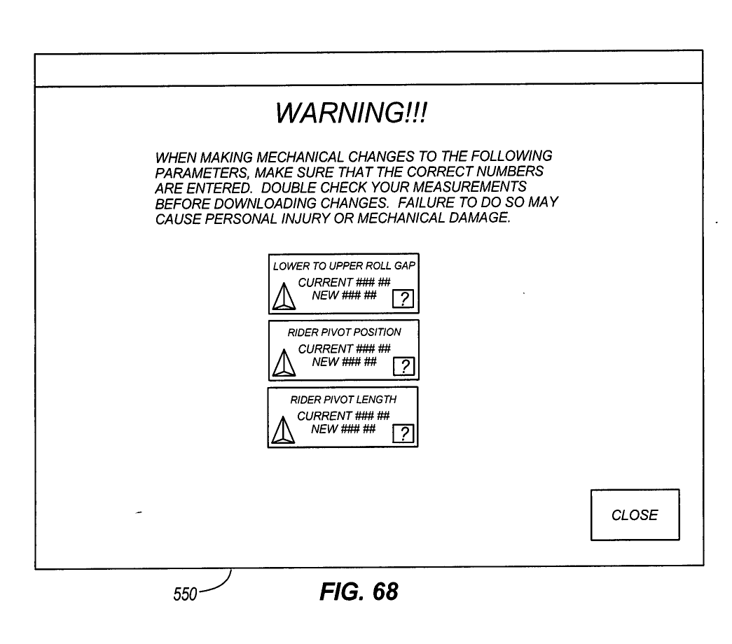

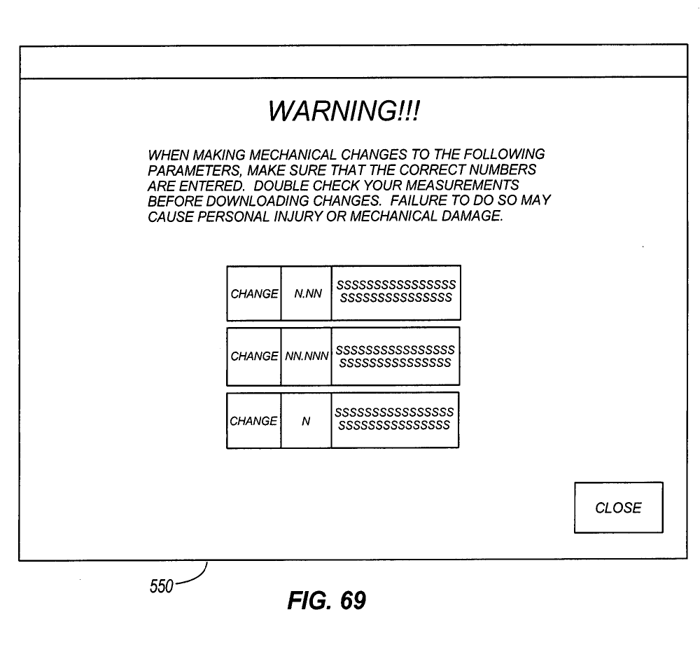

As shown in FIGS. 68 and 69, some function definition screens 550 can include a warning message. For example, upon selecting the Function Definition selector included in a particular parameter field, a warning screen can be displayed that provides an operator with warnings and/or instructions on dangers that may be associated with changing the value of a parameter. In some embodiments, a warning message can be displayed upon selecting an Adjust Parameter selector, the Download Changes selector, the Save Changes selector, and/or entering a new parameter value using a numeric keypad or a parameter adjuster. A warning message can also include one or more parameters fields, which represent parameters that, upon changing, can cause unwanted and/or dangerous effects. In addition, a warning screen can include Change selectors that can allow an operator to change the value of a parameter. In some embodiments, selecting the Change selector can access a numeric keypad on which an operator can enter a new parameter value. A warning screen can also include a Close selector.

FIG. 105 is an unwind stand front main screen 560 of the graphical user interface according to one embodiment of the invention. The unwind stand front main screen 560 can appear on a touch screen of the paper winder system 10, such as an Allen-Bradley Panel View 600 touch screen system sold by Rockwell Automation. In some embodiments, the unwind stand front main control screen 200 can be displayed to obtain paper winder system 10 operation parameters for the unwind stand components 14.

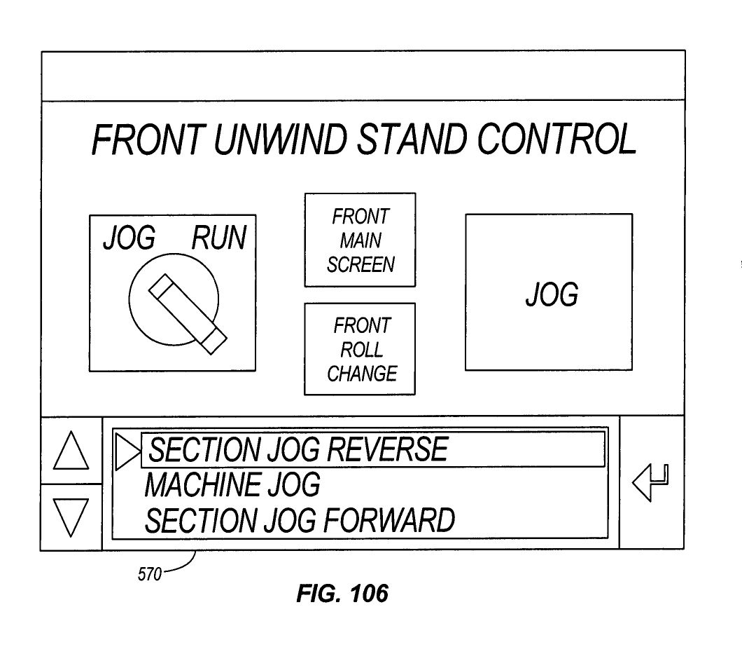

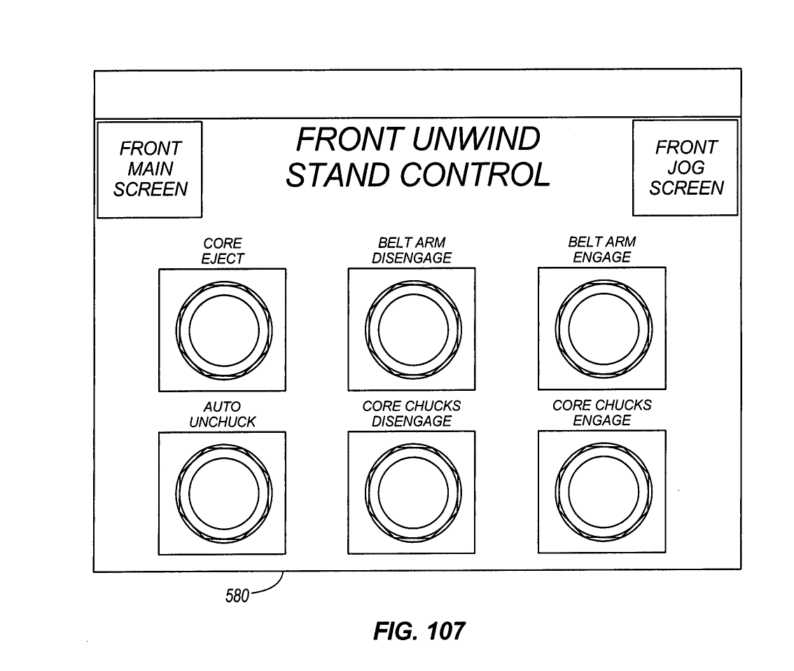

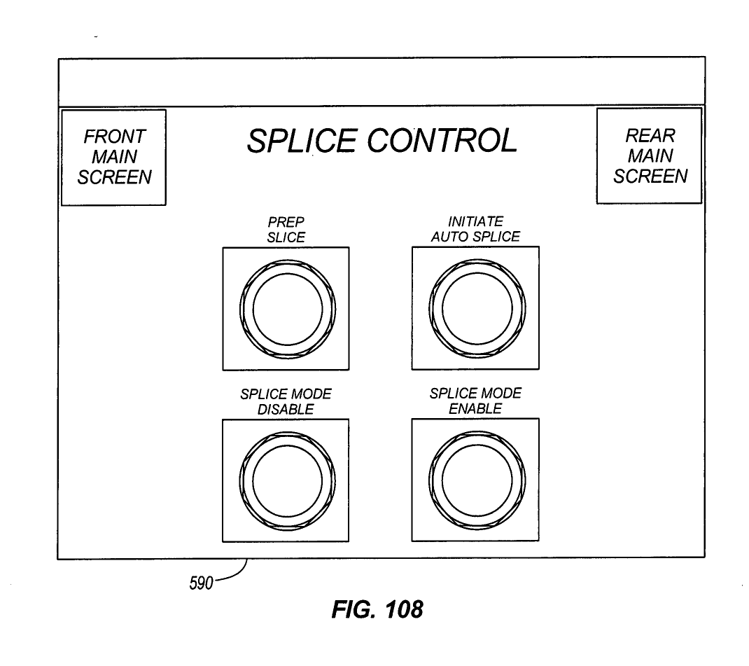

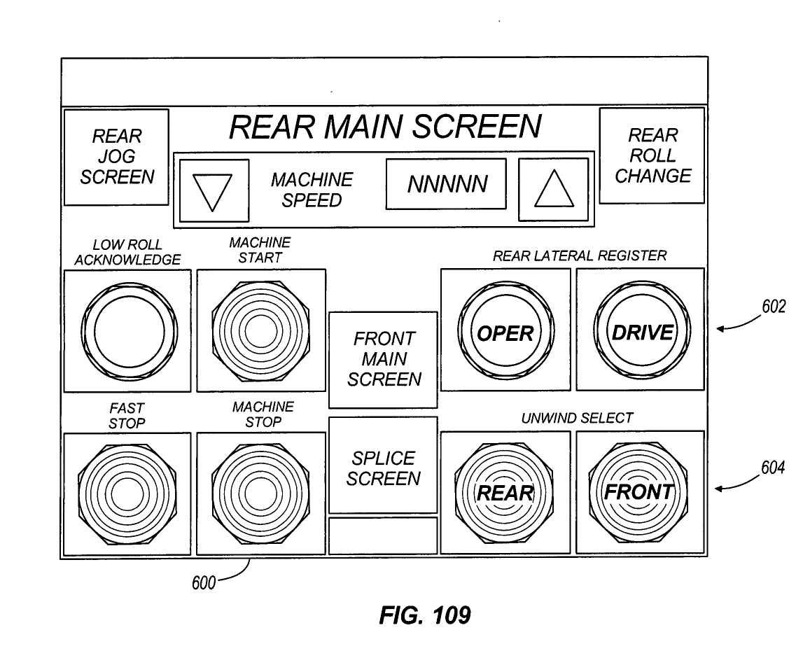

The unwind stand front main screen 560 can display fault messages and prompts for obtaining paper winder system 10 operating parameters. The unwind stand front main screen 560 can also include a Front Jog Screen selector. Selecting the Front Jog Screen selector can access a front jog screen 570 (as described and illustrated below with respect to FIG. 106). The unwind stand front main screen 560 can include a Front Roll Change selector. Selecting the Front Roll Change selector can access a front roll change screen 580 (as described and illustrated below with respect to FIG. 107). The unwind stand front main screen 560 can include a Splice Screen selector. An operator can select the Splice Screen selector in order to access a splice control screen 590 (as described and illustrated below with respect to FIG. 108). The unwind stand front main screen 560 can also include a Rear Main Screen selector. Selecting the Rear Main Screen selector can access an unwind stand rear main screen 600 (as described and illustrated below with respect to FIG. 109).

The unwind stand front main screen 560 can include a Machine Speed selector. The Machine Speed selector can include an Increase Speed selector and a Decrease Speed selector. An operator can adjust the speed of the unwind stand. In some embodiments, the Machine Speed selector can include a Numeric Speed-selector that an operator can select in order to access a numeric keypad on which the operator can enter a machine speed value. The Machine Speed selector can also include a current machine speed value.

In some embodiments, a warning signal, such as a horn or light, is generated when a low parent roll is detected on the front unwind stand 50 (as shown in FIG. 2). The unwind stand front main screen 560 can include a Low Roll Acknowledge selector than an operator can select in order to acknowledge the detection of a low roll. Selecting the Low Roll Acknowledge selector cam also turn off the warning signal. In some embodiments, if the Low Roll Acknowledge selector is not selected within approximately 120 seconds after the warning signal is initiated, the paper winder system 10, or in particular, the front unwind stand 50 and/or the unwind stand components 14 (as shown in FIG. 2) can shut down. The Low Roll Acknowledge selector can also be used to acknowledge when the included core hopper 124 (as shown in FIG. 5) is low.

In order to start a main drive of the front unwind stand 50, an operator can select a Machine Start selector included on the unwind stand front main screen 560. In some embodiments, when selected, a warning signal, such as a horn or light, is generator before the rewinder 20 begins to turn over. In some embodiments, the Machine Start selector is held in a selected position until the paper winder system 10 reaches a running speed of approximately 100 feet-per-minute. At this point, a green Machine Start indicator can be displayed on the unwind stand front main screen 560. In some embodiments, if the Machine Start selector is not held long enough, the paper winder system 10 can coast to a stop.

The unwind stand front main screen 560 can include a front lateral register section 562. The front lateral register section 562 can include an Operator (“OPER”) selector and a Drive selector. Using the Operator selector and the Drive selector, an operator can adjust a lateral register on the front unwind stand 50 (as shown in FIG. 2) in order line up the center of a web with the center of the embosser 16 (as shown in FIG. 3). In some embodiments, selecting the Drive selector moves the parent roll 70 toward a drive side of the front unwind stand 50, and selecting the Operator selector moves the parent roll 70 toward an operator side of the front unwind stand 50.

In order to stop the paper winder system 10 as quickly as possible without damaging the paper winder system 10, an operator can select a Fast Stop selector included on the unwind stand front main screen 560. In some embodiments, selecting the Fast Stop selector does shut down electrical or pneumatic systems. The stopping time for the paper winder system 10 can depend on the current running speed of the paper winder system 10. In some embodiments, the stopping time of the paper winder system 10 is approximately 10 seconds or less.

In order to bring the paper winder system 10 to a normal driven stop, an operator can select a Machine Stop selector included on the unwind stand front main screen 560. In some embodiments, selecting the Machine Stop selector does not shut down the electrical or pneumatic systems, the Fast Stop selector may do.

The unwind stand front main screen 560 can also include an unwind select section 564. The unwind select section 564 can include a Front selector and a Rear selector. An operator can select either the Front selector or the Rear selector in order to select an unwind stand to use.

FIG. 106 is an unwind stand front jog screen 570 of the graphical user interface according to one embodiment of the invention. The unwind stand front jog screen 570 can appear after selecting the Front Jog Screen selector on the unwind stand front main screen 560. The unwind stand front jog screen 570 can display fault messages and prompts for obtaining paper winder system 10 operating parameters. The unwind stand front jog screen 570 can also include a Front Main Screen selector that an operator can select in order to access the unwind stand front main screen 560. The unwind stand front jog screen 570 can also include the Front Roll Change selector that, when selected, accesses the front roll change screen 580 of FIG. 107.

The unwind stand front jog screen 570 can include a Jog/Run selector. Using the Jog/Run selector an operator can switch between operating the front unwind stand 50 (as shown in FIG. 2) in a jog mode or a run mode. In a jog mode, an operator can jog the front unwind stand 50 in order to thread the paper winder system 10 and/or clear a jam. Once in jog mode, a Jog selector included on the unwind stand front jog screen 570 can be used to jog the front unwind stand 50. In some embodiments, a warning signal, such as a horn or light, is generated each time the Jog selector is selected.

When in jog mode, an operator can also use a Jog Direction selector (e.g., section jog reverse or section jog forward) in order to choose between jogging the front unwind stand 50 in reverse or forward. In order to jog the front unwind stand 50 in reverse, the Jog Direction selector can be set to a reverse jog mode. In order to jog the front unwind stand 50 forward, the Jog Direction selector can be set to a forward jog mode. In some embodiments, an operator can also use the Job Direction selector to jog multiple unwind stands, such as the front unwind stand 50 and the rear unwind stand 52. In order to jog multiple unwind stands, each Job Direction selector on each unwind stand can be set to a multiple unwind stand jog mode.

Using the Jog/Run selector, an operator can also place the front unwind stand 50 in a run mode that can make the paper winder system 10 ready to run. In some embodiments, multiple unwind stands can be ready to run when each Jog/Run selector of each unwind stand is set to a run mode.

FIG. 107 is the unwind stand front roll change screen 580 of the graphical user interface according to one embodiment of the invention. The unwind stand front roll change screen 580 can appear after selecting the Front Roll Change selector on the unwind stand front main screen 560 and/or the unwind stand front jog screen 570. The unwind stand front roll change screen 580 can display fault messages and prompts for obtaining paper winder system 10 operating parameters. The unwind stand front roll change screen 580 can also include a Front Main Screen selector that an operator can select in order to access the unwind stand front main screen 560. The unwind stand front roll change screen 580 can also include a Front Jog Screen selector that an operator can selector in order to access the unwind stand front jog screen 570.

The unwind stand front roll change screen 580 can include a Belt Arm Disengage selector. In some embodiments, an operator can select the Belt Arm Disengaged selector in order to disengage the drive belts from the parent roll 70. The belt loading cylinders can then retract and unload the drive belts from the parent roll 70. Similarly, the unwind stand front roll change can include a Belt Arm Engaged selector that an operator can select in order to engage the drive belts with the parent roll 70. The belt loading cylinders can then extend and load the drive belts to the parent roll 70.

In some embodiments, the unwind stand front roll change screen 580 can include a Core Chucks Disengage selector. An operator can select the Core Chucks Disengage selector in order to disengage the core chucks from the parent roll 70. Likewise, an operator can select a Core Chucks Engage selector included on the unwind stand front roll change screen 580 in order to disengage the core chucks from the parent roll. After a spent parent roll is unchucked, an operator can select a Core Eject selector included on the unwind stand front roll change screen 580 in order to eject the parent roll core. An operator can also use an Auto Unchuck selector in order to disengage the drive belts, retract the core chunks for the parent roll 70, and eject the parent roll core.

FIG. 108 is an unwind stand splice control screen 590 of the graphical user interface according to one embodiment of the invention. The unwind stand splice control screen 590 can appear after selecting the Splice Screen selector on the unwind stand front main screen 560. The unwind stand splice control screen 590 can display fault messages and prompts for obtaining paper winder system 10 operating parameters. The unwind stand splice control screen 590 can include a Front Main Screen selector and a Rear Main Screen selector. An operator can select the Front Main Screen selector in order to select the unwind stand front main screen 560. Similarly, an operator can select the Rear Main Screen selector in order to access the unwind stand rear main screen 600 as shown in FIG. 109.

The unwind stand splice control screen 590 can include a Prep Slice selector. Selecting the Prep Slice selector can release a solenoid on unwind stand guard doors. In some embodiments, once the unwind stand guard doors are unlocked, they can swing open. The unwind stand splice control screen 590 can include an Initiate Auto Splice selector. An operator can select the Initiate Auto Splice selector in order to start an automatic splicing procedure. In some embodiments, once the automatic splicing procedure is initiated, the paper winder system slows down to a speed of approximately 500 feet-per-minute and the splicer activates.

To enable an unwind stand for splicing, an operator can select a Splice Mode Enable selector, included on the unwind stand splice control screen 590. In some embodiments, once the Splice Mode Enable selector is selected, pneumatic doors will close and the paper winder system 10 will prepare the splicing assembly 62 (as shown in FIG. 2) for operation.

FIG. 109 is an unwind stand rear main screen 600 of the graphical user interface according to one embodiment of the invention. The unwind stand rear main screen 600 can appear on a touch screen of the paper winder system 10, such as an Allen-Bradley Panel View 600 touch screen system sold by Rockwell Automation. In some embodiments, the unwind stand rear main control screen 600 can be displayed to obtain paper winder system 10 operation parameters for the unwind stand components 14, and, in particular, the rear unwind stand 52 (as shown in FIG. 2). The unwind stand rear main screen 600 can also display fault messages and prompts for obtaining paper winder system 10 operating parameters.

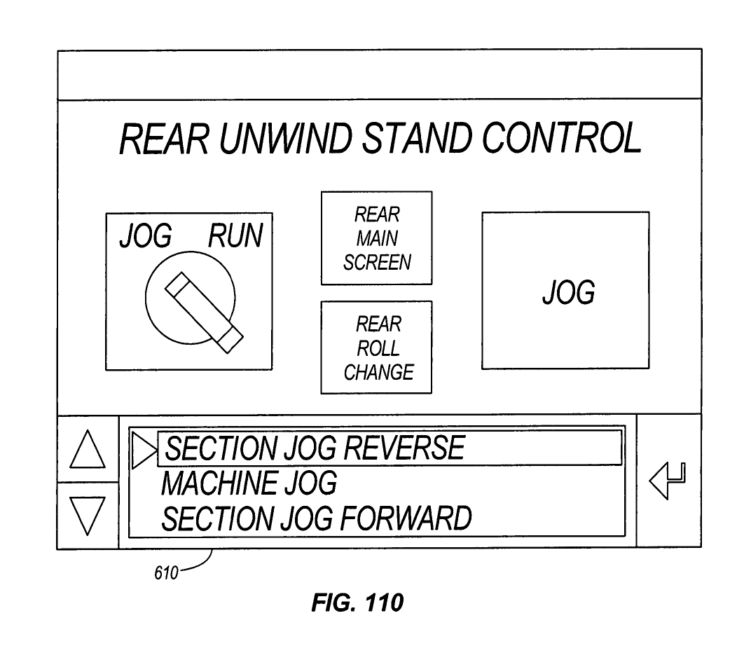

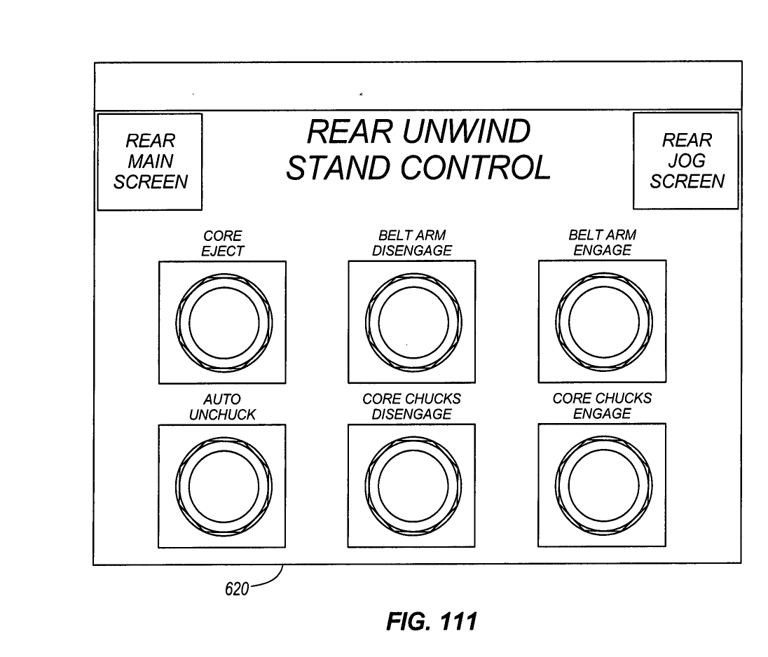

The unwind stand rear main screen 600 can include a Rear Jog Screen selector. Selecting the Rear Jog Screen selector can access a rear jog screen 610 (as described and illustrated below with respect to FIG. 110). The unwind stand rear main screen 600 can include a Rear Roll Change selector. Selecting the Rear Roll Change selector can access a rear roll change screen 620 (as described and illustrated below with respect to FIG. 111). The unwind stand rear main screen 600 can also include a Front Main Screen selector. Selecting the Front Main Screen selector can access the unwind stand front main screen 560 of FIG. 105.

The unwind stand rear main screen 600 can include a Machine Speed selector. The Machine-Speed selector can include an Increase Speed selector and a Decrease Speed selector. An operator can adjust the speed of the unwind stand 52 (as shown in FIG. 2). In some embodiments, the Machine Speed selector can include a Numeric Speed Rear selector that an operator can select in order to access a numeric keypad on which the operator can enter a machine speed value. The Machine Speed selector can also include a current machine speed value.

In some embodiments, a warning signal, such as a horn or light, is generated when a low parent roll is detected on the rear unwind stand 52. The unwind stand rear main screen 600 can include a Low Roll Acknowledge selector than an operator can select in order to acknowledge the detection of a low parent roll 70. An operator can also select the Low Roll Acknowledge selector in order to turn off the warning signal. In some embodiments, if the Low Roll Acknowledge selector is not selected within approximately 120 seconds after the warning signal is initiated, the paper winder system 10, or in particular, the rear unwind stand 52 or the unwind stand components 14 can shut down. The Low Roll Acknowledge selector can also be used to acknowledge when the inclined core hopper 124 (as shown in FIG. 5) is low.

In order to start a main drive of the rear unwind stand 52, an operator can select a Machine Start selector included on the unwind stand rear main screen 600. In some embodiments, when selected, a warning signal, such as a horn or light, is generator before the rewinder 20 begins to turn over. In some embodiments, the Machine Start selector is held in a selected position until the paper winder system 10 reaches a running speed of approximately 100 feet-per-minute. At this point, a green machine start indicator can be displayed the unwind stand rear main screen 600. In some embodiments, if the Machine Start selector is not held long enough, the paper winder system 10 can coast to a stop.

The unwind stand rear main screen 600 can include a rear lateral register section 602. The rear lateral register section 602 can include an Operator (“OPER”) selector and a Drive selector. Using the Operator selector and the Drive selector, an operator can adjust a lateral register on the rear unwind stand 52 in order line up the center of the paper web with the center of the embosser 16 (as shown in FIG. 3). In some embodiments, selecting the Drive selector moves the parent roll 70 toward a drive side of the rear unwind stand 52, and selecting the Operator selector moves the parent roll 70 toward an operator side of the rear unwind stand 52.

In order to stop the paper winder system 10 as quickly as possible without damaging the paper winder system, an operator can select a Fast Stop selector included on the unwind stand rear main screen 600. In some embodiments, selecting the Fast Stop selector does shut down the electrical or pneumatic systems. The stopping time of the paper winder system 10 can depend on the current running speed of the paper winder system 10. In some embodiments, the stopping time of the paper winder system 10 after selecting the fast-stop selector is approximately 10 seconds or less.

In order to bring the paper winder system 10 to a normal driver stop, an operator can select a Machine Stop selector included on the unwind stand rear main screen 600. In some embodiments, selecting the Machine Stop selector does not shut down electrical systems and/or pneumatic systems, as the Fast Stop selector may do.

The unwind stand rear main screen 600 can also include an unwind select section 604. The unwind select section 604 can include a Rear selector and a Front selector. An operator can select either the Rear selector or the Front selector in order to select an unwind stand to use.

FIG. 110 is a rear unwind stand control screen 610 of the graphical user interface according to one embodiment of the invention. The rear unwind stand control screen 610 can appear after selecting the Rear Jog Screen selector on the unwind stand rear main screen 600. The rear unwind stand control screen 610 can display fault messages and prompts for obtaining paper winder system 10 operating parameters. The rear unwind stand control screen 610 can include a Rear Main Screen selector that an operator can select in order to access the unwind stand rear main screen 600. The rear unwind stand control screen 610 can also include the Rear Roll Change selector that, when selected, accesses the rear roll change screen 620, as shown in FIG. 111.

The rear unwind stand control screen 610 can include a Jog/Run selector. Using the Jog/Run selector an operator can switch between operating an unwind stand in a jog mode or a run mode. In a jog mode, an operator can jog the rear unwind stand 52 (as shown in FIG. 2) in order to thread the paper winder system 10 and/or clear a jam. In jog mode, a Jog selector included on the rear unwind stand control screen 610 can be used to jog the rear unwind stand 52. In some embodiments, a warning signal, such as a horn or light, is generated each time the jog selector is selected.

When in jog mode, an operator can use a Jog Direction selector in order to choose between jogging the rear unwind stand 52 in reverse or forward. In order to jog the rear unwind stand 52 in reverse, the Jog Direction selector can be set to a reverse jog mode. In order to jog the rear unwind stand 52 forward, the Jog Direction selector can be set to a forward jog mode. In some embodiments, an operator can also use the Job Direction selector to jog multiple unwind stands, such as the front unwind stand 50 and the rear unwind stand 52 (as shown in FIG. 2). In order to jog multiple unwind stands, each Job Direction selector on each unwind stand can be set to a multiple unwind stand jog mode.

Using the Jog/Run selector, an operator can also place the rear unwind stand 52 in a run mode that can make the paper winder system 10 ready to run. In some embodiments, multiple unwind stands can be ready to run when each Jog/Run selector of each unwind stand is set to a run mode.

FIG. 111 is a rear unwind stand control screen 620 of the graphical user interface according to one embodiment of the invention. The rear unwind stand control screen 620 can appear after selecting the Rear Roll Change selector on the unwind stand rear main screen 600 and/or the unwind stand rear jog screen 610. The rear unwind stand control screen 620 can display fault messages and prompts for obtaining paper winder system 10 operating parameters. The rear unwind stand control screen 620 can also include a Rear Main Screen selector that an operator can select in order to access the unwind stand rear main screen 600. In addition, the rear unwind stand screen 620 can also include a Rear Jog Screen selector that an operator can selector in order to access the unwind stand rear jog screen 610.

The rear unwind stand control screen 620 can include a Belt Arm Disengage selector. In some embodiments, an operator can select the Belt Arm Disengage selector in order to disengage the drive belts from the parent roll 70. The belt loading cylinders can then retract and unload the drive belts from the parent roll 70. Similarly, the rear unwind stand control screen 620 can include a Belt Arm Engaged selector that an operator can select in order to engage the drive belts with the parent roll 70. The belt loading cylinders can then extend and load the drive belts to the parent roll 70.

In some embodiments, the rear unwind stand control screen 620 can include a Core Chucks Disengage selector. An operator can select the Core Chucks Disengage selector in order to disengage the core chucks from the parent roll 70. Likewise, an operator can select a Core Chucks Engage selector included on the rear unwind stand control screen 620 in order to disengage the core chucks from the parent roll 70. After a spent parent roll 70 is unchucked, an operator can select a Core Eject selector included on the rear unwind stand control screen 620 in order to eject the parent roll core. An operator can also use an Auto Unchuck selector in order to disengage the drive belts, retract the core chunks for the parent roll, and eject the parent roll core.

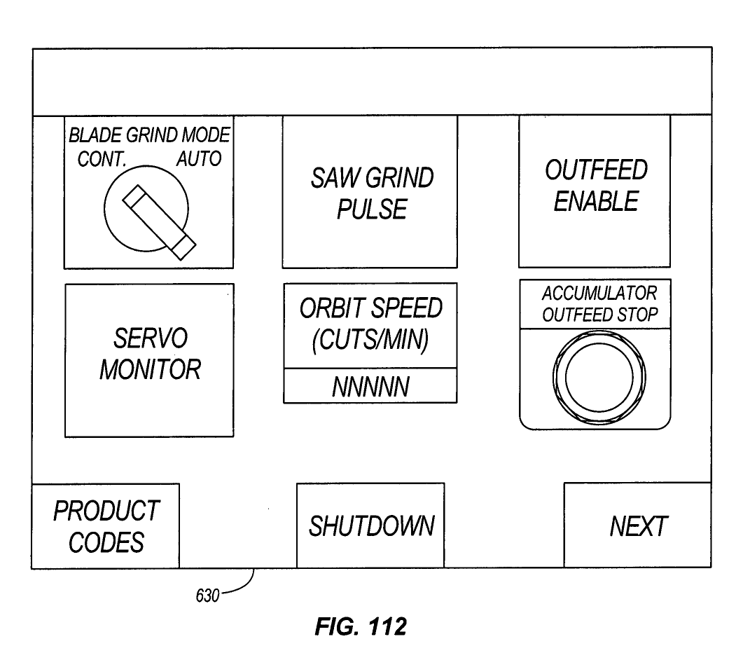

FIG. 112 a log saw main screen 630 of the graphical user interface according to one embodiment of the invention. In some embodiments, the log saw main screen 630 can appear on a touch screen of the paper winder system 10, such as an Allen-Bradley Panel View 600 touch screen system sold by Rockwell Automation. In some embodiments, the log saw main screen 630 can be displayed to obtain paper winder system 10 operating parameters for the log saw 26. In addition, the log saw main screen 630 can display fault messages and/or prompts necessary for operating the paper winder system 10.

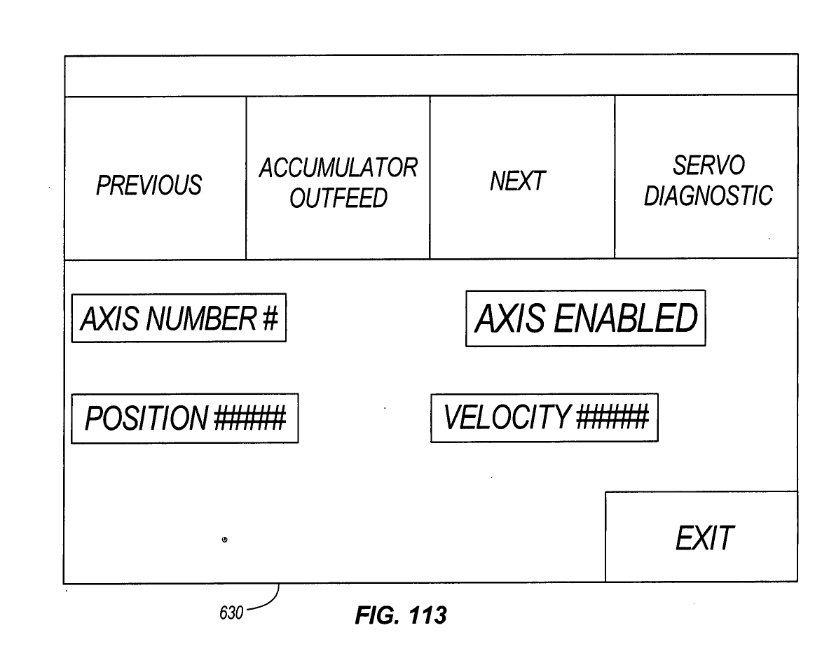

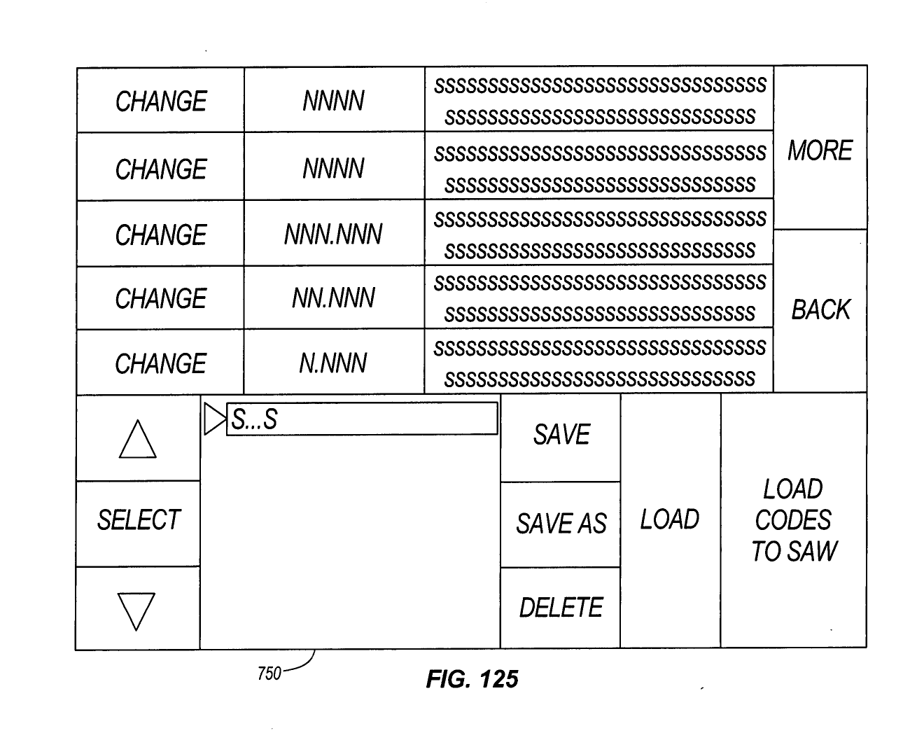

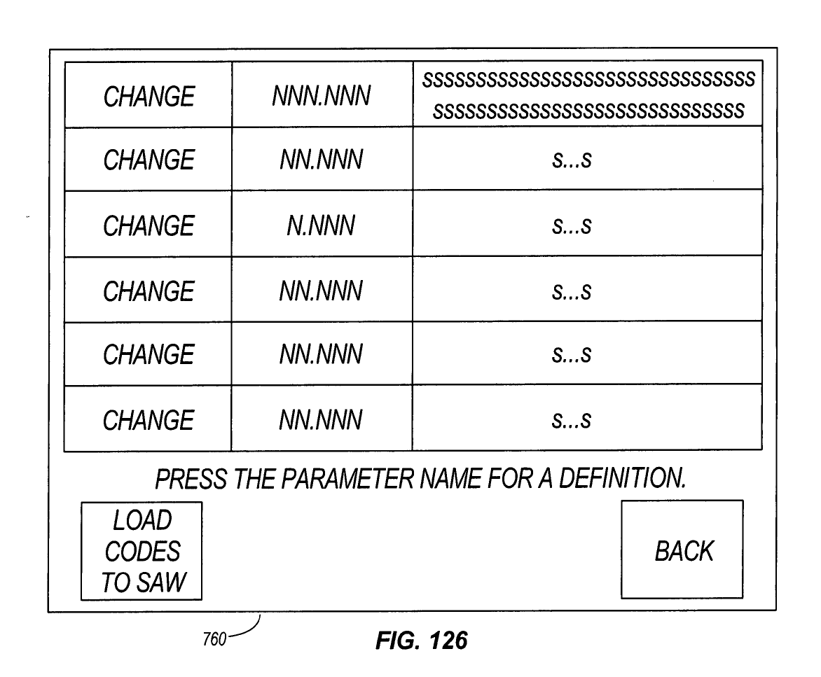

The log saw main screen 630 can include a Servo Monitor selector that an operator can select in order to access a servo monitor screen 640 (as described and illustrated below with respect to FIG. 113). The log saw main screen 630 can also include a Product Codes selector. An operator can selector the Product Codes selector in order to access a product code screen 750 (as described and illustrated below with respect to FIG. 125). In some embodiments, the log saw main screen 630 can include a Next selector to an accumulator controls screen 760 (as described and illustrated below with respect to FIG. 126). In addition, the log saw main screen 630 can include a Shutdown selector that an operator can select in order to close the log saw main screen 630 and/or shut down the control system 12 of the paper winder system 10.

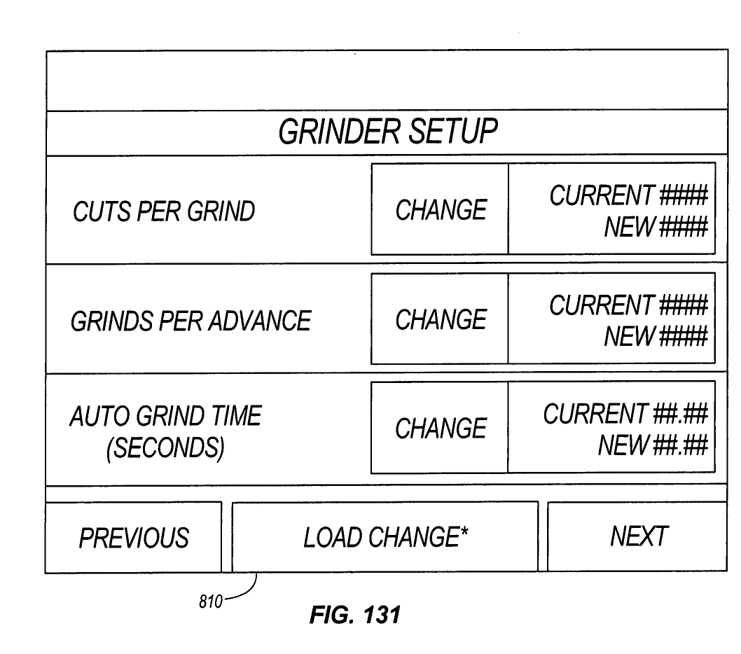

The log saw main screen 630 can include a Blade Grind Mode selector. An operator can use the Blade Grind Mode selector in order to set an operator operating mode for a grinding wheel of the log saw 26 (as shown in FIG. 8). In some embodiments, an operator can select the Blade Grind selector in order to select a continuous operating mode or an automatic operating mode. In the continuous mode, the grinding wheel can automatically grind for a predetermined time, disengage, and then remain disengaged for twice as long as the predetermined grind time. In some embodiments, an operator can set the grinding wheel to a continuous mode in order to sharpen a new or dull blade. In some embodiments, the automatic mode is a normal running mode of the grinding wheel. In the automatic mode, the frequency of the grinding of the grinding wheel can be set on a grinder setup screen 800 (as described and illustrated below with respect to FIG. 131). In some embodiments, the Blade Grind selector can remain set to a mode until an operator changes the mode.

The log saw main screen 630 can include a Saw Grind Pulse selector that an operator can use to pulse the saw grinding wheel. In some embodiments, the pulse continues as long as the operator keeps the Saw Grind Pulse selector in a selected position.

In order to receive logs from the accumulator, the log saw main screen 630 can include an Outfeed Enable selector that an operator can select in order to enable the outfeed assembly of the accumulator 24 (as shown in FIG. 7). In some embodiments, if the accumulator 24 has available logs, enabling the outfeed drive can feed logs to the log saw 26. Similarly, an operator can stop logs from being delivered from the accumulator 24 by selecting an Accumulator Outfeed Stop selector, which stops the accumulator outfeed assembly 166 (as shown in FIG. 7). In some embodiments, the remainder of the paper winder system 10 can continue to run although the outfeed assembly 166 of the accumulator 24 is stopped, because logs can be stored in the accumulator 24 until the accumulator 24 is full.

To start the log saw 26, the log saw main screen 630 can include a Log Saw Start selector. When the log saw 26 is running, the log saw main screen 630 can indicate an orbital speed of an orbital log saw arm. In some embodiments, the log saw main screen 630 can also include an Orbit selector that an operator can select in order to adjust the orbital speed of the log saw arm.

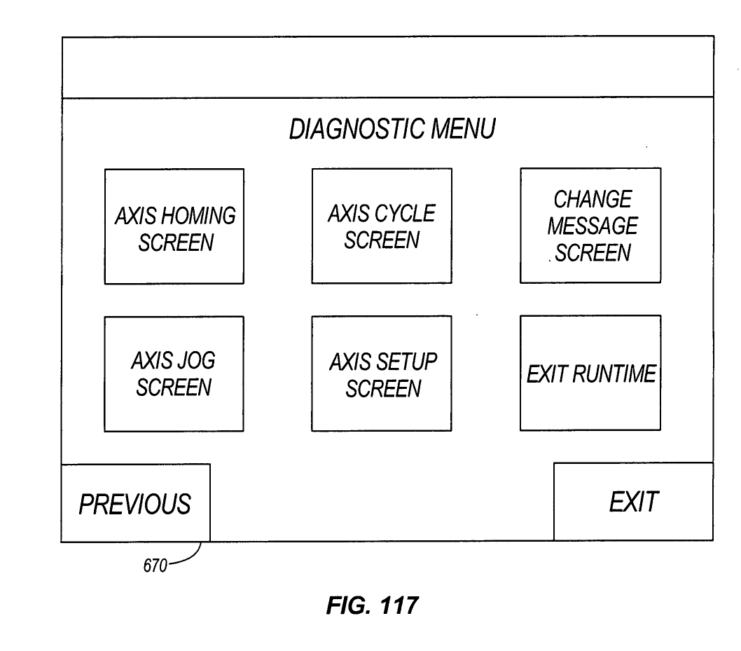

FIG. 113 is a log saw servo monitor screen 640 of the graphical user interface according to one embodiment of the invention. The log saw servo monitor screen 640 can appear after selecting the Servo Monitor selector on the log saw main screen 630. The log saw servo monitor screen 640 can display fault messages and prompts for obtaining paper winder system 10 operating parameters. The log saw servo monitor screen 640 can also include a Servo Diagnostic selector that an operator can select in order to access a log saw diagnostic main screen 670 (as described and illustrated below with respect to FIG. 117). In addition, the log saw servo monitor screen 640 can include an Exit selector.

In some embodiments, the log saw 26 can include one or more log saw servo axes. The log saw servo monitor screen 640 can include a Previous selector and a Next selector. An operator can use the Previous selector and the Next selector in order to scroll through log saw servo axes. In some embodiments, a currently-selected axis (e.g., accumulator outfeed) is included on the log saw servo monitor screen 640 between the Previous selector and the Next selector.

When an operator selects an axis, the log saw servo monitor screen 640 can indicate an Axis Number, an Axis Position, and an Axis Velocity. An operator can also select an Axis Enabled/Disabled selector included on the log saw servo monitor screen 640 in order to enable or disable a currently-selected axis.

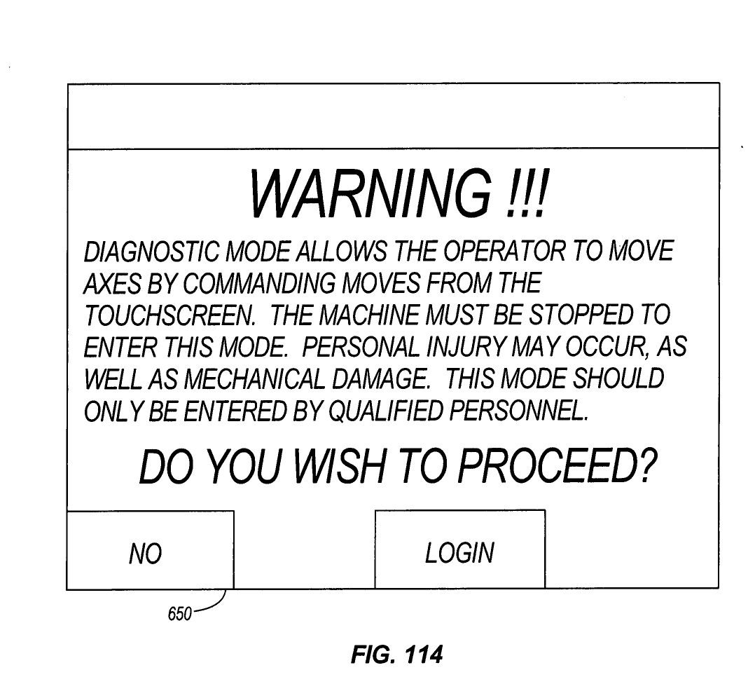

FIG. 114 is a log saw cycle confirmation screen 650 of the graphical user interface according to one embodiment of the invention. The log saw cycle confirmation screen 650 can appear after selecting the Servo Diagnostic selector on the log saw servo monitor screen 640. The log saw cycle confirmation screen 650 can display fault messages and prompts for obtaining paper winder system 10 operating parameters.

The log saw cycle confirmation screen 650 can include a warning message that informs an operator of safety issues involved with using servo diagnostic functions. If an operator does not want to proceed with servo diagnostic functions, an operator can select a No selector in order to cancel servo diagnostic functions and close the log saw cycle confirmation screen 650. In some embodiments, selecting the No selector can close the log saw cycle confirmation screen 650 and can display a previously-displayed screen, such as the log saw servo monitor screen 640.

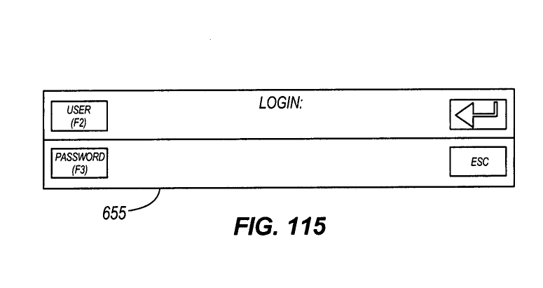

If an operator does want to proceed with a servo diagnostic function, an operator can select a Login selector included on the log saw cycle confirmation screen 650. Upon selecting the Login selector, an operator can be required to enter a username and/or password in order to continue with a servo diagnostic function. In some embodiments, selecting the Login selector can access a login screen 655 as shown in FIG. 115. The login screen 655 can include a User selector, a Password selector, a Return selector, and an Escape selector. In some embodiments, selecting the User selector or the Password selector can access a keypad than an operator can use to enter a username and/or a password. After an operator has entered a username and/or password, an operator can select the Return selector in order to request validation of the username and/or password. In some embodiments, if an operator wants to cancel the login process, an operator can select the Escape selector. Selecting the Escape selector can close the login screen 655 and display a previously-displayed screen, such as the log saw cycle confirmation screen 650 or the log saw servo monitor screen 640.

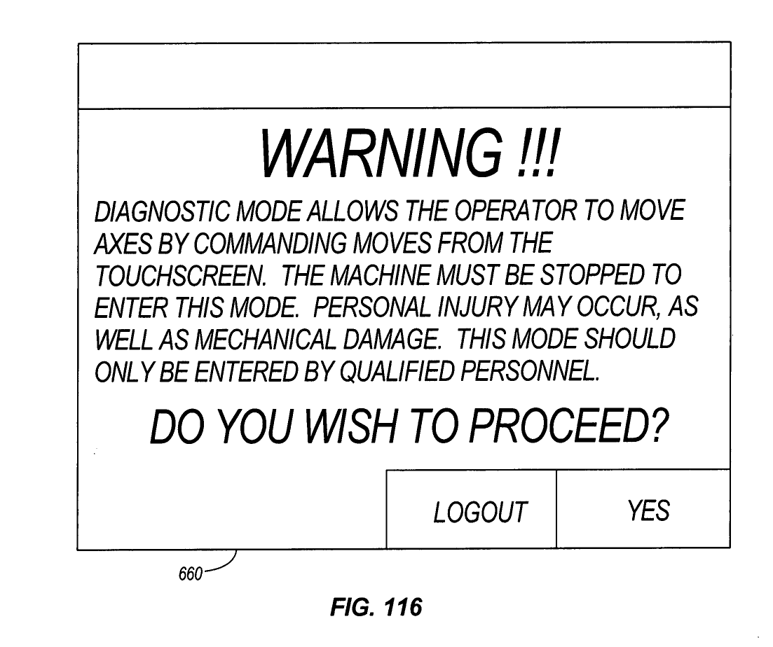

FIG. 116 is a log saw login confirmation screen 660 of the graphical user interface according to one embodiment of the invention. The log saw login confirmation screen 660 can appear after an operator enters a valid username and password on the login screen 655. The log saw login confirmation screen 660 can display fault messages and prompts for obtaining paper winder system 10 operating parameters.

The log saw login confirmation screen 660 can include a warning message that informs an operator of safety issues involved with using servo diagnostic functions. The log saw login confirmation screen 660 can include a Logout selector and a Yes selector. In order to cancel servo diagnostic functions and logout, an operator can select the Logout selector. Selecting the Logout selector can logout an operator and can disable password protected functions that were unlocked when the operator entered a valid username and password on the login screen 655. In some embodiments, selecting the Logout selector can close the log saw login confirmation screen 660 and can display a previously-displayed screen, such as the log saw cycle confirmation screen 650 or the log saw servo monitor screen 640.

In order to continue with servo diagnostic functions, an operator can select the Yes selector. Selecting the Yes selector can access a log saw diagnostic main screen 670 as shown in FIG. 117. The log saw diagnostic main screen 670 can display fault messages and prompts for obtaining paper winder system 10 operating parameters. In some embodiments, the log saw diagnostic main screen 670 can include a Previous selector and an Exit selector. An operator can select the Previous selector in order to close the log saw diagnostic main screen 670 and display a previously-displayed screen, such as the log saw servo monitor screen 640. In some embodiments, an operator can select the Exit selector in order to close the log saw diagnostic main screen 670 and display a previously-displayed screen, such as the log saw login confirmation screen 660 or the log saw servo monitor screen 640. The log saw diagnostic main screen 670 can include an Exit Run-Time selector that an operator can use in order to exit the paper winder system control system 12.

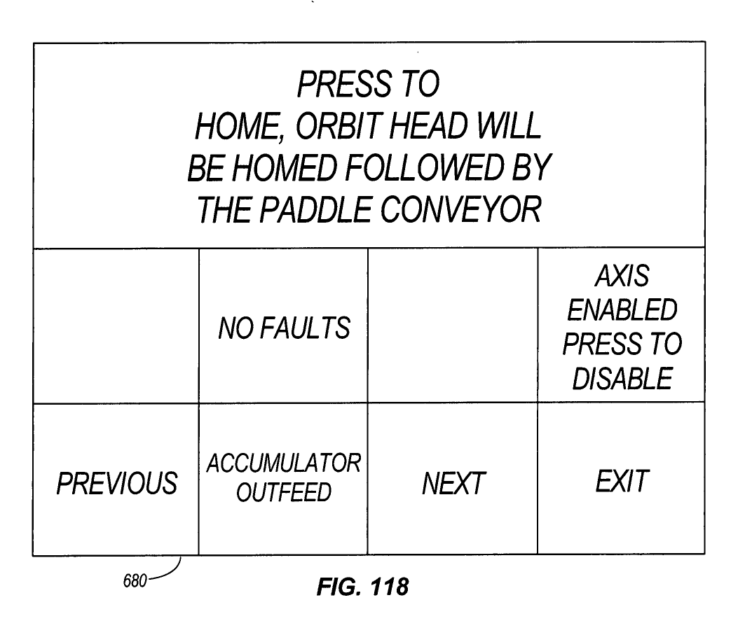

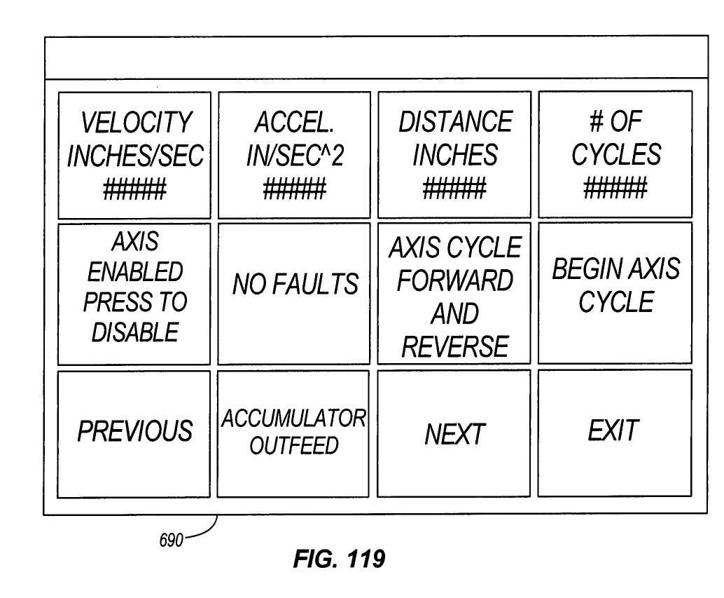

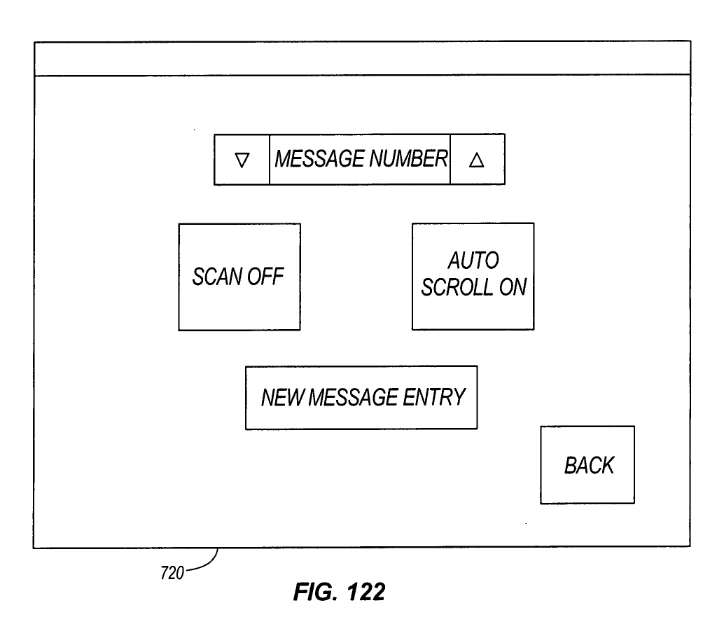

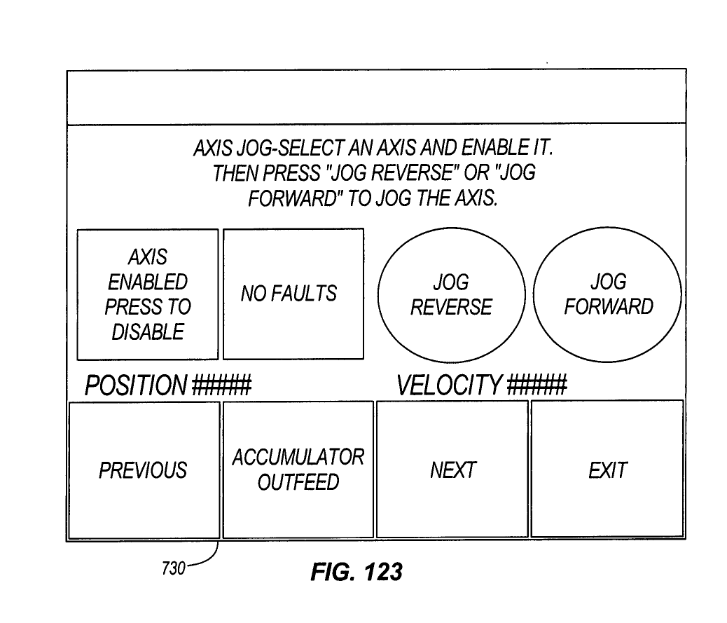

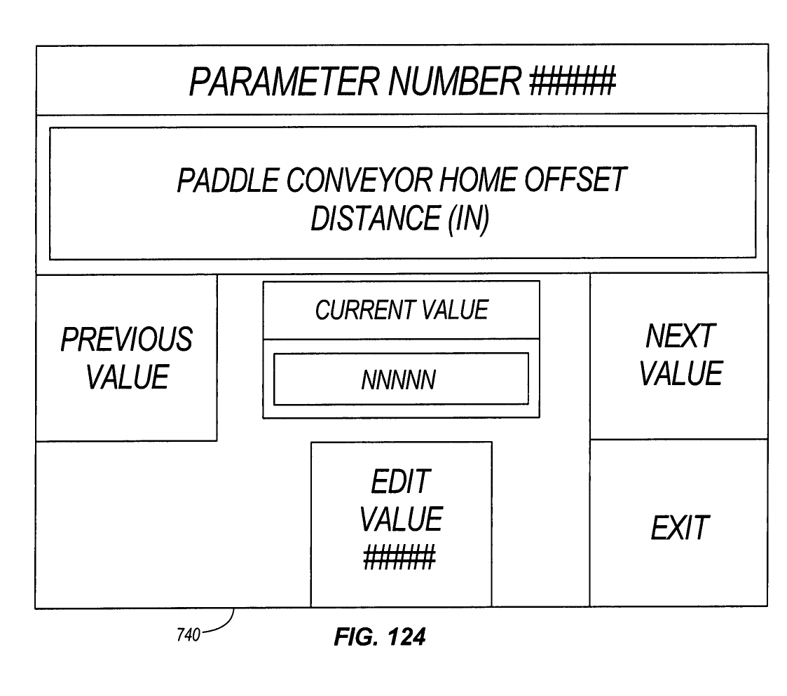

The log saw diagnostic main screen 670 can include an Axis Homing Screen selector, an Axis Cycle Screen selector, a Change Message Screen selector, an Axis Jog Screen selector, and an Axis Setup Screen selector. An operator can select the Axis Homing Screen selector in order to access an axis homing screen 680 (as described and illustrated below with respect to FIG. 118). An operator can select the Axis Cycle Screen selector in order to access an axis cycle screen 690 (as described and illustrated below with respect to FIG. 119). An operator can also select the Change Message Screen selector in order to access a change message screen 720 (as described and illustrated below with respect to FIG. 122). Similarly, an operator can select the Axis Jog Screen selector in order to access an axis jog screen 730 (as described and illustrated below with respect to FIG. 123), and an operator can select the Axis Setup Screen selector in order to access an axis setup screen 740 (as described and illustrated below with respect to FIG. 124).

FIG. 118 is a log saw axis homing screen 680 of the graphical user interface according to one embodiment of the invention. The log saw axis homing screen 680 can appear after selecting the Axis Homing Screen selector on the log saw diagnostic main screen 670. In some embodiments, the log saw axis homing screen 680 can also include a Clear Faults selector that an operator can select in order to clear faults that are displayed on the log saw axis homing screen 680. The Clear Faults selector can also indicate that no faults exist to be cleared. In some embodiments, the Clear Faults selector can be disabled and/or can turn a color or display a message, such as “No Faults,” in order to indicate that no fault messages exist to clear.

The log saw axis homing screen 680 can include a Previous selector and a Next selector. An operator can use the Previous selector and the Next selector in order to scroll through log saw servo axes. In some embodiments, a currently-selected axis can be displayed on the log saw axis homing screen 680. For example, a display box located between the Previous selector and the Next selected can display a currently-selected axis (e.g., accumulator outfeed).

Once an axis is selected, an operator can select an Axis Enabled/Disabled selector included on the log saw axis homing screen in order to enable or display a currently-selected axis. An operator can also return to a home or starting position a currently-selected axis by selecting a Press to Home selector included on the log saw axis homing screen 680.

In some embodiments, the log saw axis homing screen 680 can also include an Exit selector that an operator can select in order to close the log saw axis homing screen 680.

FIG. 119 is a log saw axis cycle screen 690 of the graphical user interface according to one embodiment of the invention. The log saw axis cycle screen 690 can appear after selecting the Axis Cycle Screen selector on the log saw diagnostic main screen 670. The log saw axis cycle screen 690 can display fault messages and prompts for obtaining paper winder system 10 operating parameters. In some embodiments, the log saw axis cycle screen 690 can also include a Clear Faults selector that an operator can select in order to clear displayed faults. The Clear Faults selector can be disabled after all faults have been cleared until a new fault occurs. In some embodiments, the Clear Faults selector can change color and/or include a message, such as “No Faults,” in order to indicate that there are no fault messages to clear.

The log saw axis cycle screen 690 can include a Previous selector and a Next selector that an operator can use to scroll through log saw servo axes. In some embodiments, the log saw axis cycle screen 690 can also include a currently-selected axis. For example, a display box, located between the Previous selector and the Next selector can indicate a currently-selected axis (e.g., accumulator outfeed).

Once an axis is selected, an operator can use a Velocity selector, an Acceleration selector, a Distance selector, and a Number of Cycles selector in order to change the operation of a currently-selected axis. In some embodiments, selecting any of these selectors can access a numeric keypad on which an operator can enter new operating parameters for a currently-selected axis. Each of these selectors can also indicate a current value of an operating parameter for an axis. An operator can select the Velocity selector in order to enter a velocity of the currently-selected axis. In some embodiments, an operator can enter a velocity value in Inches per Second units. An operator can select the Acceleration selector in order to enter an acceleration of the currently-selected axis. In some embodiments, an operator can enter an acceleration value in Inches per Second units. An operator can also select the Distance selector in order to enter a distance of the currently-selected axis. An operator can enter a distance value in inch units. Furthermore, an operator can select the Number of Cycles selector in order to enter a number of cycles for the currently-selected axis.

An operator can also use an Axis Enable/Disable selector in order to enable or disable a currently-selected axis. In addition, an operator can select an Axis Cycle Forward/Reverse selector and/or a Begin Axis Cycle selector to influence the operation of a currently-selected axis. Using the Axis Cycle Forward/Reverse selector, an operator can cycle a currently-selected axis in a forward direction and/or a reverse direction. Once all operating parameters are entered and/or selector, an operator can select the Begin Axis Cycling selector in order to begin cycling a currently-selected axis using the operating parameters entered by the operator. In some embodiments, after selecting the Begin Axis Cycling selector, the Begin Axis Cycling selector can be disabled and can display a message, such as “Axis Cycling.”

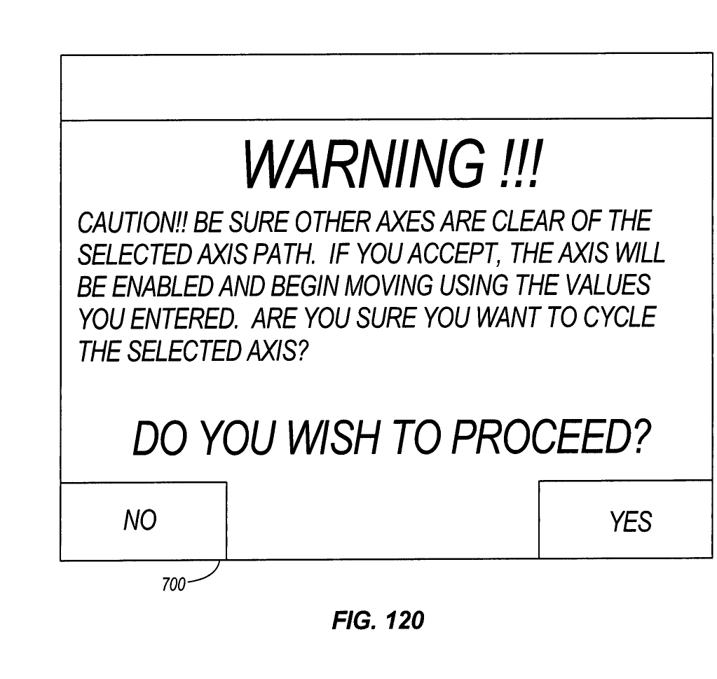

FIG. 120 is a log saw axis cycle confirmation screen 700 of the graphical user interface according to one embodiment of the invention. The log saw axis cycle confirmation screen 700 can appear after selecting the Begin Axis Cycle selector on the log saw axis cycle screen 690. The log saw axis cycle confirmation screen 700 can display fault messages and prompts for obtaining paper winder system 10 operating parameters. The log saw axis cycle confirmation screen 700 can also include a warning message that informs an operator of safety issues involved with using axis cycle functions.

The log saw axis cycle confirmation screen 700 can include a No selector and a Yes selector. An operator can select the No selector in order to cancel axis cycle functions. In some embodiments, selecting the No selector can close the log saw axis cycle confirmation screen 700 and display a previously-displayed screen.

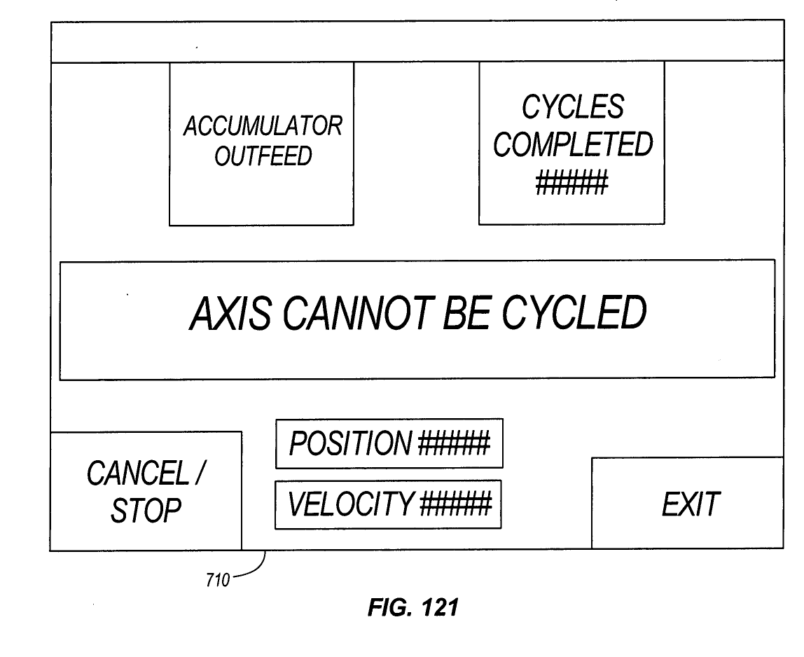

An operator can select the Yes selector in order to continue with axis cycle functions. Selecting the Yes selector can access a log saw cycle monitor screen 710 as shown in FIG. 121. In some embodiments, an operator can be required to login before accessing the log saw cycle monitor screen 710. For example, an operator can be required to provide a valid username and/or a password in order to access the log saw cycle monitor screen 710.

As shown in FIG. 121, the log saw cycle monitor screen 710 can display fault messages and prompts for obtaining paper winder system 10 operating parameters. For a selected axis, the log saw cycle monitor screen 710 can include an Axis Currently Cycling value, a Number of Cycles Completed value, a Status message, a Position value, and a Velocity value. The log saw cycle monitor screen 710 can also include a Cancel/Stop selector and/or an Exit selector. In some embodiments, an operator can select the CancelStop selector in order to cancel axis cycle functions. The Exit selector can be selected by an operator to close the log saw cycle monitor screen 710 and display a previously-displayed screen. In some embodiments, the log saw cycle monitor screen 710 can also indicate whether a selected axis is able to be cycled.

FIG. 122 is a log saw change message screen 720 of the graphical user interface according to one embodiment of the invention. The log saw change message screen 720 can appear after selecting the Change Message Screen selector on the log saw diagnostic main screen 670. The log saw change message screen 720 can display fault messages and prompts for obtaining paper winder system 10 operating parameters.

The log saw change message screen 720 can include an Up selector and a Down selector. An operator can use the Up selector and the Down selector in order to scroll through messages and select a message number. In some embodiments, the log saw change message screen 720 also displays a currently-selected message number. As shown in FIG. 122, the log saw change message screen 720 can include a display box positioned between the Up selector and Down selector that indicates a currently-selected message number.

In some embodiments, one or more modes are available to view and scroll through messages. The log saw change message screen 720 can include a Scan On/Off selector and an Automatic Scroll On/Off selector in order to select a scrolling mode. An operator can use the Scan On/Off selector in order to start and stop a message scanning functionality of the paper winder control system 10. An operator can also select the Automatic Scroll On/Off selector in order to control a method of message review. In an automatic scroll on mode, messages can be scrolled automatically. In an automatic-scroll-off mode, an operator can scroll through messages manually using the Up selector and the Down selector. In some embodiments, the Automatic Scroll On/Off selector and the Scan On/Off selector must be set to an off mode in order for an operator to change a message.

Once an operator selects message, an operator can select a New Message Entry selector in order to enter new message text. In some embodiments, selecting the New Message Entry selector can access a keypad on which an operator can enter new message text.

In some embodiments, the log saw change message screen 720 can also include a Back selector that an operator can select in order to close the log saw change message screen 720 and display a previously-displayed screen, such as the log saw diagnostic main screen 670.

FIG. 123 is a log saw axis jog screen 730 of the graphical user interface according to one embodiment of the invention. The log saw axis jog screen 730 can appear after selecting the Axis Jog Screen selector on the log saw diagnostic main screen 670. The log saw axis jog screen 730 can display fault messages and prompts for obtaining operating parameters of the paper winder system 10. In some embodiments, the log saw axis jog screen 730 can also include a Clear Faults selector that an operator can select in order to clear any displayed fault messages. In some embodiments, if no fault messages are displayed, the Clear Faults selector can be disabled. The Clear Faults selector can change color and/or display a message, such as “No Faults,” in order to indicate that the selector is disabled.

The log saw axis jog screen 730 can include outline instructions. In some embodiments, the outline instructions can list a recommended sequence for using the selectors included on the log saw axis jog screen 730. The log saw axis jog screen 730 can also include a Previous selector and a Next selector that an operator can use to scroll through log saw servo axes and select a log saw servo axis. In some embodiments, the log saw axis jog screen 730 can include a display box that indicates a currently-selected axis. The display box can be positioned between the Previous selector and the Next selector.

Once an axis is selected, the log saw axis jog screen 730 can include a position value and a velocity value of a currently-selected axis. An operator can then use an Axis Enable/Disable selector, a Jog Reverse selector, and/or a Jog Forward selector to influence operation a currently-selected axis. An operator can select the Axis Enable/Disable selector in order to enable or disable a currently-selected axis. An operator can use the Jog Reverse selector and the Jog Forward selector to jog a currently-selected axis in a corresponding direction.

The log saw axis jog screen 730 can also include an Exit selector that an operator can use in order to close the log saw axis jog screen 730 and display a previously-displayed screen, such as the log saw diagnostic main screen 670.

FIG. 124 is a log saw axis setup screen 740 of the graphical user interface according to one embodiment of the invention. The log saw axis setup screen 740 can appear after selecting the Axis Setup Screen selector on the log saw diagnostic main screen 670. The log saw axis setup screen 740 can include a Previous Value selector and a Next Value selector that an operator can select in order to scroll through parameters and select a parameter. In some embodiments, the log saw axis setup screen 740 can include a display box that displays a description of the currently-selected parameter and a display box that displays the current value of a currently-selected parameter. The display box can be positioned between the Previous Value selector and the Next Value selector. The log saw axis setup screen 740 can also include a parameter number of a currently-selected parameter.

Once an operator has selected a parameter, an operator can select an Edit Value selector included on the log saw axis setup screen 740 in order to edit the value of the currently-selected parameter. In some embodiments, selecting the Edit Value selector can access a numeric keypad on which an operator can enter a new parameter value. The log saw axis setup screen 740 can also include an Exit selector that an operator can use in order to close the log saw axis setup screen 740.

FIG. 125 is a log saw product codes screen 750 of the graphical user interface according to one embodiment of the invention. The log saw product codes screen 750 can appear after the Set Product Codes selector is selected at the log saw main screen 630. Using the log saw product codes screen 750, an operator can change product codes for product changeover and/or can adjust individual parameter values in order to adjust operation of the paper winder system 10. In order to adjust and/or load a set of product codes, an operator can first select a set of product codes using an Up selector and a Down selector included on the log saw product codes screen 750. Once a code set is highlighted in a display box included on the log saw product codes screen 750, an operator can choose the Select button in order to choose a set of product codes.

An operator can then load a set of product codes by selecting a Load selector. Using one or more Change selectors included on the log saw product codes screen 750, an operator can make parameter adjustments. Selecting a Change selector can access a keypad on which an operator can enter a new parameter value. In some embodiments, an operator can also select a Parameter Name selector in order to obtain a description of a parameter.

The log saw product codes screen 750 can include a More selector that an operator can select in order to view additional parameters. FIG. 126 is another log saw product codes screen 760 that includes additional parameters and Change selectors for an operator to change the value of a parameters. The log saw product codes screen 760 can also include a Back selector that an operator can select in order to return to the log saw product codes screen 750, as shown in FIG. 125.

Once a new parameter value is entered, an operator can load changes by selecting a Load Codes to Saw selector included on the log saw product codes screen 750 and 760. Changes can also be saved by selecting a Save selector or a Save As selector. In some embodiments, the Save As selector can be used to create and save a new set of product codes. After selecting the Save As selector, a keypad can be displayed on which an operator can provide a name for the new set of product codes.

In some embodiments, the parameters included on the log saw product codes screens 750 and 760 are color-coded according to the estimated frequency of adjustment. For example, green parameters can indicate parameters that are changed on a daily basis, light blue parameters can indicate other parameters that are changed on a random schedule, dark blue parameters can indicate parameters that are changed on a one-time basis, purple parameters can indicate tail sealer parameters, and red parameters can indicate technician parameters.

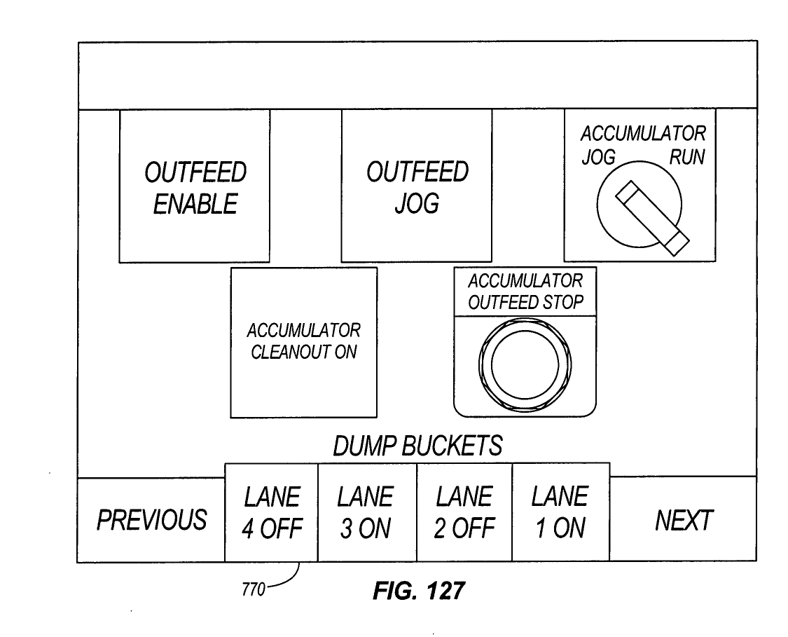

FIG. 127 is an accumulator control screen 770 of the graphical user interface according to one embodiment of the invention. The accumulator control screen 770 can appear after selecting the Next selector on the log saw main screen 630. The accumulator control screen 770 can display fault message and prompts for obtaining paper winder system 10 operating parameters. The accumulator control screen 770 can also include a Previous selector and a Next selector. An operator can use the Previous selector and the Next selector in order to scroll through other control screens.

The accumulator control screen 770 can include an Accumulator Jog/Run selector. An operator can use the Accumulator Jog/Run selector in order to set an operating mode of the accumulator 24 (as shown in FIG. 7). In some embodiments, an operator can use the Accumulator Jog/Run selector in order to set the accumulator 24 in a jog mode or a run mode. In a jog mode, the accumulator 24 can be jogged over for the purpose of clearing a jam. In some embodiments, a jog mode is used in conjunction with an Outfeed Jog selector and/or an Infeed Jog selector. An operator can select the Outfeed Jog selector and the Infeed Jog selector in order to jog the corresponding drive of the accumulator 24. In some embodiments, the Outfeed Jog selector and the Infeed Jog selector are disabled when the Accumulator Jog/Run selector is not set to a jog mode.

In a run mode, the accumulator 24 can be run continuously. Once in a run mode, an operator can select an Outfeed Enable selector included on the accumulator control screen 770 in order operate the outfeed drive to the accumulator 24 under normal operating conditions.

The accumulator control screen 770 can include an Accumulator Cleanout selector that an operator can select in order to send all staged logs to the log saw 26 from the accumulator 24 (as shown in FIGS. 7 and 8). In some embodiments, the Accumulator Jog/Run selector can be set to a run mode in order to run the accumulator 24 and send the staged logs. The accumulator control screen 770 can also include an Accumulator Outfeed Stop selector. An operator can select the Accumulator Outfeed Stop selector in order to stop the accumulator outfeed assembly, and therefore, stop logs from being fed to the log saw 26.

In some embodiments, the accumulator 24 can include multiple outfeed lanes. For example, the accumulator 24 can include four outfeed lanes. The accumulator control screen 770 can include a Lane On/Off selector for each lane that an operator can select in order to toggle operation of the outfeed lanes of the accumulator 24.

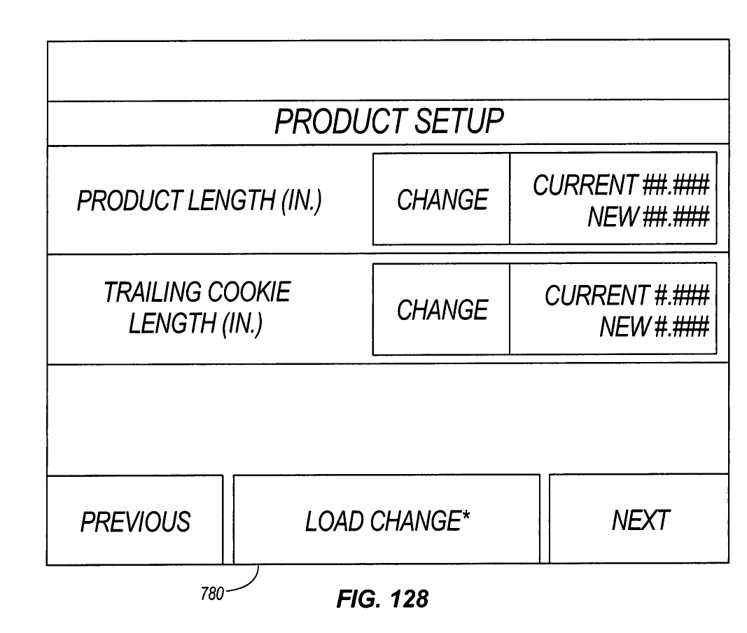

FIG. 128 is a log saw product setup screen 780 of the graphical user interface according to one embodiment of the invention. The log saw product setup screen 780 can appear after selecting the next selector on the accumulator control screen 770. In some embodiments, log saw product setup screen 780 can allow an operator to change parameters of product running through the paper winder system 10. The log saw product setup screen 780 can include a Previous selector and a Next selector that an operator can select in order to scroll through other control screens.

The log saw product setup screen 780 can display fault messages and prompts for obtaining paper winder system 10 operating parameters. The log saw product setup screen 780 can include a Current Product Length and Current Trailing Cookie Length. In some embodiments, the Current Product Length and the Current Trailing Cookie Length can be displayed in inches. The log saw product setup screen 780 can also include a New Product Length and a New Trailing Cookie Length.

To provide a New Product Length value and/or a New Trailing Cookie Length value, an operator can use a Change selector included on the log saw setup screen 780 for each product parameter. In some embodiments, upon selecting a Change selector, a numeric keypad can be displayed on which an operator can provide a new value for a product parameter.

Once an operator has provided one or more new parameter values, an operator can select a Load Change selector. Selecting the Load Change selector can confirm the new values and the can load the new values.

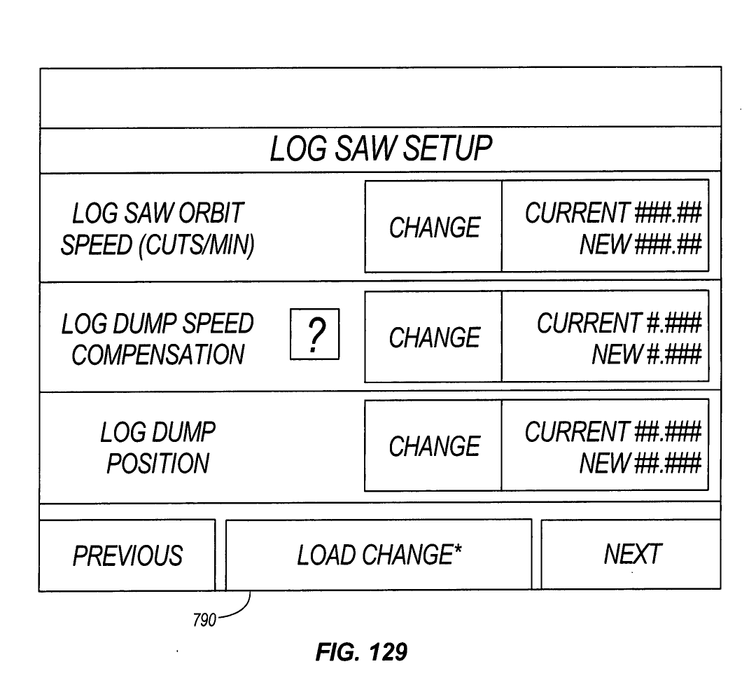

FIG. 129 is a log saw setup screen 790 of the graphical user interface according to one embodiment of the invention. The log saw setup screen 790 can appear after selecting the Next selector on the log saw product setup screen 780. The log saw setup screen 790 can allow an operator to change operating parameters for the log saw. The log saw setup screen 790 can also display fault messages and prompts for obtaining operating parameters of the paper winder system 10. To view previous or additional control screens, an operator can select a Previous selector and/or a Next selector included on the log saw setup screen 790.

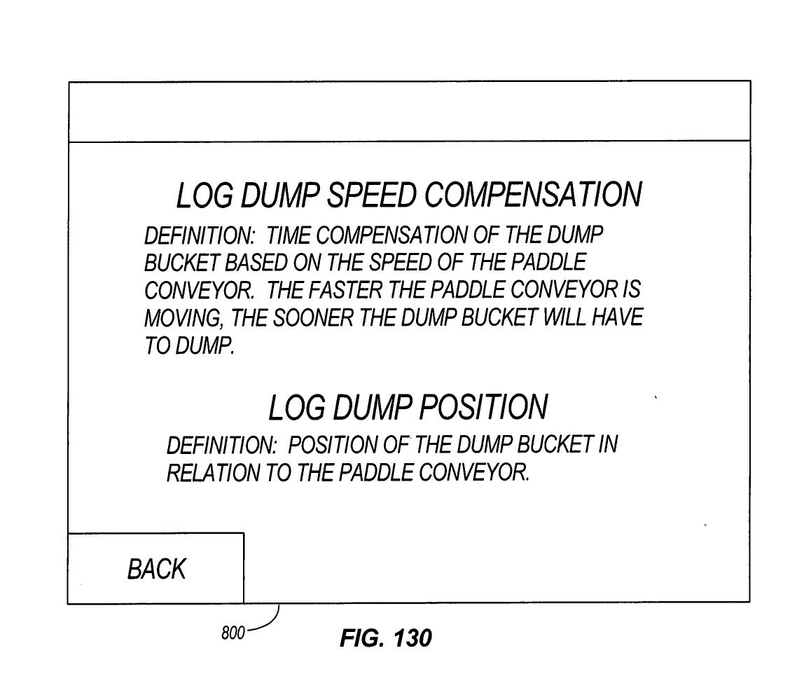

The log saw setup screen 790 can display a current value and a new value for various log saw operating parameters, such as a Log Saw Orbit Speed value, a Log Dump Speed Compensation value, and a Log Dump position. In some embodiments, a log saw operating parameter can include a Parameter Definition selector (e.g., a “?” box) that an operator can select in order to display a definition screen 800 as shown in FIG. 130. The parameter definition screen 800 can provide a definition for one or more parameters listed on the log saw setup screen 800. The parameter definition screen 800 can also include a Back selector that an operator can select in order to close the parameter definition screen 800 and display a previously-displayed screen, such as the log saw setup screen 790.

Each log saw operating parameter can also include a Change selector that an operator can select in order to provide a new value for an operating parameter. In some embodiments, selecting a Change selector can access a numeric keypad on which an operator can enter a new parameter value. After an operator has entered any parameter changes, an operator can select the Load Change selector. In some embodiments, selecting the Load Change selector can confirm the changed parameter values and load the new values.

FIG. 131 is a grinder setup screen 810 of the graphical user interface according to one embodiment of the invention. The grinder setup screen 810 can appear after selecting the Next selector on the log saw setup screen 790. The grinder setup screen 810 can allow an operator to change parameters for a grinder of the paper winder system 10. The grinder setup screen 810 can also include display fault message and prompts for obtaining operating parameters for the paper winder system 10. In some embodiments, the grinder setup screen 810 can include a Previous selector and a Next selector that an operator can use to scroll through other control screens.

The grinder setup screen 810 can include one or more operating parameters for the grinder, such as a Cuts per Grind value, a Grinds per Advance value, and an Automatic Grind Time value. The grinder setup screen 810 can also include a Current Parameter value and a New Parameter value for each grinder operating parameter. In order to provide a new parameter value, an operator can select a Change selector associated with each operating parameter. In some embodiments, selecting a Change selector can access a numeric keypad on which an operator can enter a new parameter value.

Once an operator can provided one or more new parameter values, an operator can select a Load Change selector included on the grinder setup screen 810. Selecting the Load Change selector can confirm the changed parameter values and can load them.

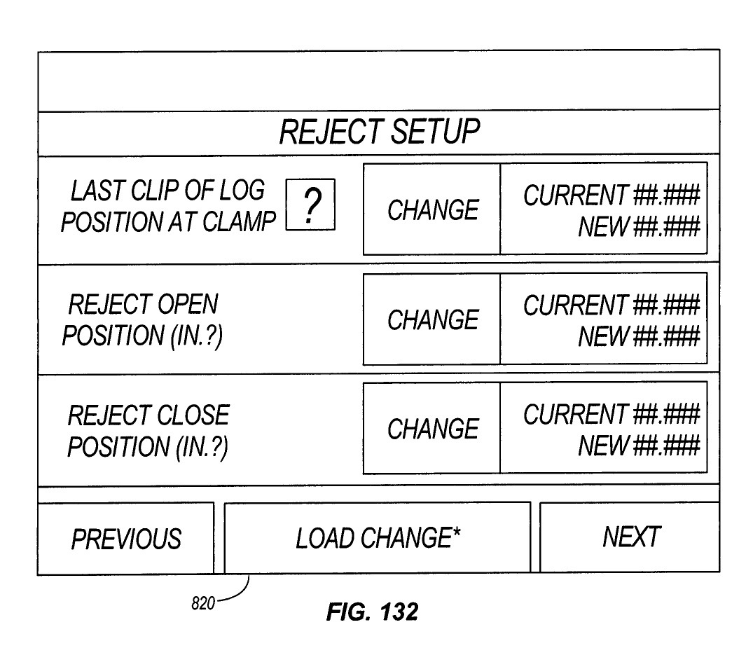

FIG. 132 is a reject setup screen 820 of the graphical user interface according to one embodiment of the invention. The reject setup screen 820 can appear after selecting the Next selector on the grinder setup screen 810. In some embodiments, the reject setup screen 820 allows an operator to change parameters for a reject assembly of the paper winder system 10. In addition, the reject setup screen 820 can include a Previous selector and a Next selector that an operator can use to scroll through other control screens.

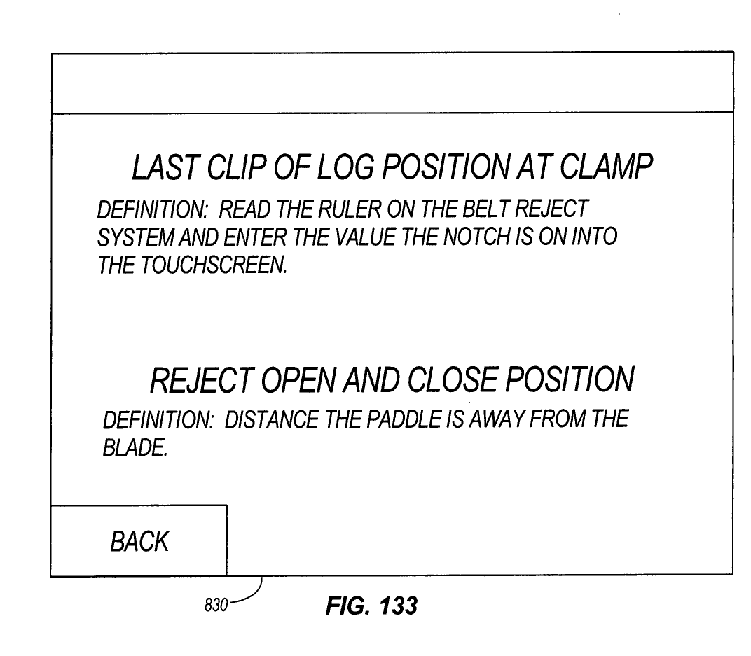

The reject setup screen 820 can include one or more operating parameters for the reject assembly, such as a Last Clip of Log Position at Clamp value, a Reject Open Position value, and a Reject Close position. Each operating parameter can include a current parameter value and a new parameter value. In some embodiments, some or all of the operating parameters can include a Parameter Definition selector (e.g., a “?” box) that an operator can select in order to access a parameter definition screen 830 as shown in FIG. 133. The parameter definition screen 830 can display a definition of one or more parameters listed on the reject setup screen. The parameter definition screen 830 can also include a Back selector. An operator can select the Back selector in order to close the parameter definition screen 830 and display a previously-displayed screen, such as the reject setup screen 820.

To provide a new parameter value for each of the operating parameters, an operator can select a Change selector associated with each operating parameter. In some embodiments, selecting a Change selector can access a numeric keypad on which an operator can enter a new parameter value.

In some embodiments, once an operator has entered one or more new parameter values, an operator can select a Load Changes selector. Selecting the Load Changes selector can confirm the value changes and can load the changes.

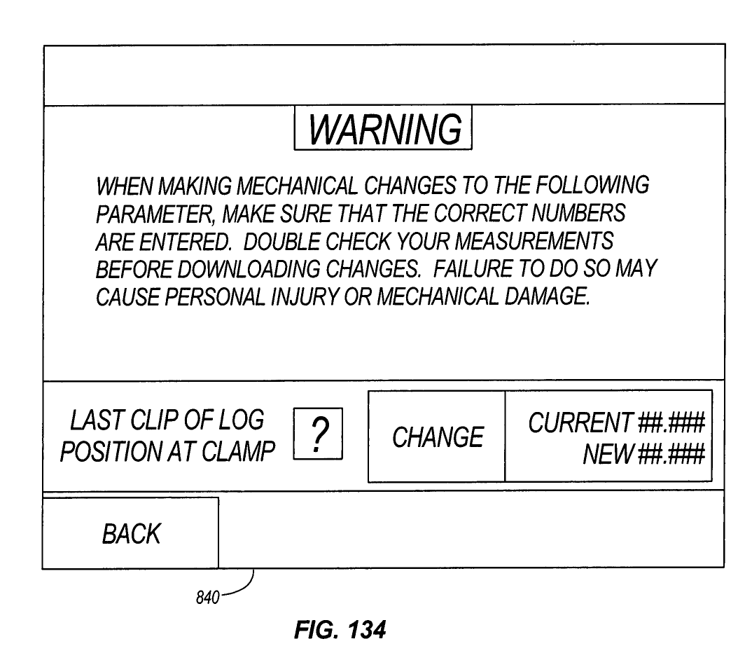

In some embodiments, selecting a Change selector on the reject setup screen 820 for a particular parameter can access a warning screen 840 as shown in FIG. 134. The warning screen 840 can display a warning message that informs an operator with guidance for safely and correctly providing a new parameter value in order to avoid certain dangerous repercussions. The warning screen 840 can include one or more operating parameters that include a current parameter value and a new parameter value. In some embodiments, some or all of the operating parameters included on the warning screen 840 can also include a Parameter Definition selector (e.g., a “?” box). In some embodiments, the warning screen 840 can include a Change selector that an operator can use to change a parameter value from the warning screen 840. The warning screen 840 can also include a Back selector. An operator can select the Back selector in order to close the warning screen 84 and display a previously-displayed screen, such as the reject setup screen 820. It should be understood that the warning screen 840 can be displayed upon selecting the Change selector for a particular operating parameter, entering a new value for an operating parameter, selecting a Parameter Definition selector for a particular operating parameters, selecting the Load Changes selector, and/or selecting the Next selector in the grinder setup screen 810 that causes the reject setup screen 820 to be displayed.

FIG. 135 is a lubrication setup screen 850 of the graphical user interface according to one embodiment of the invention. The lubrication setup screen 850 can appear after selecting the Next selector on the reject setup screen 820. The lubrication setup screen 850 can allow an operator to change parameters for a lubrication system of the paper winder system 10. In addition, the lubrication setup screen 850 can also display fault messages and prompts for obtaining operating parameters for the paper winder system 10. The lubrication setup screen 850 can also include a Previous selector that an operator can select in order to view other control screens. In some embodiments, the lubrication setup screen 850 includes a Main Screen selector that an operator can select in order to return to the log saw main screen 630.

The lubrication setup screen 850 can include a Blade Mist Frequency selector. The Blade Mist Frequency selector can include a current frequency value for blade mist lubrication. The Blade Mist Frequency selector can also include an Increase selector and a Decrease selector that an operator can use to change the frequency of blade mist lubrication.

The lubrication setup screen 850 can also include a Blade Mist Pump on Duration selector. The Blade Mist Pump on Duration selector can include a current duration value for a blade mist lubrication cycle. The Blade Mist Pump on Duration selector can also include an Increase selector and a Decrease selector that an operator can use to change the duration of a blade mist lubrication cycle.

In addition, the lubrication setup screen 850 can include a Next Cycle will Occur in selector. The Next Cycle will Occur in selector can include a current amount of time until a subsequent lubrication cycle begins. In some embodiments, an operator can also provide a new value for the time period.

The lubrication setup screen 850 can include a Blade Mist Primer selector. An operator can select the Blade Mist Primer selector in order to manually cycle a lubrication pump. A lubrication pump can cycle once each time the Blade Mist Primer selector is selected. In some embodiments, an operator can select the Blade Mist Primer selector and retain the selector in a selected state (e.g., pushing and holding a button) until a lubrication pump reaches system pressure. The lubrication setup screen 850 can also include a Blade Mist On/Off selector that an operator can select in order to turn off blade mist lubrication.

It should be understood by one of ordinary skill in the art that embodiments of the invention can be implemented using various computer devices, such as personal computers, servers, and other devices that have processors or that are capable of executing programs or sets of instructions. In general, the invention can be implemented using existing hardware or hardware that could be readily created by those of ordinary skill in the art. Thus, the architecture of exemplary devices has not always been explained in detail, except to note that the devices will generally have a processor, memory (of some kind), and input and output applications. The processor can be a microprocessor, a programmable logic control, an application-specific integrated circuit, or a computing device configured to fetch and execute instructions. In some cases, the devices can also have running systems and application programs that are managed by the running systems. It should also be noted that no specific network configurations are ever implied. One or more networks or communication systems, such as the Internet, telephone systems, wireless networks, satellite networks, cable TV networks, and various other private and public networks, could be used in various combinations to provide the communication links desired or needed to create embodiments or implementations of the invention, as would be apparent to one of ordinary skill in the art. Thus, the invention is not limited to any specific network or combinations of networks.

Various features and advantages of the invention are set forth in the following claims.

1. A graphical user interface for use with a paper winder system, the graphical user interface comprising:
a main control screen including at least one of a web handling section, a log/core handling section, and a menu section;
the web handling section including at least one of an unwind stand components control section, a main paper winder system control section, a web speed control section, an embosser control section, and a winder control section;
the log/core handling section including at least one of a log reject control section, a core hopper control section, an accumulator control section, and a log saw control section; and
the menu section including at least one of a control panels selector, a set product codes selector, a monitor servos selector, an adjust parameters selector, a help menu selector, and a shutdown selector.

2. The graphical user interface of claim 1 wherein the main control screen displays at least one of fault messages and paper winder system operating parameter prompts.

3. The graphical user interface of claim 1 wherein the unwind stand components control section includes at least one lateral register selector that allows a user to adjust a lateral position of a parent roll of the paper winder system.

4. The graphical user interface of claim 1 wherein the main paper winder system control section includes an acknowledge selector that allows a user to acknowledge automatic warnings initiated by the paper winder system.

5. The graphical user interface of claim 1 wherein the web speed control section includes a bar graph speed indicator that indicates a current running speed of the paper winder system as a percentage of a maximum running speed of the paper winder system.

6. The graphical user interface of claim 5 wherein the bar graph speed indicator allows a user to enter a running speed of the paper winder system as a percentage of the maximum running speed of the paper winder system.

7. The graphical user interface of claim 1 wherein the web speed control section includes at least one of a minimum speed selector, a maximum speed selector, a 25% speed selector, a 50% speed selector, a 75% speed selector, an increase speed selector, a decrease speed selector, and an adjust speed selector.

8. The graphical user interface of claim 1 wherein the web speed control section displays a current running speed of the paper winder system.

9. The graphical user interface of claim 1 wherein the embosser control section includes an emboss rear/front selector that allows a user to select an embossing deck of the paper winder system.

10. The graphical user interface of claim 1 wherein the embosser control section includes at least one adjustment selector that allows a user to adjust an embossing roll nip value.

11. The graphical user interface of claim 10 wherein the at least one adjustment selector includes at least one of an increase value selector and a decrease value selector that allows a user to adjust the embossing roll nip value.

12. The graphical user interface of claim 10 wherein the at least one adjustment selector indicates a current embossing roll nip value.

13. The graphical user interface of claim 1 wherein the embosser control section includes at least one of an emboss unload/automatic selector and an emboss load selector.

14. The graphical user interface of claim 1 wherein the rewinder control section includes a perforation selector that allows a user to select a perforation unit of the paper winder system.

15. The graphical user interface of claim 1 wherein the rewinder control section includes a perforation angle adjust selector that allows a user to adjust a perforation angle of the paper winder system.

16. The graphical user interface of claim 15 wherein the perforation angle adjust selector includes at least one of an increase angle selector and a decrease angle selector that allows a user to adjust the perforation angle of the paper winder system.

17. The graphical user interface of claim 15 wherein the perforation angle adjust selector displays a current perforation angle of the paper winder system.

18. The graphical user interface of claim 1 wherein the rewinder control section includes at least one of an upper perforation load/unload selector, a lower perforation load/unload selector, a rehome separator selector, a separator off selector, and a run rewinder without/with paper selector.

19. The graphical user interface of claim 1 wherein the log reject section includes at least one of a rewinder log reject selector and a tail sealer log reject selector.

20. The graphical user interface of claim 1 wherein the core hopper control section includes a core hopper on/off selector.

21. The graphical user interface of claim 1 wherein the accumulator control section includes at least one of an accumulator infeed enable selector, an accumulator outfeed enable selector, an infeed stop selector, and an outfeed stop selector that allow a user to control at least one of an infeed drive and an outfeed drive of an accumulator of the paper winder system.

22. The graphical user interface of claim 1 wherein the log saw control section includes a log saw stop selector that allows a user to stop a log saw of the paper winder system.

23. The graphical user interface of claim 1 wherein the control panels selector provides access to a control panels screen, the set product codes selector provides access to a create product codes screen, the monitor servos selector provides access to a servo monitor screen, the adjust parameters selector provides access to a parameter adjustment screen, the help menu selector provides access to a help menu screen, and the shutdown selector allows a user to shut down the graphical user interface.

24. A graphical user interface for use with a paper winder system, the graphical user interface comprising:
a change parameters screen including at least one parameter field that allows a user to adjust at least one parameter according to which the paper winder system operates;
the at least one parameter field including at least one of a current parameter value and a new parameter value;
the at least one parameter field including an adjust parameter selector and a function definition selector.

25. The graphical user interface of claim 24 wherein the at least one parameter field includes a changes pending indicator.

26. The graphical user interface of claim 24 wherein the change parameters screen includes a plurality of parameter fields including at least two parameter categories.

27. The graphical user interface of claim 26 wherein the at least two parameter categories are color-coded.

28. The graphical user interface of claim 26 wherein the at least two parameter categories includes at least two of daily parameters, adjust-once parameters, other parameters, tail sealer parameters, and technician parameters.

29. The graphical user interface of claim 28 wherein the daily parameters include at least one of finished roll diameter, perforation length, lower roll speed, separator finger timing, log insert done count, log insertion distance, log insertion distance high speed compensation, and rider roll contact position.

30. The graphical user interface of claim 28 wherein the adjust-once parameters include at least one of core glue position, core insert tip speed, core insert acceleration complete position, core insert timing, separator finger speed, rider start down count, rider finish down count, and core diameter.

31. The graphical user interface of claim 28 wherein the other parameters include rider roll speed, sheet count, log discharge distance, log discharge start count, rider discharge assist, rider discharge delay, rider discharge initial compression, and rider discharge final compression.

32. The graphical user interface of claim 28 wherein the tail sealer parameters include tail seal initial speed, tail unwind distance, log position fine adjustment, tail pull up distance, tail seal upper belt rewind, tail seal lower roll rewind, log seal position, and tail seal outfeed belt speed.

33. The graphical user interface of claim 28 wherein the technician parameters include minimum rider clearance, rider pivot position, rider pivot length, and rider initial compression done percent.

34. The graphical user interface of claim 24 wherein the function definition selector provides access to a function definition screen for each one of the at least one parameters.

35. The graphical user interface of claim 34 wherein the function definition screen includes at least one of a function definition, a figure of a portion of the paper winder, a parameter value range, an adjustment requirement, and a direct effect description.

36. The graphical user interface of claim 35 wherein the adjustment requirement indicates whether the paper winder can be running or must be stopped to change the parameter.

37. The graphical user interface of claim 34 wherein at least one of the change parameters screen and the function definition screen includes at least one of a save changes selector, a values exceeds limit selector, a changes pending indicator, a download changes selector, a current parameter value, and a new parameter value.

38. The graphical user interface of claim 24 wherein the change parameters screen is one of an expert adjust parameters screen, a main winder parameters screen, and a tail sealer parameters screen.

39. The graphical user interface of claim 24 wherein the change parameters screen displays at least one of fault messages and paper winder system operating parameter prompts.

40. A graphical user interface for use with a paper winder system, the graphical user interface comprising:
a help menu screen including at least one of an overview selector, an operator manual selector, a starting the machine selector, and a troubleshoot product selector.

41. The graphical user interface of claim 40 wherein the help menu screen displays at least one of fault messages and paper winder system operating parameter prompts.

42. The graphical user interface of claim 40 wherein the overview selector provides access to an overview of the operation of the paper winder system.

43. The graphical user interface of claim 40 wherein the operator manual selector provides access to an operator's manual screen.

44. The graphical user interface of claim 40 wherein the starting the machine selector provides access to a starting the machine screen that provides instructions on starting procedures for the paper winder system.

45. The graphical user interface of claim 40 wherein the troubleshoot product selector provides access to a product troubleshooting screen that includes at least one problem selector.

46. The graphical user interface of claim 45 wherein the at least one problem selector indicates at least one of a description of a problem that can occur when operating the paper winder system and an illustration of a problem that can occur when operating the paper winder system.

47. The graphical user interface of claim 45 wherein the at least one problem selector provides access to a troubleshooting help screen that includes at least one of a description of the problem, an illustration that represents a configuration of the paper winder system causing the problem, and a recommended action for an operator to take to correct the problem.

48. A graphical user interface for use with a paper winder system, the graphical user interface comprising:
a change message screen that includes at least one of a message selector, a scan on/off selector, an automatic scan off selector, and a new message entry selector.

49. The graphical user interface of claim 48 wherein the change message screen displays at least one of fault messages and paper winder system operating parameter prompts.

50. The graphical user interface of claim 48 wherein the message selector allows a user to select a message displayed by the paper winder system.

51. The graphical user interface of claim 48 wherein the message selector includes at least one of an up selector and a down selector that allows a user to scroll through a plurality of messages.

52. The graphical user interface of claim 48 wherein the message selector displays a currently-selected message.

53. The graphical user interface of claim 48 wherein the scan on/off selector allows a user to prevent scrolling through a plurality of messages.

54. The graphical user interface of claim 48 wherein the automatic scroll off selector allows a user to turn off automatic scrolling through a plurality of messages.

55. The graphical user interface of claim 48 wherein the new message entry selector allows a user to enter message text of a currently-selected message.

56. A graphical user interface for use with a paper winder system, the graphical user interface comprising:
a control panels screen including at least one of an unwind stand control selector, an accumulator control selector, a perforation control selector, a run tension control selector, a stop tension control selector, a thread tension control selector, and a lubrication control selector.

57. The graphical user interface of claim 56 wherein the unwind stand control selector provides access to an unwind stand control screen that allows a user to control unwind stand components of the paper winder system.

58. The graphical user interface of claim 56 wherein the accumulator control selector provides access to an accumulator control screen that allows a user to control an accumulator of the paper winder system.

59. The graphical user interface of claim 56 wherein the perforation control selector provides access to a perforation control screen that includes at least one of a perforation selector, an upper perforation load/unload selector, a lower perforation load/unload selector, and a perforation angle adjust selector.

60. The graphical user interface of claim 59 wherein the perforation control screen includes a download changes selector that allows a user to download changes made on the perforation control screen to a perforation unit of the paper winder system.

61. The graphical user interface of claim 60 wherein the perforation control screen includes an implementing changes indicator that indicates when changes are being downloaded to the perforation unit.

62. The graphical user interface of claim 59 wherein the perforation control screen includes a values exceed limit selector that indicates that one or more changes made on the perforation control screen lie outside a valid range of values and allows a user to reset the changes such that the changes lie inside the valid range of values.

63. The graphical user interface of claim 59 wherein the perforation control screen displays at least one of a current perforation length and a new perforation length of the paper winder system.

64. The graphical user interface of claim 59 wherein the perforation control screen includes a save changes to product codes selector that allows a user to save operating parameters set on the perforation control screen.

65. The graphical user interface of claim 56 wherein the run tension control selector provides access to a run tension control screen that includes an ironing roll speed selector that allows a user to set a running speed of an ironing roll of the paper winder system.

66. The graphical user interface of claim 65 wherein the run tension control screen includes at least one of an unwind stand tension selector, a pull roll tension selector, a embosser run tension selector, a pull roll ratio selector, and an emboss ratio selector.

67. The graphical user interface of claim 65 wherein the run tension control screen includes a save changes to product codes selector that allows a user to save operating parameters set on the run tension control screen.

68. The graphical user interface of claim 56 wherein the stop tension control selector provides access to a stop tension screen that includes at least one of an unwind stand stop tension selector, a pull roll stop tension selector, and an embosser stop tension selector.

69. The graphical user interface of claim 68 wherein the stop tension control screen includes a save changes to product codes selector that allows a user to save operating parameters set on the stop tension control screen.

70. The graphical user interface of claim 56 wherein the thread tension control selector provides access to a thread tension screen that includes at least one of an unwind stand thread tension selector, a pull roll thread tension selector, and an embosser thread tension selector.

71. The graphical user interface of claim 70 wherein the thread tension control screen includes a save changes to product codes selector that allows a user to save operating parameters set on the thread tension control screen.

72. The graphical user interface of claim 56 wherein the lubrication control selector provides access to a lubrication procedures screen that includes at least one lubrication adjustment selector that includes a frequency selector, a duration selector, and a next cycle will occur selector that allow a user to adjust a frequency, a duration, and a duration remaining before a next lubrication cycle for a lubrication procedure of the paper winder system.

73. The graphical user interface of claim 72 wherein the at least one lubrication adjustment selector includes a lubrication primer selector that allows a user to manually operate a lubrication machine pump of the paper winder system.

74. The graphical user interface of claim 72 wherein the at least one lubrication adjustment selector displays a frequency, a duration, and a duration remaining before a next lubrication cycle for a lubrication procedure of the paper winder system.

75. The graphical user interface of claim 72 wherein the lubrication procedures screen includes an emboss spray mist off/on selector that allows a user to control an emboss spray of the paper winder system.

76. A graphical user interface for use with a paper winder system, the graphical user interface comprising:
a create product codes screen that includes a select product code set selector, a load product code set selector, and one or more change selectors.

77. The graphical user interface of claim 76 wherein the create product codes screen displays at least one of fault messages and paper winder system operating parameter prompts.

78. The graphical user interface of claim 76 wherein the create product codes screen includes at least one of an up selector and a down selector that allows a user to scroll through a plurality of product code sets.

79. The graphical user interface of claim 76 wherein the create product codes screen includes a parameter section that displays one or more parameters associated with a selected product code set.

80. The graphical user interface of claim 79 wherein each of the one or more change selectors is associated with one of the one or more parameters.

81. The graphical user interface of claim 79 wherein one or more parameters include at least two parameter categories.

82. The graphical user interface of claim 81 wherein the at least two parameter categories are color-coded.

83. The graphical user interface of claim 81 wherein the at least two parameter categories includes at least two of daily parameters, adjust once parameters, other parameters, tail sealer parameters, and technician parameters.

84. The graphical user interface of claim 76 wherein the create product codes screen includes at least one of a load product code to rewinder selector, a download selector, a save selector, and a save as selector.

85. A graphical user interface for use with a paper winder system, the graphical user interface comprising:
a troubleshooting guide screen including at least one problem selector that provides access to at least one troubleshooting help screen,
the at least one problem selector including at least one of an illustration of a portion of the paper winder system and a description of a problem.

86. The graphical user interface of claim 85 and further comprising at least one troubleshooting help screen including at least one of an illustration of a portion of the paper winder system, a description of the problem, at least one action to solve the problem, and at least one link to a function definition screen.

87. The graphical user interface of claim 86 and further comprising a function definition screen including at least one of a function definition, an illustration of a portion of the paper winder, a parameter value range, an adjustment requirement, and a direct effect description.

88. The graphical user interface of claim 87 wherein the adjustment requirement indicates whether the paper winder system can be running or must be stopped to change the parameter.

89. The graphical user interface of claim 87 wherein at least one of the change parameters screen and the function definition screen includes at least one of a save changes selector, a values exceeds limit selector, a changes pending indicator, a download changes selector, a current parameter value, and a new parameter value.

90. The graphical user interface of claim 85 wherein the troubleshooting guide screen includes at least one of a roller diameter is too small problem selector, a rider roll is not contacting product problem selector, a product roll is not walking through nip problem selector, a product roll is walking too far through nip problem selector, a wind is too loose problem selector, a tight winding problem selector, a separation is not clean problem selector, an entire roll is too tight problem selector, a log is not exiting tail sealer problem selector, a gluing parameters problem selector, an inserting the core problem selector, a separator finger problem selector, a changing the core size problem selector, an embossing roll problem selector, a pull roll problem selector, and an anvil roll problem selector.
